(19) United States
(12) Patent Application Publication
(10) Pub. No.: US 2026/0057779 A1
(43) Pub. Date: Feb. 26, 2026

(54) VEHICLE COLLISION AVOIDANCE AND MITIGATION SYSTEM

(71) Applicant: Oshkosh Corporation, Oshkosh, WI (US)

(72) Inventors: Matt Bellafaire, Oshkosh, WI (US); Jake Steiner, Oshkosh, WI (US); Jonathan Honig, Oshkosh, WI (US)

(73) Assignee: Oshkosh Corporation, Oshkosh, WI (US)

(21) Appl. No.: 19/306,786

(22) Filed: Aug. 21, 2025

Related U.S. Application Data
(60) Provisional application No. 63/686,112, filed on Aug. 22, 2024.
(60) Provisional application No. 63/691,776, filed on Sep. 6, 2024.
(60) Provisional application No. 63/691,468, filed on Sep. 6, 2024.
(60) Provisional application No. 63/691,614, filed on Sep. 6, 2024.
(60) Provisional application No. 63/691,600, filed on Sep. 6, 2024.
(60) Provisional application No. 63/691,589, filed on Sep. 6, 2024.
(60) Provisional application No. 63/691,734, filed on Sep. 6, 2024.
(60) Provisional application No. 63/691,609, filed on Sep. 6, 2024.
(60) Provisional application No. 63/691,491, filed on Sep. 6, 2024.
(60) Provisional application No. 63/691,750, filed on Sep. 6, 2024.
(60) Provisional application No. 63/691,621, filed on Sep. 6, 2024.

(51) Int. Cl. G08G 1/16; B60Q 1/50; B60Q 5/00; B60R 21/013; B60R 21/36

(52) U.S. Cl. CPC G08G 1/166; B60Q 1/525; B60Q 5/006; B60R 21/013; B60R 21/36

(57) ABSTRACT

A vehicle is configured to be positioned upstream of traffic relative to a scene to protect personnel responding to the scene. The vehicle includes a collision avoidance and mitigation system configured to alert personnel on the scene of a threat caused by an approaching vehicle and/or alert the driver of the approaching vehicle of the scene. The collision avoidance and mitigation system is configured to determine a threat score based on a past trajectory of a detected vehicle and a number of previously observed trajectories of vehicles approaching the scene. The collision avoidance system can generate a threat score for the detected vehicle and adjust the threat score based on a comparison of the past trajectory to the number of previously observed trajectories. An alert signal is generated responsive to the threat score exceeding a threshold.

### CROSS-REFERENCE TO RELATED PATENT APPLICATIONS

This application claims the benefit of and priority to (a) U.S. Provisional Patent Application No. 63/686,112, filed Aug. 22, 2024, (b) U.S. Provisional Patent Application No. 63/691,468, filed Sep. 6, 2024, (c) U.S. Provisional Patent Application No. 63/691,491, filed Sep. 6, 2024, (d) U.S. Provisional Patent Application No. 63/691,589, filed Sep. 6, 2024, (e) U.S. Provisional Patent Application No. 63/691,600, filed Sep. 6, 2024, (f) U.S. Provisional Patent Application No. 63/691,609, filed Sep. 6, 2024, (g) U.S. Provisional Patent Application No. 63/691,614, filed Sep. 6, 2024, (h) U.S. Provisional Patent Application No. 63/691,621, filed Sep. 6, 2024, (i) U.S. Provisional Patent Application No. 63/691,734, filed Sep. 6, 2024, (j) U.S. Provisional Patent Application No. 63/691,750, filed Sep. 6, 2024, and (k) U.S. Provisional Patent Application No. 63/691,776, filed Sep. 6, 2024, all of which are incorporated herein by reference in their entireties.

### BACKGROUND

Blocker vehicles are commonly used at emergency scenes, construction sites, parades, etc. to prevent approaching vehicles from entering a scene, site, etc. However, as vehicle operators become more distracted by technology (e.g., infotainment systems, smartphones, cell phones, etc.) while driving, increased incidents are occurring where approaching vehicles drive into the blocker vehicles, damaging the blocker vehicle and putting personnel on scene in harm's way.

### SUMMARY

One embodiment relates to a collision avoidance system for a blocker vehicle at a scene. The collision avoidance system includes one or more sensors and one or more processing circuits. The one or more processing circuits are configured to acquire a number of past trajectories of approaching vehicles proximate the scene based on a number of first position measurements from the one or more sensors and representing unthreatening conditions for the scene. The one or more processing circuits are also configured to determine a threat score for a detected vehicle based on the number of past trajectories and a number of second position measurements of the detected vehicle acquired by the one or more sensors and responsive to the threat score exceeding a threshold, transmit an alert signal configured to activate at least one of an alert system associated with the blocker vehicle, a collision avoidance system of the detected vehicle, or a threat mitigation system of the blocker vehicle.

Another embodiment relates to a collision avoidance system for a blocker vehicle at a scene. The collision avoidance system includes one or more sensors and one or more processing circuits. The one or more processing circuits are configured to acquire a number of past trajectories of approaching vehicles proximate the scene representing unthreatening conditions. The one or more processing circuits are also configured to determine a threat score for a detected vehicle based on a number of position measurements of the detected vehicle acquired by the one or more sensors; adjust the threat score based on a comparison of the number of position measurements to one or more past trajectories of the number of past trajectories representing unthreatening conditions; and responsive to the threat score exceeding a threshold, transmit an alert signal configured to activate at least one of an alert system of the blocker vehicle, a collision avoidance system of the detected vehicle, or a threat mitigation system of the blocker vehicle.

Still another embodiment relates to a collision avoidance system for a blocker vehicle at a scene. The collision avoidance system includes one or more sensors configured to acquire a position and a longitudinal axis of a detected vehicle and one or more processing circuits configured. The processing circuits are configured to acquire a number of position measurements for the detected vehicle; determine an angle between the longitudinal axis of the detected vehicle and a direction of motion of the detected vehicle determined from the number of position measurements; and responsive to the angle satisfying a threshold criterion, transmit an alert signal configured to activate at least one of an alert system associated with the blocker vehicle, a collision avoidance system of the detected vehicle, or a threat mitigation system of the blocker vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a front, left perspective view of a fire fighting vehicle, according to an exemplary embodiment.

FIG. 2 is a side view of the fire fighting vehicle of FIG. 1 with an aerial ladder assembly, according to an exemplary embodiment.

FIG. 3 is a schematic block diagram of the fire fighting vehicle of FIGS. 1 and 2 including a collision avoidance and mitigation system (“CAMS”), according to an exemplary embodiment.

FIG. 4 is a perspective view of an in-cab display of the CAMS of FIG. 3 according to an exemplary embodiment.

FIG. 5 is a schematic block diagram of a CAMS module of the CAMS of FIG. 3, according to an exemplary embodiment.

FIG. 6 is a perspective view of the CAMS module of FIG. 5, according to an exemplary embodiment.

FIG. 7-9 are various views of a scene including the vehicle of FIG. 1 and the CAMS of FIG. 3, according to an exemplary embodiment.

FIG. 10 is an illustration of data acquisition using the CAMS module of FIG. 4, according to an exemplary embodiment.

FIG. 11 is a live camera feed with a data overlay displayed on the in-cab display of FIG. 6, according to an exemplary embodiment.

FIG. 12 a block diagram of the CAMS, according to an exemplary embodiment.

FIG. 13 is another view of a scene including the vehicle of FIG. 1, according to an exemplary embodiment.

FIG. 14A is an illustrative example of predicting a vehicle trajectory, according to an exemplary embodiment.

FIG. 14B is an illustration of a vehicle with its direction of motion aligned with its longitudinal axis, according to an exemplary embodiment.

FIG. 14C is an illustration of a vehicle indicating yawing, according to an exemplary embodiment.

FIG. 15 is an overhead illustration of a scene including vehicle trajectory clusters, according to an exemplary embodiment.

FIG. 16A is an overhead illustration of a scene including restricted zones, according to an exemplary embodiment.

FIG. 16B is another overhead illustration of a scene including restricted zones, according to an exemplary embodiment.

FIG. 17 is a flow diagram of a method for generating an alert responsive to an adjusted value related to the probability of a threat condition exceeding a threshold, according to some embodiments.

FIG. 18 is a flow diagram of a method for generating an alert responsive to a value related to the probability of a vehicle entering a restricted zone exceeding a threshold, according to some embodiments.

FIG. 19 is a schematic diagram of the scene of FIG. 7-9 and a restricted zone established around the scene, according to an exemplary embodiment.

FIG. 20 is a schematic diagram of the scene of FIG. 7-9 and a dynamic restricted zone established around the scene and a personnel device, according to an exemplary embodiment.

FIG. 21 is a schematic diagram of the scene of FIG. 7-9, a dynamic restricted zone established around the scene and a personnel device, and a dynamic sensor detection zone, according to an exemplary embodiment.

FIG. 22 is a control system of an approaching vehicle, according to an exemplary embodiment.

FIG. 23 is a flow diagram of a method for communicating with and controlling the approaching vehicle of FIG. 12, according to an exemplary embodiment.

FIG. 24 is a schematic illustration of a scene including the vehicle of FIG. 1 and the CAMS of FIG. 3 with a field of view of the CAMS rotating, according to an exemplary embodiment.

FIG. 25 is schematic top view of the CAMS module of FIGS. 5 and 6 rotatably coupled to the vehicle of FIG. 1, according to an exemplary embodiment.

FIG. 26 is schematic side view of the CAMS module of FIGS. 5 and 6 rotatably coupled to the vehicle of FIG. 1, according to an exemplary embodiment.

FIG. 27 is schematic top view of the CAMS module of FIGS. 5 and 6 rotatably coupled to the vehicle of FIG. 1, according to an exemplary embodiment.

FIG. 28 is schematic side view of the CAMS module of FIGS. 5 and 6 rotatably coupled to the vehicle of FIG. 1, according to an exemplary embodiment.

FIG. 29 is a schematic block diagram of the CAMS module of FIGS. 5 and 6 and a rotary actuator, according to an exemplary embodiment.

FIG. 30A is a schematic top view of the vehicle of FIG. 1 including a plurality of the CAMS modules of FIGS. 5 and 6, where each of the CAMS modules includes a field of view, according to an exemplary embodiment.

FIG. 30B is a schematic top view of the vehicle of FIG. 1 including a plurality of the CAMS modules of FIGS. 5 and 6, where two or more of the CAMS modules include a field of view that overlap, according to an exemplary embodiment.

FIG. 30C is a schematic top view of the vehicle of FIG. 1 including a plurality of the CAMS modules of FIGS. 5 and 6, where two or more of the CAMS modules include a field of view that overlap, according to an exemplary embodiment.

FIG. 30D is a rear perspective view of the vehicle of FIG. 1 including a plurality of the CAMS modules of FIGS. 5 and 6, according to an exemplary embodiment.

FIG. 30E is an enlarged view of the plurality of CAMS modules of FIG. 30D, according to an exemplary embodiment.

FIG. 31 is a schematic block diagram of the CAMS modules of FIGS. 30A-30E connected to the vehicle of FIG. 1, according to an exemplary embodiment.

FIG. 32 is a schematic illustration of a scene including the vehicle of FIG. 1 and the CAMS of FIG. 3 with a drone providing an upstream field of view, according to an exemplary embodiment.

FIG. 33 is a schematic block diagram of the drone of FIG. 32 in communication with the vehicle of FIG. 1, according to an exemplary embodiment.

FIG. 34 is a perspective view of a mobile CAMS unit, according to an exemplary embodiment.

FIG. 35 is a schematic illustration of a scene including the vehicle of FIG. 1 and the CAMS of FIG. 3 with the mobile CAMS unit of FIG. 34 providing an upstream field of view, according to an exemplary embodiment.

FIG. 36 is a schematic block diagram of the mobile CAMS unit of FIG. 34 in communication with the vehicle of FIG. 1, according to an exemplary embodiment.

FIG. 37 is a schematic illustration of a scene including the vehicle of FIG. 1 and the CAMS of FIG. 3 with roadway camera(s) providing an upstream field of view, according to an exemplary embodiment.

FIG. 38 is a schematic block diagram of the roadway camera(s) of FIG. 37 in communication with the vehicle of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, the present disclosure relates to a blocker vehicle that provides alerts for advanced warning of incoming vehicles at a scene (e.g., an accident scene, a construction zone, etc.). Blocker vehicles (e.g., a response vehicle, a fire truck, a police vehicle, a tow truck, a dump truck, a construction machine, etc.) may be parked at the rear of a scene to block the scene from traffic. However, unlike traditional blocker vehicles today, the blocker vehicle of the present disclosure includes an advanced detection and warning system. The advanced detection and warning system is configured to monitor the areas adjacent the scene and provide advanced warning regarding a threat to the scene (e.g., such as an incoming vehicle that is likely to collide with the blocker vehicle or enter the scene). The advanced warning may include (i) activating vehicle systems such as sirens, horns, and lights on the blocker vehicle and/or (ii) sending notifications to user devices of personnel on the scene.

### Vehicle

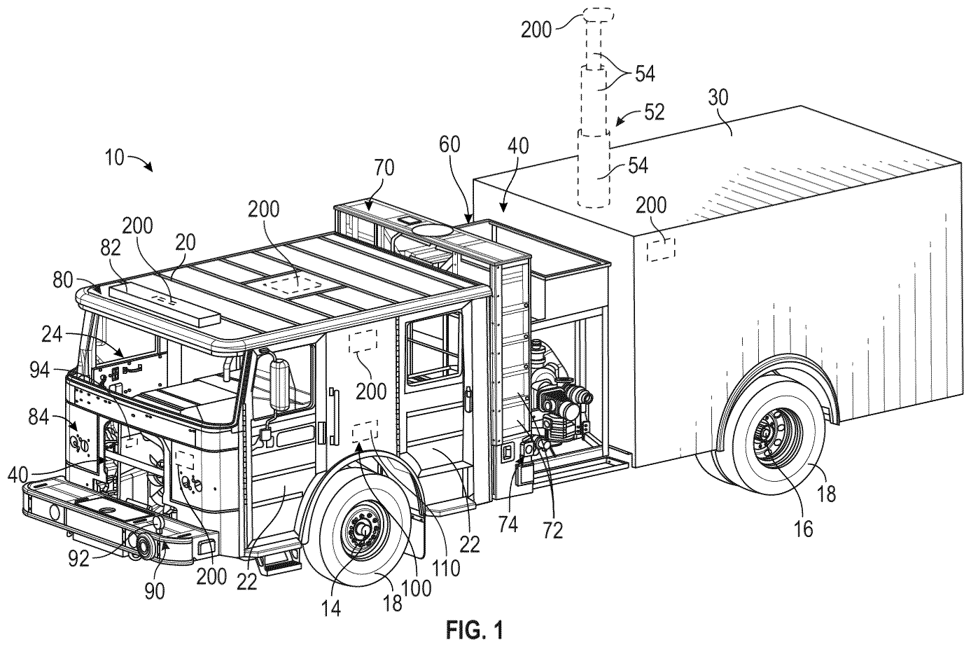

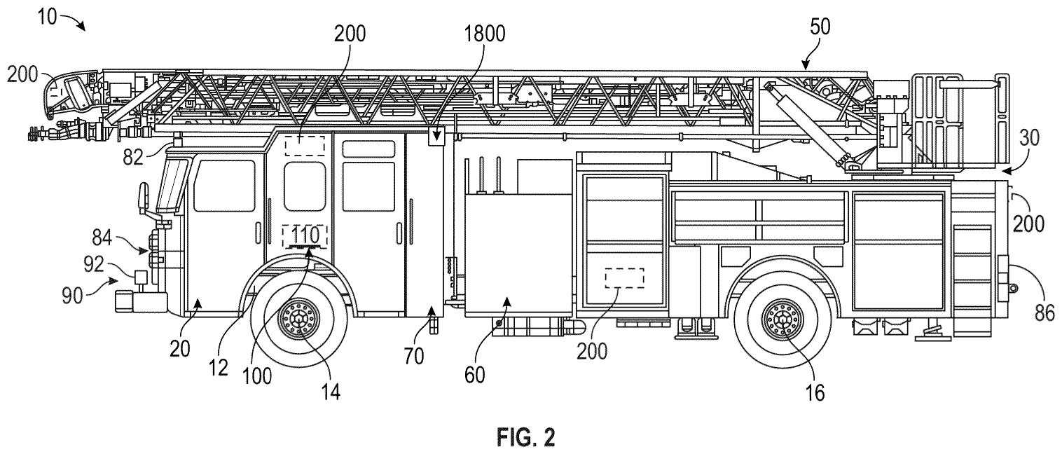

According to the exemplary embodiment shown in FIGS. 1 and 2, a machine, shown as vehicle 10, is configured as a fire fighting vehicle. In the embodiment shown, the fire fighting vehicle is a pumper fire truck. In another embodiment, the fire fighting vehicle is an aerial ladder truck. The aerial ladder truck may include a rear-mount aerial ladder or a mid-mount aerial ladder. In some embodiments, the aerial ladder truck is a quint fire truck. In other embodiments, the aerial ladder truck is a tiller fire truck. In still another embodiment, the fire fighting vehicle is an airport rescue fire fighting (“ARFF”) truck. In various embodiments, the fire fighting vehicle (e.g., a quint, a tanker, an ARFF, etc.) includes an on-board water storage tank, an on-board agent storage tank, and/or a pumping system. In other embodiments, the fire fighting vehicle is still another type of fire fighting vehicle. In an alternative embodiment, the vehicle 10 is another type of vehicle other than a fire fighting vehicle. For example, the vehicle 10 may be a refuse truck, a concrete mixer truck, a military vehicle, a tow truck, a snow plow truck, a response vehicle (e.g., an ambulance, a police vehicle, etc.), a farming machine or vehicle, a construction machine or vehicle (e.g., a dump truck, a backhoe, an excavator, etc.), airport ground service equipment (e.g., a tractor, a loader, a de-icer truck, etc.), a bucket truck, a boom lift, a crane truck, and/or still another vehicle or machine.

As shown in FIGS. 1 and 2, the vehicle 10 includes a chassis, shown as frame 12; a plurality of axles, shown as front axle 14 and rear axle 16, supported by the frame 12 and that couple a plurality of tractive elements, shown as wheels 18, to the frame 12; a cab, shown as front cabin 20, supported by the frame 12; a body assembly, shown as a rear section 30, supported by the frame 12 and positioned rearward of the front cabin 20; and a driveline (e.g., a powertrain, a drivetrain, an accessory drive, a prime mover, an electric driveline including one or more motors, a hybrid driveline including an engine and one or more motors, a non-hybrid, dual-drive driveline including an engine and one or more motors etc.), shown as driveline 40. While shown as including a single front axle 14 and a single rear axle 16, in other embodiments, the vehicle 10 includes two front axles 14 and/or two rear axles 16. In an alternative embodiment, the tractive elements are otherwise structured (e.g., tracks, etc.). The frame 12 extends along a longitudinal direction or axis (e.g., the longitudinal axis 260) defined by the vehicle 10 (e.g., a center axis that extends in a front-to-back direction along the frame 12).

According to an exemplary embodiment, the front cabin 20 includes a plurality of body panels coupled to a support (e.g., a structural frame assembly, etc.). The body panels may define a plurality of openings through which an operator accesses an interior 24 of the front cabin 20 (e.g., for ingress, for egress, to retrieve components from within, etc.). As shown in FIGS. 1 and 2, the front cabin 20 includes a plurality of doors, shown as doors 22, positioned over the plurality of openings defined by the plurality of body panels. The doors 22 may provide access to the interior 24 of the front cabin 20 for a driver and/or passengers of the vehicle 10. The doors 22 may be hinged, sliding, or bus-style folding doors.

The front cabin 20 may include components arranged in various configurations. Such configurations may vary based on the particular application of the vehicle 10, customer requirements, or still other factors. The front cabin 20 may be configured to contain or otherwise support a number of occupants, storage units, and/or equipment. For example, the front cabin 20 may provide seating for an operator (e.g., a driver, etc.) and/or one or more passengers of the vehicle 10. The front cabin 20 may include one or more storage areas for providing compartmental storage for various articles (e.g., supplies, instrumentation, equipment, etc.). The interior 24 of the front cabin 20 may further include a user interface. The user interface may include a cabin display and various controls (e.g., buttons, switches, knobs, levers, joysticks, etc.). In some embodiments, the user interface within the interior 24 of the front cabin 20 further includes touchscreens, a steering wheel, an accelerator pedal, and/or a brake pedal, among other components. The user interface may provide the operator with control capabilities over the vehicle 10 (e.g., direction of travel, speed, etc.), one or more components of driveline 40, and/or still other components of the vehicle 10 from within the front cabin 20.

In some embodiments, the rear section 30 includes a plurality of compartments with corresponding doors positioned along one or more sides (e.g., a left side, right side, etc.) and/or a rear of the rear section 30. The plurality of compartments may facilitate storing various equipment such as oxygen tanks, hoses, axes, extinguishers, ladders, chains, ropes, straps, boots, jackets, blankets, first-aid kits, and/or still other equipment. One or more of the plurality of compartments may include various storage apparatuses (e.g., shelving, hooks, racks, etc.) for storing and organizing the equipment.

As shown in FIG. 1-3, the vehicle 10 includes one or more aerial devices, assemblies, or systems. In some embodiments (e.g., when the vehicle 10 is an aerial ladder truck, etc.), as shown in FIG. 2, the rear section 30 includes an aerial ladder assembly, shown as aerial ladder 50. The aerial ladder 50 may have a fixed length or may have one or more extensible ladder sections. The aerial ladder 50 may include a basket or implement (e.g., a water turret, etc.) coupled to a distal or free end thereof. According to the exemplary embodiment shown in FIG. 2, the aerial ladder 50 is coupled to the frame 12 proximate a rear of the rear section 30 (e.g., a rear-mount fire truck). In some embodiments, the aerial ladder 50 is coupled to the frame 12 proximate a front of the rear section 30 (e.g., a mid-mount fire truck). In some embodiments (e.g., when the vehicle 10 is non-aerial ladder truck, etc.), as shown in FIG. 1, the rear section 30 includes a deployable structure, shown as mast 52. The mast 52 includes a plurality of telescoping sections or portions, shown as mast segments 54, that telescope or nest relative to each other. Accordingly, the mast segments 54 can be extended and retracted relative to each other to facilitate stowing and deploying the mast 52 to an elevated height above the vehicle 10. In some embodiments, the mast 52 is part of the front cabin 20. In some embodiments, the vehicle 10 does not include the mast 52. In some embodiments, the aerial device is another type of aerial device. By way of example, the vehicle 10 may be a boom lift and the aerial device may be a boom assembly. By way of another example, the vehicle 10 may be a crane truck and the aerial device may be a crane. By way of still another example, the vehicle 10 may be bucket truck and the aerial device may be an aerial bucket.

In some embodiments (e.g., when the vehicle 10 is an ARFF truck, a tanker truck, a quint truck, etc.), the rear section 30 includes one or more fluid tanks. By way of example, the one or more fluid tanks may include a water tank and/or an agent tank. The water tank and/or the agent tank may be corrosion and UV resistant polypropylene tanks. In a municipal fire truck implementation (i.e., a non-ARFF truck implementation), the water tank may have a maximum water capacity ranging between 50 and 1000 gallons (e.g., 50, 100, 150, 200, 250, 300, 350, 400, 450, 500, 550, 600, 650, 700, 750, 800, 850, 900, 950, 1000, etc. gallons). In an ARRF truck implementation, the water tank may have a maximum water capacity ranging between 1,000 and 4,500 gallons (e.g., at least 1,250 gallons; between 2,500 gallons and 3,500 gallons; at most 4,500 gallons; at most 3,000 gallons; at most 1,500 gallons; etc.). The agent tank may have a maximum agent capacity ranging between 25 and 750 gallons (e.g., 25, 50, 75, 100, 150, 200, 250, 300, 350, 400, 450, 500, 550, 600, 650, 700, 750, etc. gallons). According to an exemplary embodiment, the agent is a foam fire suppressant, an aqueous film forming foam (“AFFF”). A low-expansion foam, a medium-expansion foam, a high-expansion foam, an alcohol-resistant foam, a synthetic foam, a protein-based foams, a fluorine-free foam, a film-forming fluoro protein (“FFFP”) foam, an alcohol resistant aqueous film forming foam (“AR-AFFF”), and/or still another suitable foam or a foam yet to be developed. The capacity of the water tank and/or the agent tank may be specified by a customer. It should be understood that the water tank and the agent tank configurations are highly customizable, and the scope of the present disclosure is not limited to a particular size or configuration of the water tank and the agent tank.

In some embodiments, the driveline 40 includes an internal combustion engine configured to drive the front axle 14 and/or the rear axle 16. In some embodiments, the driveline 40 includes one or more electric motors configured to drive the front axle 14 and/or the rear axle 16. In some embodiments, the driveline 40 includes the internal combustion engine to supplement the one or more electric motors. Accordingly, the driveline 40 may be an all-electric driveline, a hybrid driveline, a dual-drive driveline, and/or a conventional driveline.

As shown in FIG. 1-3, the vehicle 10 includes a pump assembly, shown as pump system 60, coupled to the frame 12 and positioned between the front cabin 20 and the rear section 30. In other embodiments, the pump system 60 is otherwise positioned (e.g., within the rear section 30). As shown in FIG. 1-3, the vehicle 10 includes an on-board energy storage system (“ESS”), shown as ESS 70, coupled to the frame 12 and positioned between the front cabin 20 and the rear section 30. In other embodiments, the ESS 70 is otherwise positioned (e.g., within the rear section 30, under the front cabin 20, under the rear section 30, between frame rails of the frame 12, etc.). According to an exemplary embodiment, the ESS 70 is configured to power the one or more electric motors of the driveline 40. As shown in FIG. 1, the ESS 70 includes one or more battery packs, shown as battery packs 72, and a charging system, shown as high voltage charging system 74. According to an exemplary embodiment, the high voltage charging system 74 includes a charging port that facilities selectively, electrically coupling the battery packs 72 to an external power source (e.g., a charging station, etc.). In some embodiments, the vehicle 10 does not include the ESS 70 or the high voltage charging system 74 (e.g., when the driveline 40 is a conventional driveline).

As shown in FIG. 1-3, the vehicle 10 includes a light assembly, shown as light system 80. The light system 80 includes a first light element, shown as light bar 82, disposed along a top or roof of the front cabin 20; second lighting elements, shown as front lights 84, positioned along the front of the front cabin 20; and third lighting elements; shown as rear lights 86, positioned along a rear of the rear section 30. In some embodiments, the light system 80 includes additional lighting elements positioned about the vehicle 10. By way of example, the light system 80 may include fourth lighting elements positioned along the sides of the front cabin 20, fifth lighting elements positioned along the sides of the rear section 30, sixth lighting elements disposed along a top of the rear section 30, and/or seventh lighting elements positioned along the aerial ladder 50, among other possible locations. According to an exemplary embodiment, the light system 80 (e.g., the light bar 82, the front lights 84, the rear lights 86, etc.) is configured to emit light in various colors (e.g., white, red, yellow, blue, etc.) and/or at various patterns (e.g., solid light, flashing light, different strobe patterns, different cadences, etc.)

As shown in FIG. 1-3, the vehicle 10 includes a sound emitting assembly, shown as audio system 90. The audio system 90 includes a first audio element, shown as siren 92, and a second audio element, shown as horn 94. The siren 92 and the horn 94 may be positioned variously about the vehicle 10 (e.g., along a front bumper, under the front cabin 20, etc.). In some embodiments, the audio system 90 includes additional audio elements positioned about the vehicle 10. By way of example, the audio system 90 may include a loudspeaker or an in-cab speaker. According to an exemplary embodiment, the audio system 90 (e.g., the siren 92, the horn 94, the loudspeaker, the in-cab speaker, etc.) is configured to emit various sounds and/or messages.

### CAMS

As shown in FIG. 1-3, the vehicle 10 includes a collision avoidance and mitigation system, shown as CAMS 100, that includes a first controller, shown as vehicle controller 110, an alerting system, shown as alert system 120, and one or more vision units or modules, shown as CAMS module(s) 200, and, in some embodiments, the aerial ladder 50 and/or the mast 52. As shown in FIGS. 1 and 2, the CAMS module 200 can be variously positioned about the vehicle 10. Such positions may include one or more of: along a front of the front cabin 20, along one or more sides of the front cabin 20, along a top of the front cabin 20, along one or more sides of the rear section 30, along a top of the rear section 30, along a rear of the rear section 30, coupled to the aerial ladder 50 (e.g., a ladder thereof, a basket at a proximal end thereof, etc.), coupled to the mast 52, and/or coupled to or integrated into the light bar 82, among other possible locations. Positioning the CAMS module 200 along the top of the front cabin 20 and/or the rear section 30, on the aerial ladder 50, on the mast 52, and/or in the light bar 82 may facilitate providing a higher vantage point for the CAMS module 200 to monitor an area proximate the vehicle 10 and/or a scene. In some embodiments, the CAMS module 200 is integrated into the vehicle 10 (e.g., recessed within a body panel thereof). In some embodiments, the CAMS module 200 provides a retrofit kit solution where the CAMS module 200 can be retrofitted to the vehicle 10 to provide the CAMS functionalities described herein (e.g., attached to an exterior surface of a body panel).

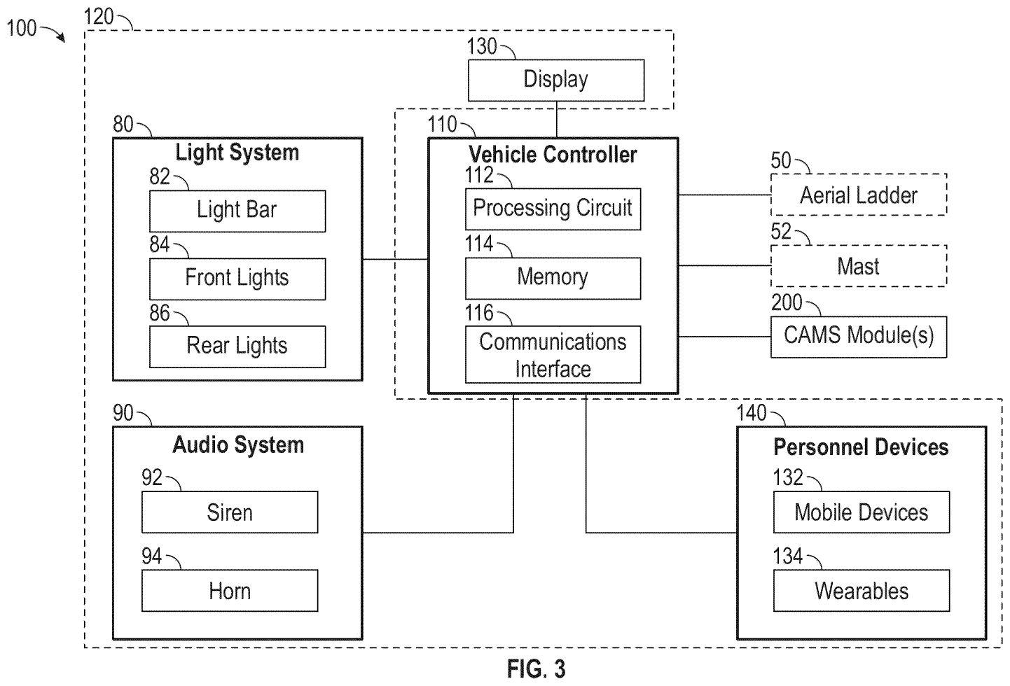

The vehicle controller 110 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 3, the vehicle controller 110 includes a processing circuit 112, a memory 114, and a communications interface 116. The processing circuit 112 may include an ASIC, one or more FPGAs, a DSP, circuits containing one or more processing components, circuitry for supporting a microprocessor, a group of processing components, or other suitable electronic processing components. In some embodiments, the processing circuit 112 is configured to execute computer code stored in the memory 114 to facilitate the activities described herein. The memory 114 may be any volatile or non-volatile or non-transitory computer-readable storage medium capable of storing data or computer code relating to the activities described herein. According to an exemplary embodiment, the memory 114 includes computer code modules (e.g., executable code, object code, source code, script code, machine code, etc.) configured for execution by the processing circuit 112. In some embodiments, the vehicle controller 110 may represent a collection of processing devices. In such cases, the processing circuit 112 represents the collective processors of the devices, and the memory 114 represents the collective storage devices of the devices.

In one embodiment, the vehicle controller 110 is configured to selectively engage, selectively disengage, control, or otherwise communicate with components of the vehicle 10 (e.g., via the communications interface 116, a controller area network (“CAN”) bus, etc.). According to an exemplary embodiment, the vehicle controller 110 is coupled to (e.g., communicably coupled to) components of the aerial ladder 50, the mast 52, the alert system 120, and the CAMS module(s) 200. By way of example, the vehicle controller 110 may send and receive signals (e.g., control signals, location signals, etc.) with the components of the aerial ladder 50, the mast 52, the alert system 120, and/or the CAMS module(s) 200.

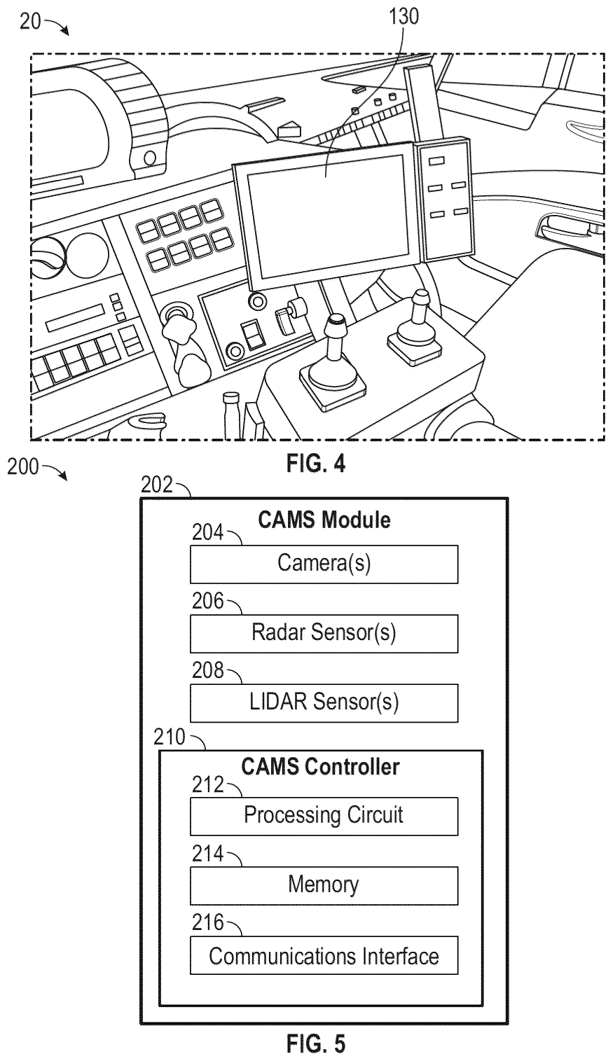

As shown in FIG. 3, the alert system 120 includes the light system 80, the audio system 90, a display device, shown as display 130, and personnel warning devices, shown as personnel devices 140. As shown in FIG. 4, the display 130 is configured as an in-cab display disposed within an operator area of the front cabin 20. In some embodiments, the display 130 or a second display is positioned outside of the front cabin 20 (e.g., along a side of the front cabin 20, along a side of the rear section 30, along a rear of the rear section 30, etc.). As shown in FIG. 3, the personnel devices 140 include first devices, shown as mobile devices 132, and/or second devices, shown as wearables 134. The mobile devices 132 may be or include radios, cell phones, smartphones, tablets, beepers, and/or other suitable portable user devices that can communicate wirelessly, track position, provide audible feedback (e.g., alerts, warnings, etc.), and/or provide haptic feedback that may be carried by personnel on a scene at which the vehicle 10 is located. The wearables 134 may be or include position trackers (e.g., global positioning system (“GPS”) sensors), smartwatches, smart rings, and/or other wearable devices that can communicate wirelessly, track position, provide audible feedback, and/or provide haptic feedback.

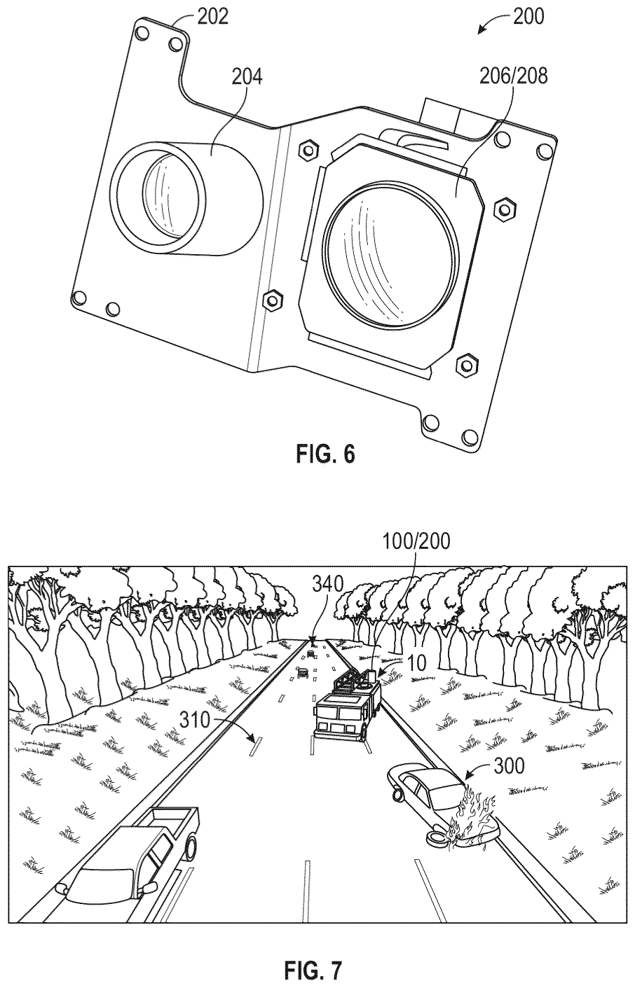

As shown in FIGS. 5 and 6, the CAMS module 200 includes a support, shown as sensor housing 202, that receives and/or supports a plurality of sensors, shown as camera(s) 204, radar sensor(s) 206, and LIDAR sensor(s) 208. In some embodiments, the CAMS module 200 does not include the LIDAR sensor(s) 208. In some embodiments, the CAMS module 200 does not include the radar sensor(s) 206. According to an exemplary embodiment, (a) the camera(s) 204 are configured to acquire image data (e.g., still images, video, etc.) regarding an environment proximate the vehicle 10 and (b) the radar sensor(s) 206 and/or the LIDAR sensor(s) 208 are configured to acquire CAMS data regarding moving objects proximate and/or approaching the vehicle 10 (e.g., within a 100, 200, 300, 400, 500, 600, 700, 800, 900, 1000, etc. foot range of the vehicle 10).

As shown in FIG. 5, the CAMS module 200 includes a second controller, shown as CAMS controller 210. The CAMS controller 210 may be implemented as a general-purpose processor, an ASIC, one or more FPGAs, a DSP, circuits containing one or more processing components, circuitry for supporting a microprocessor, a group of processing components, or other suitable electronic processing components. According to the exemplary embodiment shown in FIG. 5, the CAMS controller 210 includes a processing circuit 212, a memory 214, and a communications interface 216. The processing circuit 212 may include an ASIC, one or more FPGAs, a DSP, circuits containing one or more processing components, circuitry for supporting a microprocessor, a group of processing components, or other suitable electronic processing components. In some embodiments, the processing circuit 212 is configured to execute computer code stored in the memory 214 to facilitate the activities described herein. The memory 214 may be any volatile or non-volatile or non-transitory computer-readable storage medium capable of storing data or computer code relating to the activities described herein. According to an exemplary embodiment, the memory 214 includes computer code modules (e.g., executable code, object code, source code, script code, machine code, etc.) configured for execution by the processing circuit 212. In some embodiments, the CAMS controller 210 may represent a collection of processing devices. In such cases, the processing circuit 212 represents the collective processors of the devices, and the memory 114 represents the collective storage devices of the devices.

In one embodiment, the CAMS controller 210 is configured to selectively engage, selectively disengage, control, or otherwise communicate with components of the vehicle 10 (e.g., via the communications interface 216, a controller area network (“CAN”) bus, etc.). According to an exemplary embodiment, the CAMS controller 210 is coupled to (e.g., communicably coupled to) other components of the CAMS 100. By way of example, the CAMS controller 210 may send and receive signals (e.g., control signals, location signals, etc.) with the components of the vehicle controller 110 and/or the alert system 120.

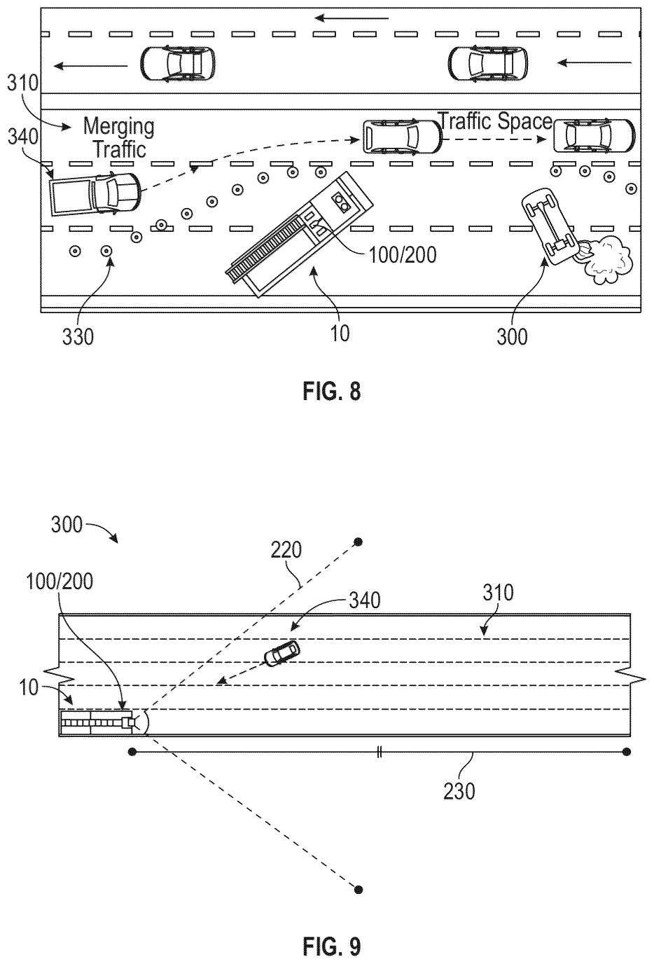

As shown in FIG. 7-9, the vehicle 10 is parked proximate an incident, scene, or closed area, shown as scene 300, along a roadway, shown as road 310, in a blocking arrangement blocking one or more lanes of the road 310. The scene 300 may be an accident, a construction area or site, a parade route, a street festival, and/or other possible scenes where vehicles, pedestrians, response personnel, booths, stages, etc. may be positioned along the road 310. In some embodiments, as shown in FIG. 8, the scene 300 includes one or more boundary markers, shown as scene markers 330, that at least partially define the perimeter of the scene 300. The scene markers 330 may be or include flares, cones, light boards, barriers (e.g., moveable concrete barriers, water barrels, etc.), light beacons (further information regarding the light beacons may be found in U.S. Patent Publication No. 2023/0234498, filed Jan. 25, 2023, which is incorporated herein by reference in its entirety), and/or other boundary markers.

As shown in FIG. 7-9, the vehicle 10 is positioned on the road 310 in the blocking arrangement to prevent approaching vehicles 340 from entering the scene 300. However, as operators of the approaching vehicles 340 become more distracted by technology (e.g., infotainment systems, smartphones, cell phones, etc.) while driving, there are increased risks of the approaching vehicles 340 driving into the vehicle 10 and/or the scene 300, damaging the vehicle 10 and putting personnel (e.g., response personnel, construction workers, police officers, firemen, paramedics, etc.) and pedestrians (e.g., injured persons, festival/parade attendees, etc.) on the scene 300 in harm's way.

According to the exemplary embodiment shown in FIG. 7-9, the CAMS 100 is configured to monitor the vehicle 10, the scene 300, and/or the adjacent/proximate areas therearound and provide advanced warning when one or more of the approaching vehicles 340 pose a threat to the vehicle 10 and/or the scene 300. More specifically, the vehicle controller 110 and/or the CAMS controller 210 are configured to (a) analyze the image data captured or acquired via the camera(s) 204 and/or the radar/LIDAR data captured or acquired via the radar sensor(s) 206 and/or the LIDAR sensor(s) 208 to monitor an area proximate the vehicle 10, (b) detect and track movements of the approaching vehicles 340 and characteristics thereof (e.g., speed relative to the vehicle 10, heading relative to the vehicle 10, relative distance to the vehicle 10, path of travel, size, type of vehicle, etc.), (c) assess and determine a threat level associated with the approaching vehicles (e.g., risk of impact with the vehicle 10, risk of entering a scene the vehicle 10 is blocking, timing of impact, severity of impact, etc.), and (d) initiate or engage the alert system 120 in response to the threat level exceeding a threat threshold (e.g., more likely than not to impact the vehicle 10 and/or enter the scene). Herein, the functionality of the CAMS 100 is described in the context of the vehicle controller 110 and/or the CAMS controller 210. It should be understood that any one of the functionalities described herein may be performed or controlled by the vehicle controller 110, the CAMS controller 210, and/or the combination thereof. Accordingly, various data, command, signals, etc. may be transmitted therebetween to perform one or more of the functions described herein. Further, in some embodiments, the vehicle controller 110 and/or the CAMS controller 210 are the same or a single controller (e.g., the CAMS module 200 does not include the CAMS controller 210 and the vehicle controller 110 performs the functions of the CAMS controller 210).

As shown in FIG. 9, the CAMS module 200 (e.g., the camera(s) 204, the radar sensor(s) 206, the LIDAR sensor(s) 208) has a field of view, shown as FOV 220, and a sensing range, shown as range 230. In some embodiments, the FOV 220 is greater than or equal to 60 degrees (e.g., greater than 60 degrees, greater than or equal to 75 degrees, greater than or equal to 90 degrees, etc.). In some embodiments, the range 230 is greater than or equal to 100 feet (e.g., greater than 100 feet, greater than or equal to 200 feet, greater than or equal to 250 feet, about 264 feet, greater than or equal to 300 feet, greater than or equal to 500 feet, etc.).

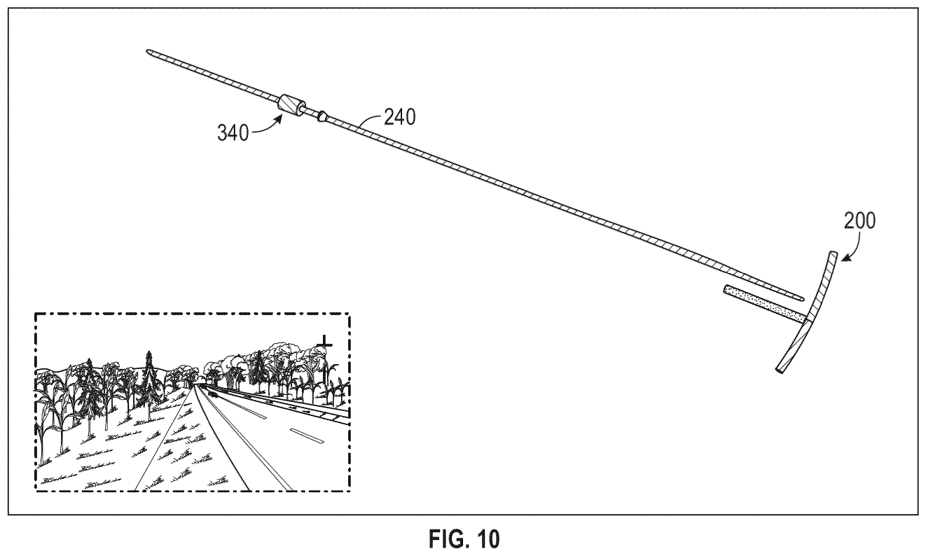

As shown in FIG. 10, the radar sensor(s) 206 and/or the LIDAR sensor(s) 208, of the CAMS module 200 are configured to transmit a plurality of signals (e.g., radar signals, LIDAR signal, etc.), shown as signals 240, down the road 310 and away from the scene 300 toward objects including the approaching vehicles 340. The radar sensor(s) 206 and/or the LIDAR sensor(s) 208 are configured to receive the signals 240 back to acquire the radar/LIDAR data (e.g., point cloud data) regarding detected objects. Based on the radar/LIDAR data, the vehicle controller 110 and/or the CAMS controller 210 are configured to detect moving and non-moving objects and filter out non-moving objects to reduce noise. For the moving objects, the vehicle controller 110 and/or the CAMS controller 210 are configured to detect and track movements of the moving objects and characteristics thereof including a speed relative to the vehicle 10 and/or the CAMS module 200, a heading relative to the vehicle 10 and/or the CAMS module 200, a relative distance to the vehicle 10 and/or the CAMS module 200, a path of travel, a size, a type of object, and/or other characteristics. Based on at least the speed and/or the size, the vehicle controller 110 and/or the CAMS controller 210 may be configured to distinguish between vehicle objects or the approaching vehicles 340 and non-vehicle objects (e.g., pedestrians, animals, bicyclists, etc.), and filter out the non-vehicle objects to further reduce noise.

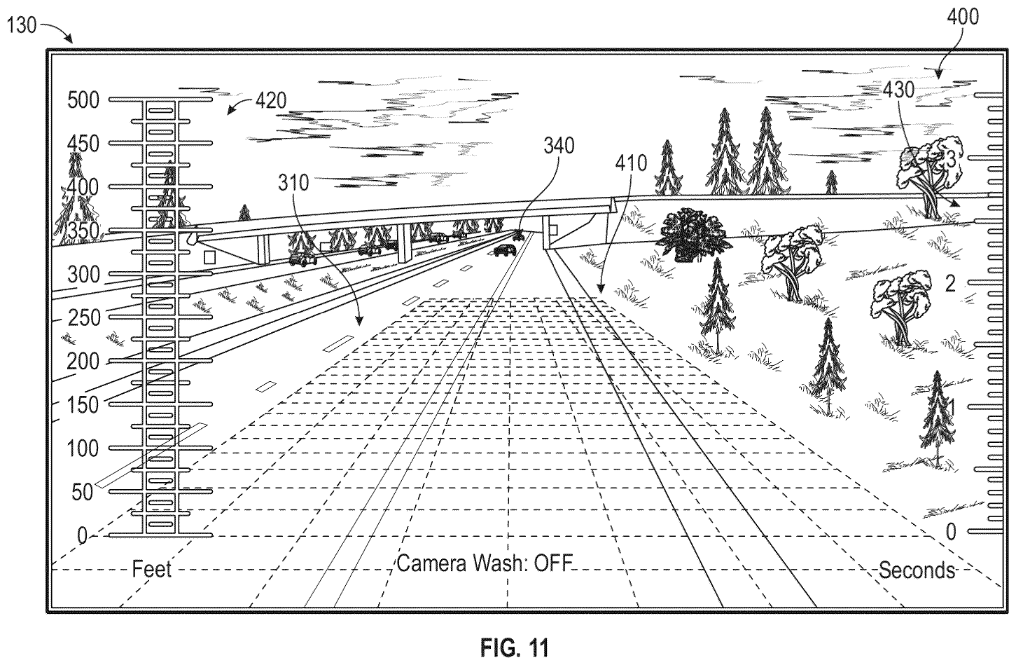

According to an exemplary embodiment, the camera(s) 204 of the CAMS module 200 is configured to acquire image data regarding the proximate area in front of the CAMS module 200. As shown in FIG. 11, the vehicle controller 110 and/or the CAMS controller 210 are configured to provide the image data for display on the display 130 to provide a display, shown as live display 400, of the proximate area in front of the CAMS module 200 to an operator of the vehicle 10. The vehicle controller 110 and/or the CAMS controller 210 are configured to overlay a sensor detection zone 410, a distance legend 420, and a time legend 430 onto the live display 400 based on the image data and/or the radar/LIDAR data. The sensor detection zone 410 may define an area that the CAMS module 200 is actively monitoring for the approaching vehicles 340 or an area that is used to evaluate risk associated with the approaching vehicles 340. The distance legend 420 provides distance measurements so that an operator can evaluate distance between the approaching vehicles 340 and the vehicle 10. The time legend 430 provides time measurements so that an operator can evaluate a time until the approaching vehicles 340 reach the vehicle 10. In some embodiments, the vehicle controller 110 and/or the CAMS controller 210 are configured to overlay the CAMS data onto the live display 400.

In some embodiments, the vehicle controller 110 and/or the CAMS controller 210 are configured to perform object recognition on the image data to detect and track the approaching vehicles 340 including a path of the approaching vehicles 340, a size of the approaching vehicles 340, and/or a type of the approaching vehicles 340 (e.g., a motorcycle, a sedan, a SUV, a truck, a semi-truck, a response vehicle, etc.). The image data and the radar/LIDAR data may be used together for redundancy or as a confirmation that both the camera(s) 204 and the radar sensor(s) 206 and/or the LIDAR sensor(s) 208 are sensing the same thing.

According to an exemplary embodiment, the vehicle controller 110 and/or the CAMS controller 210 are configured assess and determine a threat level associated with the approaching vehicles 340 based on the detection and tracking of the approaching vehicles 340 (e.g., the speed, the heading, the size, the path of travel, the type, etc.). The threat level may be evaluated or determined based on the risk of impact of the approaching vehicles 340 with the vehicle 10 (e.g., based on heading, distance, and speed), the risk of the approaching vehicles 340 entering the scene 300 that the vehicle 10 is blocking (e.g., based on heading, distance, and speed), the estimated timing of impact (e.g., based on vehicle speed and distance), and/or the severity of impact (e.g., based on speed and size). By way of example, if one of the approaching vehicles 340 is traveling at a high rate of speed on a heading toward the vehicle 10 and/or the scene 300 and is within a certain distance or time of arrival where it is unlikely that the driver would be able to avoid the vehicle 10 and/or the scene 300, the threat level may be determined to be high. By way of another example, if one of the approaching vehicles 340 is traveling at a low rate of speed on a heading away from the vehicle 10 and/or the scene 300, the threat level may be determined to be low. By way of still another example, if one of the approaching vehicles 340 is traveling at a high rate of speed on a heading toward the vehicle 10 and/or the scene 300, but the approaching vehicle 340 is a response vehicle (e.g., indicated by flashing lights detected via object recognition), the threat level may be determined to be low.

According to an exemplary embodiment, the vehicle controller 110 and/or the CAMS controller 210 are configured to initiate or engage the alert system 120 in response to the threat level exceeding a threat threshold (e.g., more likely than not to impact the vehicle 10 and/or enter the scene 300, a high threat level, etc.). In some embodiments, the vehicle controller 110 and/or the CAMS controller 210 are configured to activate one or more components of the light system 80 or alter the operation of one or more components of the light system 80 (e.g., change the color, change the cadence or pattern, etc.) to alert or warn the personnel on the scene 300 in response to the threat level exceeding the threat threshold. In some embodiments, the vehicle controller 110 and/or the CAMS controller 210 are configured to activate one or more components of the audio system 90 (e.g., activate the siren 92, activate the horn 94, activate the loudspeaker and/or the in-cab speaker to provide an evacuation or warning message, etc.) or alter the operation of one or more components of the audio system 90 (e.g., change the sound, change the volume, etc.) to alert or warn the personnel on the scene 300 in response to the threat level exceeding the threat threshold. In some embodiments, the vehicle controller 110 and/or the CAMS controller 210 are configured to provide a warning or alert via the display 130 and/or an in-cab speaker to instruct an operator in the front cabin 20 to evacuate the vehicle 10 in response to the threat level exceeding the threat threshold. In some embodiments, the vehicle controller 110 and/or the CAMS controller 210 are configured to initiate or engage the light system 80 and/or the audio system 90 to direct lights and/or sounds at the operator of the approaching vehicle 340 to alert or warn the operator of the scene 300 so that the operator can take mitigating actions (e.g., slow down, pull over, swerve out of the path of the vehicle 10 and the scene 300, etc.). In some embodiments, the vehicle controller 110 and/or the CAMS controller 210 are configured to transmit a wireless signal (e.g., via the communications interface 116, via the communications interface 216, a short-range signal, a radio signal, a Wi-Fi signal, a Bluetooth® signal, etc.) to the personnel devices 140 proximate the vehicle 10 and/or on the scene 300 (e.g., within a range of the wireless signal) in response to the threat level exceeding the threat threshold. Upon receipt of the wireless signal, the personnel devices 140 are configured to initiate an alarm, output a message, vibrate, or perform some other function to warn the personnel holding or wearing the personnel devices 140 to take cover or evacuate the scene 300.

### Adaptive Threat and Abnormality Detection

In some embodiments, the CAMS 100 is configured to detect the approaching vehicles 340 near the scene 300 and perform a threat analysis on the approaching vehicles 340. The threat analysis may determine whether each approaching vehicle 340 presents a threat to the scene 300 and/or the vehicle 10 (e.g., driving too quickly near the vehicle 10, has the potential to collide with the vehicle 10, personnel at the scene 300, or other objects at the scene, may enter an area with workers at the scene 300, etc.). The CAMS 100, for example, may be configured to predict future trajectories of the approaching vehicles 340 or use an artificial intelligence model to determine if each approaching vehicle 340 has the potential to cause a threat condition.

The variety of scenes at which the vehicle 10 may be deployed may result in analysis difficulties for a static threat analysis system. Geometry of the scene (e.g., road curvature, number of lanes, size of the shoulder, etc.), current weather conditions, traffic density, etc. may cause the CAMS 100 to incorrectly identify a vehicle as threat and/or incorrectly identify a vehicle as not being a threat. The false alarms could lead workers and drivers to ignore warnings from the CAMS 100. In addition, false negatives could lead to a threat condition continuing, potentially leading to a collision. In some embodiments, the CAMS 100 provides adaptive threat detection to adjust threat detection capability to a particular scene 300. The CAMS 100 may analyze the typical driver patterns around the vehicle 10 that has recently been deployed to the scene 300. The CAMS 100 may learn frequently occurring patterns (e.g., trajectories, paths, etc.) of the approaching vehicles 340 and determine/identify such patterns to not be a threat. Non-threatening driving patterns result in clusters with which the CAMS 100 can compare and adjust the threat risk (e.g., probability, severity, etc.) and/or suppress the alarms or other actions to be taken.

In some embodiments, the CAMS 100 is configured to compare the behavior of an approaching vehicle 340 against typical vehicle behavior (e.g., pre-trained, from the learned clusters, etc.) and identify the approaching vehicle 340 as a threat based on the comparison. For example, comparisons can be made to the vehicle speeds, number of lane changes, distance from typical vehicle trajectories or a cluster thereof, or any other feature indicative of creating a threat condition near the scene 300. The CAMS 100 may be able to detect if a driver is not in control of an approaching vehicle 340 (e.g., the approaching vehicle 340 is yawing or spinning). The CAMS 100 may be able to detect nearby accidents that could pose a risk to the vehicle 10.

In some embodiments, the CAMS 100 is configured to adjust expected behavior (e.g., stopping distance, predicted trajectories, safe traveling speed, etc.) based on the current weather conditions. Weather conditions may be received from onboard sensors, weather services (e.g., current observations, predictions, etc.), and/or inferred from the behavior of the vehicle 10 (e.g., motion sensors, anti-lock brake systems, etc.). Weather conditions may be used to increase or otherwise adjust the probability of a threat condition or risk of a particular detected vehicle or trajectory thereof.

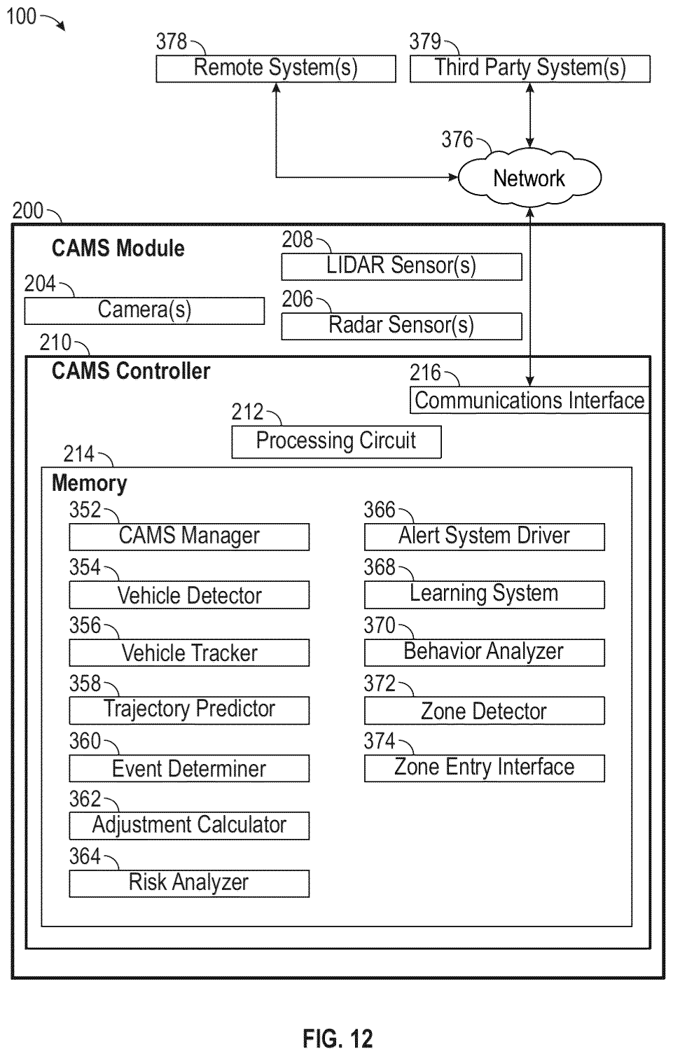

As shown in FIG. 12, the CAMS 100 is configured to communicate with external systems using the communications interface 216. The communications interface 216 may be a network interface card, cellular modem, cellular module, or any other hardware capable of communicating on a network 376. The network 376 may include routers, switches, antennas, computers, and any other hardware required to communicate information from the CAMS module 200 (e.g., from the CAMS controller 210) to a remote system 378 or a third-party system 379. The network 376 may include a number of networks (e.g., cellular networks, the internet, etc.) traversed by data communicated between a CAMS module 200 and the remote system(s) 378 or the third-party system(s) 379. A portion of the network 376 may be wireless and/or a portion of the network 376 may be wired.

In some embodiments, the CAMS 100 includes (e.g., communicably connected to) remote systems 378. The remote systems 378 may provide the CAMS 100 with remote connectivity. For example, the remote systems 378 may allow remote configuration and/or monitoring of the CAMS 100. Communications to the remote systems 378 may provide dispatchers, news organizations, social media, etc. status updates of the scene 300. For example, the CAMS 100 may detect vehicles approaching the vehicle 10, determine the speed of the vehicle and report average speeds to the remote system 378 so that traffic delays may be calculated. The CAMS 100 may also detect other potentially related accidents and communicate such accidents to the remote system 378. The remote systems 378 may also be used to request additional vehicles, equipment, personnel, etc. by a worker or automatically as determined by the CAMS 100.

The CAMS 100 may connect to the third-party systems 379 using the network 376. The third-party systems 379 may enrich the CAMS 100 with additional information (e.g., sensor measurements, repositories, maps, traffic reporting systems, etc.). For example, the CAMS 100 may receive (e.g., subscribe to, request through an API, etc.) current weather information and/or forecasts. The CAMS 100 may also connect to navigation services to receive information about the current traffic situation near the scene 300 and/or to communicate information related to traffic events to navigation services so that vehicles may be routed away from the scene 300, and thus, the CAMS 100 may provide a reduction in the threat posed by other vehicles approaching the vehicle 10 at the scene 300 and may provide personnel at the scene with a less threatening work environment. Navigation services and/or similar mapping type services may be used to determine the topology of the scene 300 (e.g., hills of the road, etc.).

As shown in FIG. 12, the memory 214 of the CAMS controller 210 includes a CAMS manager 352, a vehicle detector 354, a vehicle tracker 356, a trajectory predictor 358, an event determiner 360, an adjustment calculator 362, a risk analyzer 364, an alert system driver 366, a learning system 368, a behavior analyzer 370, a zone detector 372, and a zone entry interface 374. In some embodiments, the components 352-374 represent instruction sets or code stored in the memory 214. The instructions may be executed by the processing circuit 212 of the CAMS module 200. The CAMS manager 352 may be configured to control the timing and flow of data through the other circuitry of the CAMS controller 210. For example, the CAMS manager 352 may cause the instructions or circuits to execute in a specific order to perform the function of the CAMS controller 210. In some embodiments, the CAMS manager 352 may route the information and/or outputs of other modules that are dependent on the information or use the information as an input. Instructions, modules, portions of memory, etc. described as configured to perform a function (or described as performing the function) may include embodiments for which the module is configured to cause the performance of the function (or is causing the performance of the function). Similarly, instructions, modules, portions of memory, etc. described as configured to cause the performance of a function (or described as causing the performance of a function) may include embodiments for which the module is configured to perform the function (or is performing the function).

The vehicle detector 354 may perform object recognition on the image data to detect the approaching vehicles 340 including a path of the approaching vehicles 340 (e.g., distinguish a vehicle from other objects in the scene), a size of the approaching vehicles 340, and/or a type of the approaching vehicles 340 (e.g., a motorcycle, a sedan, a SUV, a truck, a semi-truck, a response vehicle, etc.). The vehicle detector 354 may receive vision and/or image data from the camera(s) 204, the radar sensor(s) 206, and/or the LIDAR sensor(s) 208 to perform the vehicle detection. Various rule-based and/or artificial intelligence (“AI”) techniques can be used by the vehicle detector 354 to perform vehicle detection. For example, machine vision AI models (e.g., convolutional neural networks, etc.) can be provided inputs in the form of images (e.g., of one or more color channels) or sequences of images and output locations of the vehicle within the image (e.g., a pixel location or bounding box). AI models may be trained to recognize vehicles and/or different types of vehicles as part of the overall machine vision system of the CAMS controller 210. Rule-based systems may also be used in combination with or instead of AI models. For example, edge detection could be performed within a scene by calculating brightness and/or color gradients and template (e.g., shape) matching could be used to determine the type, size, etc. of the detected object defined by the edges.

The vehicle tracker 356 may be configured to track the trajectory of the approaching vehicles 340 (e.g., the speed, the heading, the size, the path of travel, the type, etc.). The vehicle tracker 356 may receive an image with a detected vehicle and associate that detected vehicle with a detected vehicle from a similar image (e.g., associate the two positions with the same vehicle). The vehicle tracker 356 may save the various positions of an approaching vehicle 340 as the approaching vehicle 340 approaches the vehicle 10 to build a historical (e.g., recent past) trajectory of the approaching vehicle 340. For example, the trajectory may be saved and made available for the trajectory predictor 358 to determine likely future paths of the approaching vehicle 340. In some embodiments, the vehicle tracker 356 may use two or more historical positions of the trajectory in order to estimate the speed of the approaching vehicle 340 (e.g., using finite difference equations). The radar sensor(s) 206 may also be used to calculate speed (e.g., using the Doppler effect). The LIDAR sensor(s) 208 may be used to calculate speed (e.g., by calculating the speed based on two consecutive distance determinations). In some embodiments, radar-, LIDAR-, and/or camera-based speed and position calculations are combined to create a better estimate of the speed and/or position of the approaching vehicle 340. For example, multiple sensors modalities may be used to reduce the uncertainty in the estimates. In some embodiments, radar-, LIDAR-, and/or camera-based speed and/position calculations are combined to perform sensor fault detection on the various sensors and/or algorithms. For example, if one of the sensors generates a speed or position estimate that is significantly different than estimates from other sensors, the sensor generating the different estimate may be flagged (e.g., indicated, etc.) as faulty. Outlier analysis or other statistical tests may be performed to determine whether an estimate is significantly different than others. For example, the difference between the sensor estimates or each estimate and an average of the estimates may be compared to a threshold (e.g., a statistically generated threshold). Responsive to a sensor being identified as faulty, a respective indication may be activated or another remediation action may be taken. For example, the CAMS module 200 may indicate that the identified sensor requires maintenance or replacement and/or may no longer use data from the identified sensors to generate speed and/or position estimates of approaching vehicles 340.

In some embodiments, geometry (e.g., topology of the road, curves in the road, etc.) of the scene 300 is taken into account to improve the trajectory, speed, and positions estimates. In some embodiments, the sensors of the CAMS module 200 (e.g., the camera(s) 204, the radar sensor(s) 206, the LIDAR sensor(s) 208) may be positioned at an elevation (e.g., on the mast 52, on the aerial ladder 50, etc.) and the height of each type of sensor relative to the ground may be used to improve the speed and trajectory positions. In some embodiments, the vehicle tracker 356 is configured to obtain (e.g., generate, receive, etc.) a function that maps positions in two-dimensional images of the camera(s) 204 to positions in a three-dimensional coordinate system of the scene 300 (e.g., including topology of the scene 300, curves in the road, distance from the vehicle 10). For example, the mapping may be generated based navigation services, topological maps, GPS services, etc. and used to improve trajectory positions and/or speeds of the approaching vehicles 340.

The trajectory predictor 358 may be configured to predict a future trajectory of an approaching vehicle 340. The trajectory predictor 358 may use, as input a historical trajectory provided by the vehicle tracker 356, geometry of the scene 300, lane markings, past trajectories of other vehicles, etc. in order to generate the prediction of the trajectory. Predicted vehicle trajectories can be used to determine if a trajectory of a currently approaching vehicle 340 may result in a threat situation. For example, by predicting if the trajectory will result in a collision with the vehicle 10, a nearby object, a worker, enter a restricted zone, or if the future trajectory will cause the approaching vehicle 340 to approach the vehicle 10 too closely and/or at too high of a rate of speed, a threat situation or condition may be determined.

Vehicle trajectories may be predicted using various methods. For example, a spline or other fitting function (e.g., curve, polynomial, dynamic system, etc.) may be fit to the past positions of the vehicle trajectory and the direction, curvature, etc. of the fitting function may be projected forward (e.g., in time). The changes in vehicle speed (e.g., acceleration or deceleration) may also be projected forward in time to create a prediction of both position and speed into the future (e.g., the predicted trajectory).

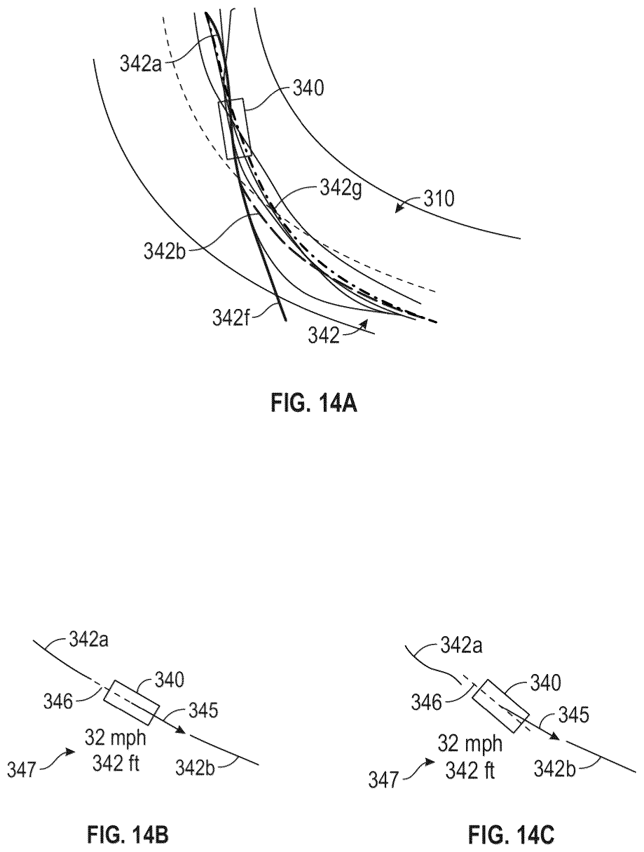

A vehicle may not remain on the predicted trajectory (e.g., the driver of the vehicle may provide additional control inputs). In some embodiments, the trajectory obtained by extrapolating a fitting function forward in time is combined with typical vehicle trajectories (e.g., an average vehicle path, center of the lane, etc.) to project the trajectory forward in time. For example, the predicted trajectory may be the weighted average of the trajectory from the fitting function extrapolation and the typical trajectory, where weighting factors are changed from more heavily weighting the extrapolation to more heavily weighting the typical trajectory as the prediction is made further forward in time. Weights, for example, can follow a sigmoid function with time or a linear function with time. In some embodiments, AI models are trained to directly predict future trajectories from past positions and/or speeds. Combining a typical trajectory with an extrapolation is described in more detail with reference to FIG. 14A.

The event determiner 360 may be configured to determine a threat score (e.g., probability, possibility, figure of merit, etc.) associated with the likelihood that a threat condition will result given the information (e.g., past and/or current position and/or speed estimates). The event determiner 360 may calculate a higher threat score if the likelihood of a threat condition is higher. For example, the event determiner 360 may determine if the projected trajectory is expected to take the approaching vehicle 340 near (e.g., within 10, 20, etc. feet, or within a restricted zone) the vehicle 10 and/or the scene 300. The threat score, for example, may be how close the approaching vehicle 340 is expected to come to the vehicle 10 and/or the scene 300. In some embodiments, the event determiner 360 may calculate the threat score based on an amount of time the driver can maintain the current trajectory and remain safe (e.g., not encroaching the vehicle 10 too closely, colliding with the vehicle 10, or entering a restricted zone). For example, if the driver has fifteen seconds to react, the threat score may be low (e.g., representing a low likelihood of a threat condition) and, if the driver only has five seconds to react, the threat score may be high (e.g., necessitating some type of alert). In some embodiments, the sensor data is input to an AI model to determine the likelihood of a threat condition. For example, the input (e.g., past trajectory of positions and speeds or images from the camera(s) 204, the radar sensor(s) 206, and/or the LIDAR sensor(s) 208) may be directly classified as threatening or not threatening by the AI model.

In some embodiments, the event determiner 360 is configured determine the threat score based on a likelihood (e.g., risk, probability, etc.) that an approaching vehicle 340 will enter a restricted zone encompassing the blocker vehicle, scene or lane markers, personnel, a disabled vehicle, etc. For example, the event determiner 360 may determine whether a predicted (e.g., projected) trajectory of an approaching vehicle 340 enters the restricted zone. In some embodiments, the threat score is based on the time until the predicted trajectory enters the restricted zone (e.g., based on the time the driver of the approaching vehicle 340 has to react). In some embodiments, the predicted trajectory includes an expanding uncertainty region (e.g., a cone, etc.) and the threat score is based on the amount (e.g., area, probability, etc.) of the region that intersects (e.g., crosses, etc.) a boundary of the restricted zone.

In some embodiments, the threat score for a detected vehicle is based on past trajectories of vehicles that have previously approached the scene (e.g., unthreatening trajectories) and position measurements of the detected vehicle acquired by the sensors (e.g., the camera(s) 204, the radar sensor(s) 206, and/or the LIDAR sensor(s) 208). For example, a threat score may be calculated for the detected vehicle and then adjusted up if the position measurements are not similar to the past trajectories (e.g., satisfy a dissimilarity criterion, etc.) or down if the position measurements are similar to the past trajectories (e.g., satisfy a similarity criterion, etc.). In some embodiments, the past trajectories are incorporated into the calculation of the threat score. For example, an neural network or other artificial intelligence model may be used to calculate a threat score based on the past trajectories and the position measurements of the detected vehicle. In some embodiments, the threat score is based upon a comparison of the past trajectories and the position measurements (e.g., without an adjustment step). In some embodiments, the threat score is based on a future trajectory of the detected vehicle, for example, predicted based on the position measurements. The threat score may be based on (a) the position measurements and based on the future trajectory and (b) the past trajectories. For example, the position measurements (e.g., the previous positions of the detected vehicle) and the future trajectory may be combined to determine a trajectory for the detected vehicle as it traverses the environment proximate the scene 300. The combined trajectory for the detected vehicle and the past trajectories of the other vehicles may then be compared. In some embodiments, the threat score is adjusted by the adjustment calculator 362 and/or the learning system 368.

The adjustment calculator 362 may be configured to adjust the likelihood of a threat condition (e.g., the threat score). The adjustment calculator 362 may adjust (e.g., adapt) the threat score based on additional information received and/or sensor information regarding the vehicle 10 itself (e.g., antilock brakes information during transit to the scene, windshield wipers being activated, cold temperatures, etc.). For example, low temperatures may increase the score (e.g., because of an increased chance of ice), rain and/or snow may increase the score (e.g., because of increased stopping distances), high traffic volume may increase the score (e.g., more potential for a vehicle to be unable to execute a lane change). In some embodiments, a separate module is not used to perform the score adjustment and the information described to cause an adjustment is directly fed to the event determiner 360 (e.g., for use by an AI network, etc.).

The risk analyzer 364 may be configured to generate a second score, for example, a risk score related to the risk of a threat condition. The risk score, for example, may represent or relate to a probability multiplied by a severity of the threat condition. The risk analyzer 364 may calculate a higher risk score related to a collision than for an entry into a restricted area or passing too closely to the vehicle 10. The risk analyzer 364 may also calculate the risk score based on the type of vehicle, for example, by calculating a higher risk associated with the potential for a collision with a tractor-trailer (e.g., semi-truck) than with a motorcycle. Motorcycles, for example, may be able to change trajectories more quickly and affect the vehicle 10 less if there is a collision. In some embodiments, the risk score is determined by multiplying the threat score by a severity modifier (e.g., a multiplier related to the severity of the threat).

The alert system driver 366 may be configured to activate the alert systems 120 to alert drivers, workers, bystanders, etc. of a potential threat condition. If a trajectory of an approaching vehicle 340 is projected to collide with the vehicle 10, enter a restricted zone or otherwise be a threat, an alert may be generated. For example, the alert system driver 366 may transmit an alert signal in response to the threat score exceeding a threshold. The alert signal may be configured to activate an alert system associated with the vehicle 10 (e.g., alert system 120), activate a collision avoidance system of an approaching vehicle, or activate a threat mitigation system of the vehicle 10 (e.g., active threat mitigation, deploying external airbags, force dispersion devices, bracing the vehicle 10, etc.). Alert signals may be transmitted wirelessly, for example, to systems of the vehicle 10, to an approaching vehicle 340, and/or to devices worn or carried by personnel associated with the scene 300. Alert signals may also be transmitted over wire, trace, or other conductive element, for example, to connected systems. Alert severity may increase with the threat score related to the likelihood of a threat condition and/or the risk score. For example, a first stage of the alert system driver 366 may include causing the light system 80 of the vehicle 10 to flash (e.g., turning on rotating beacon lights or strobe lights on top of the vehicle 10, flashing headlights or taillights, etc.). If beacon or strobe lights are already deployed, the alert system driver 366 may cause the lights to flash more intensely or with a different pattern. A second stage of the alert system driver 366 may cause the audio system 90 (e.g., the horn 94, the siren 92, etc.) to activate to get the attention of the driver of the approaching vehicle 340 with the threatening trajectory and/or to alert workers and/or bystanders of the potential for a threat condition (e.g., collision, etc.). In some embodiments, the vehicle 10 may alert workers of the potential threat situation via the personnel devices 140 (e.g., causing an audio or haptic alarm on a watch, radio, etc.). The vehicle 10 may also deploy deceleration reduction and/or force dispersion devices (e.g., external airbags, etc.) if it is determined that a collision is imminent (e.g., if the threat or risk score exceeds a particular threshold).

In some embodiments, the alert system driver 366 may alert personnel at the scene if the personnel are about to enter a more dangerous area at the scene 300. For example, the alert system driver 366 may be configured to transmit a second alert signal to a device worn or carried by a person associated with the scene in response to the person leaving a protected area (e.g., upstream or downstream of the vehicle 10, the restricted zone, etc.). Such an alert may be predictive and/or be generated when personnel are within a threshold distance from a boundary of the restricted zone or other protected area.

In some embodiments, the CAMS 100 is configured to adapt to a particular scene 300. The geometry (e.g., road topology, etc.) of the scene 300 may make it difficult for either the trajectory predictor 358 to accurately predict future trajectories of vehicles near the scene 300 and/or the event determiner 360 to accurately calculate a threat score related to the likelihood of a threat condition. The learning system 368 may be configured to adapt the trajectory predictor 358 and/or the event determiner 360 to the specific scene 300. The learning system 368 also may be configured to adjust the outputs of the trajectory predictor 358 and/or the event determiner 360. For example, each trajectory from the vehicle tracker 356 may be used to update weights (e.g., to train, fine-tune, adjust, etc.) in an AI neural network-based (or other machine learning model) trajectory prediction and/or likelihood determination.

The learning system 368 may receive trajectories from the vehicle tracker 356 and use those trajectories to adjust the outputs of the CAMS 100. For example, clusters of trajectories may be determined and marked (e.g., flagged, indicated, etc.) as unthreatening for a given scene 300, preventing or minimizing the number of false alarms that are issued by the alert system driver 366. To determine clusters of vehicle trajectories, trajectories may be converted into a feature embedding and clustered using geometric approaches such as k-means, Gaussian mixture models, etc. Clusters may also be determined using an agglomerative clustering approach, for example, by using an integrated absolute difference (e.g., the integral of the absolute value of the difference) between two trajectories as a distance metric. Trajectories found within a cluster may be used to train, update, or otherwise adjust the parameters of an AI model used to perform trajectory prediction and/or likelihood determination. The representative (e.g., average) cluster of a trajectory may also be used to serve as the basis of a trajectory prediction. For example, a historical trajectory of a detected vehicle may be compared to the cluster (e.g., a trajectory within the cluster, or a representative trajectory of the cluster) to determine which cluster best represents the detected vehicles trajectory. The forward prediction of the trajectory can then be combined with the representative trajectory of the cluster over time as the trajectory is predicted out into the future as described with reference to the trajectory predictor 358.

In some embodiments, clusters of trajectories from the learning system 368 are used to adjust a predicted future trajectory of an approaching vehicle. The learning system 368 may determine a cluster that is similar to past positions of the approaching vehicle. For example, the learning system 368 may calculate an observed trajectory from the past positions and compare the observed trajectory to the clusters. In some embodiments, the learning system 368 calculates a similarity measure (e.g., average similarity or distance with each trajectory of the cluster, similarity or distance to a representative trajectory of the cluster, etc.). The cluster having maximum similarity with the observed trajectory may be used by the trajectory predictor 358 to adjust the prediction.

In some embodiments, the cluster having maximum similarity (e.g., best match to the observed trajectory) is used to calculate the threat score (e.g., by the event determiner 360). Member trajectories of the cluster may be used as input by the event determiner 360. For example, the member trajectories may be input to a neural network or other artificial intelligence model used to determine the threat score. In some embodiments, a representative trajectory (e.g., average, etc.) of the cluster is used as input to the event determiner 360. The representative trajectory may be based on the member trajectories of the cluster. In some embodiments, the value of the maximum similarity to a cluster is used to adjust the threat score of the event determiner 360. For example, if the similarity of a cluster is high, the threat score may be adjusted downwards, for example, indicating that the trajectory appears similar to that of other unthreatening trajectories. If the maximum similarity is low, the threat score may be left unadjusted or adjusted upwards, for example, indicating an increased threat level when a similar trajectory has not been previously encountered.

The behavior analyzer 370 may be configured to compare the behavior of an approaching vehicle 340 (e.g., past trajectory, current trajectory, orientation, etc.) to the behavior of other approaching vehicles 340 and issue an alert to the alert system driver 366 if the behavior is found anomalous or as outlier. The historical trajectory of the approaching vehicle 340 can, for example, be compared to each cluster identified for a given scene 300 (e.g., by integrated absolute difference to a representative trajectory of the cluster), and if no cluster matches the trajectory within an acceptance criterion an alert may be generated. Behavior may also be feature-based (e.g., rather than trajectory-based). Trajectories may be converted into a vector feature embedding, where the dimensions represent various features of the behavior, for example, integral of the square of the curvature of the trajectory, vehicle acceleration, centripetal acceleration of the vehicle, number of lane changes, angle between direction of travel and the direction of vehicle orientation, or any number of other numeric representations of the behavior of the approaching vehicle 340. Outlier behavior may be identified in the feature space and an alert issued. For example, outliers may be identified using Wilks'theorem, density-based spatial clustering of applications with noise (“DBSCAN”), the Mahalanobis distance, etc. In some embodiments, if the trajectory of an approaching vehicle is determined to be an outlier, the threat score is increased and/or an alert signal is transmitted.

The behavior analyzer 370 may also be configured to detect anomalous behavior (in addition to being different than the previous trajectories). For example, the behavior analyzer 370 may determine whether the detected vehicle is traveling parallel to its longitudinal axis. An significant angle (e.g., satisfying a detection criterion or threshold) between the longitudinal axis and the direction of motion may indicate an out-of-control vehicle (e.g., in a spin or fish-tail). The 370 may cause the threat score to be increased and/or an alert signal to be activated responsive to the angle being significant (e.g., greater than a threshold angle, etc.). In some embodiments, the behavior analyzer 370 may determine a quantity of times the detected vehicle changes directions, swerves, etc. and cause the threat score to be increased and/or directly transmit an alert signal. The behavior analyzer 370 may also determine the average absolute value of the second derivative of the trajectory or its deviation from a straight line to determine if the detected vehicle is approaching erratically and the threat score should be increased, be high, or an alert signal should be activated.

The zone detector 372 and zone entry interface 374 are related to determining zones (e.g., restricted areas) near the vehicle 10 and the scene 300 and are described in more detail herein.

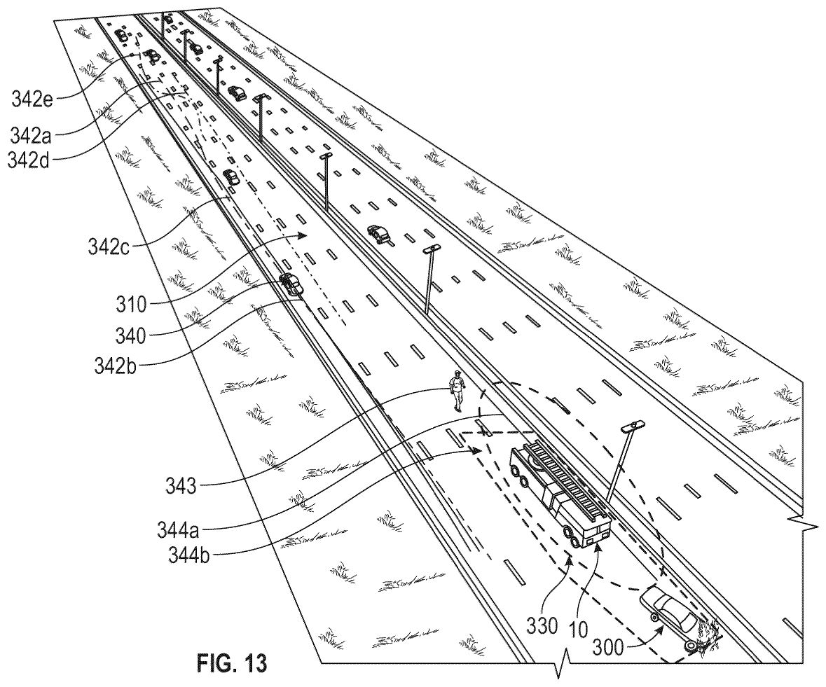

With reference to FIG. 13, the scene 300 is described with greater detail to better understand the functionality of the CAMS 100 according to some embodiments. The scene 300 may be a typical scene of an accident and/or disabled vehicle on a road 310. The vehicle 10 is shown situated in a lane of the road 310, upstream of the flow of traffic relative to the disabled car to block the approaching vehicles 340 from colliding with the disabled car and/or personnel 343 at the scene 300 attending to the driver of the disabled vehicle, removing the disabled vehicle, etc. Markers (e.g., cones, beacons, flares, barricades, etc.), shown as scene markers 330 may be deployed to better indicate the need to change lanes as the approaching vehicles 340 approach the scene 300.

Trajectories 342 are shown overlaid on the scene 300 of FIG. 13. The trajectories 342 may include (e.g., store, represent, etc.) the position and speed of an approaching vehicle 340 over time. For example, the approaching vehicle 340 may be detected by the vehicle detector 354 and the position and speed monitored by the vehicle tracker 356 as previously described. A past trajectory 342a (e.g., of the approaching vehicle 340) may be created and stored by the vehicle tracker 356. The past trajectory 342a may be used to predict a future trajectory 342b of the approaching vehicle 340. In some embodiments, the past trajectories of multiple vehicles 342c (e.g., that were unthreatening) may be stored and used to help predict the future trajectory 342b of the approaching vehicle 340.

With reference to FIG. 14A, an approach to predict the future trajectory 342b (indicated by the dashed line with long dashes) of an approaching vehicle 340 using the past trajectory 342a of the approaching vehicle 340 and other vehicle trajectories 342 is described in more detail according to some embodiments. The vehicle tracker 356 may track the past trajectory 342a of the approaching vehicle 340 and using the past trajectory 342a project vehicle positions and speed into the future. For example, the vehicle tracker 356 and/or the trajectory predictor 358 may track the approaching vehicle 340 by fitting the past trajectory 342a to a function (e.g., spline, polynomial, etc.) and extrapolating forward in time. The extrapolation may form an extrapolated trajectory 342f (indicated by the thick, solid line). However, it may be unlikely that the driver of the approaching vehicle 340 will input no more control on the approaching vehicle 340 and follow the extrapolated trajectory 342f. It may be more likely that the driver will maneuver the approaching vehicle 340 similarly to previous vehicles that have followed the other trajectories 342 (indicated by thin, solid lines). The trajectory predictor 358 may anticipate some input from the driver at various times to converge towards a representative trajectory 342g of the trajectories 342 (indicated by the dashed line with alternating long and short dashes). The representative trajectory 342g may, for example, be the average of all previous trajectories 342 that followed a similar path as the approaching vehicle 340. The trajectory predictor 358 may predict the future trajectory 342b by calculating a weighted average of the extrapolated trajectory 342f and the representative trajectory 342g. For example, a weighted average (e.g., the future trajectory 342b) may be calculated by xₚ(t)=(1−w(t))xₑ(t)+w(t)x_{c}(t) where xₚ(t) is the future trajectory 342b, xₑ(t) is the extrapolated trajectory 342f, and x_{c}(t) is the representative trajectory 342g. The weight, w(t) may follow a sigmoid function of time such that the future trajectory 342b transitions from the extrapolated trajectory 342f to the representative trajectory 342g as prediction is performed forward in time (e.g., further from the current position of the approaching vehicle 340).

In some embodiments, less geometric approaches may be performed to calculate the future trajectory 342b. For example, dynamic systems representations of the approaching vehicle 340 may be used to predict position (e.g., using a Kalman filter) and/or neural network models or other machine learning techniques may be used to process a past trajectory (e.g., 342a and 342) to create a future trajectory 342b.

With reference to FIGS. 14B and 14C, an approach for detecting abnormal behavior of an approaching vehicle 340, specifically yawing (e.g., fish-tailing) and/or spinning is described according to some embodiments. In some embodiments, the vehicle tracker 356 can detect the orientation of the approaching vehicle 340 (e.g., detect a longitudinal axis 346 of the approaching vehicle 340). The vehicle tracker 356 may also determine the speed/range 347 and a current direction/heading of motion 345 of the approaching vehicle 340. For example, the direction/heading of motion 345 may be determined using a finite difference of previous locations of the approaching vehicle 340 in the past trajectory 342a. The longitudinal axis 346 should align with the direction of motion 345 (e.g., they should be parallel or have a small angle between them) if the approaching vehicle 340 is under control and operating normally. Yawing, as shown in FIG. 14C, is indicated by a larger angle between the longitudinal axis 346 and the direction/heading of motion 345. In some embodiments, the angle may be compared to a threshold by the behavior analyzer 370 to determine if an alert should be generated.

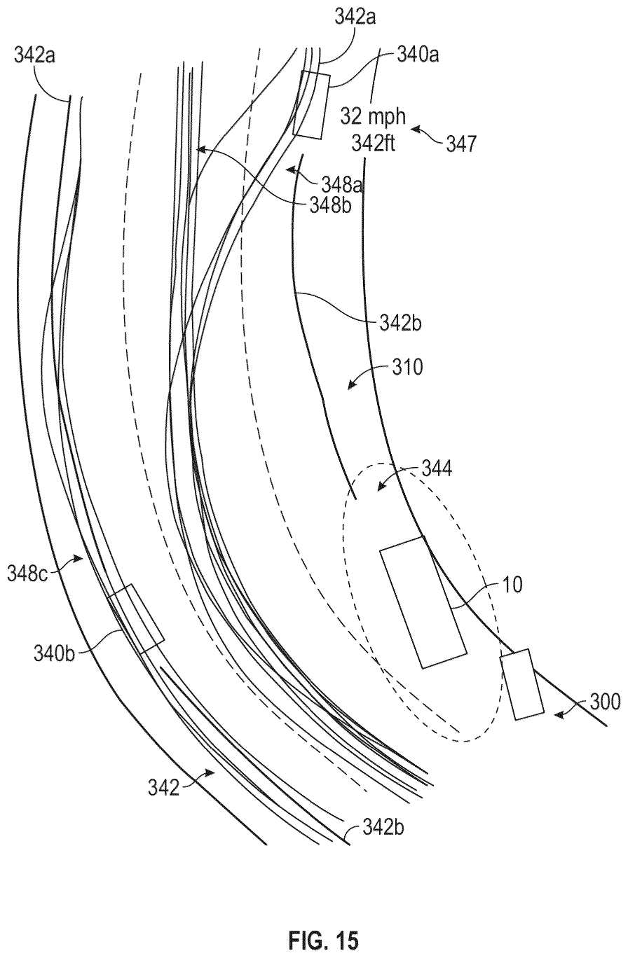

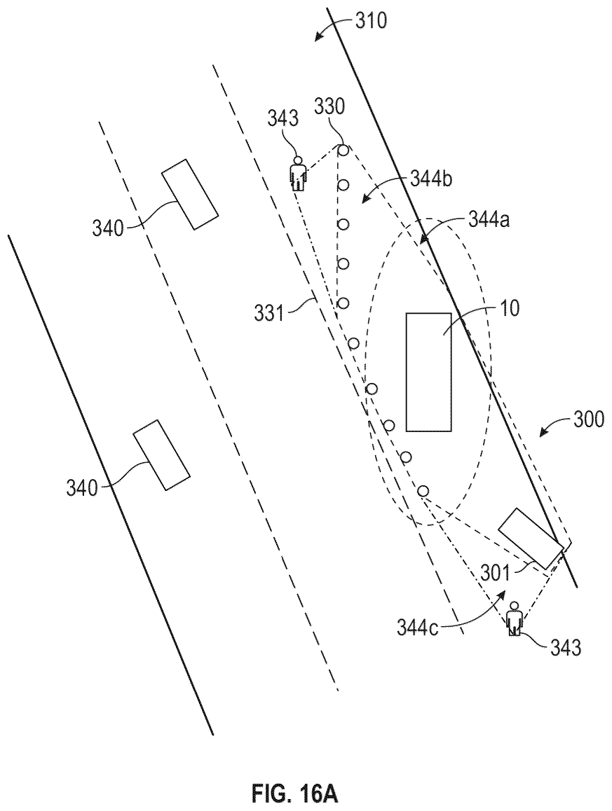

With reference to FIG. 15, a method for adjusting the analysis of the trajectory predictor 358 and/or the event determiner 360 is described in more detail according to some embodiments. FIG. 15 shows the scene 300 again with the vehicle 10 in a lane of traffic to protect the personnel and/or other people and the disabled vehicle from the approaching vehicles 340. An approaching vehicle 340a is shown with a historical trajectory 342a along with a future trajectory 342b. The future trajectory 342b may be calculated by the trajectory predictor 358 as described with reference to FIG. 14A or any other suitable initial prediction technique (e.g., curve fitting, dynamic system modeling, lane following, etc.). The future trajectory 342b is shown to enter a zone, shown as restricted zone 344, around the vehicle 10 and/or the scene 300. This may cause the event determiner 360 to determine there is a high likelihood of a threat condition and the alert system driver 366 may issue an alert. However, the approaching vehicle 340 is likely to perform a lane change to move around the scene 300 and no collision will occur. As more trajectories similar to that of 342a occur the CAMS controller 210 may learn that this situation is not threatening.

In some embodiments, the CAMS 100 can determine (e.g., group, create, etc.) clusters of trajectories 342 in order to learn unthreatening, potentially common, trajectories at a specific scene 300. Clustering may be performed using agglomerative hierarchical clustering, Gaussian mixture models, etc. as described with reference to the learning system 368. The learning system 368 may, for example, determine the trajectories 342 near approaching vehicle 340a form a cluster 348a of unthreatening trajectories. The cluster 348a of unthreatening trajectories may be used by the event determiner 360 to lower the value related to the probability of a threatening event as long as the approaching vehicle 340a is near the cluster 348a (e.g., using a distance metric) and/or traveling at a similar or lower speed. As shown in FIG. 15, the approaching vehicle 340a is still near a cluster 348a, however, if the approaching vehicle 340a continues in the current lane for much longer the distance from the cluster 348a may be far enough to cause the alert to be generated.

In some embodiments, the CAMS 100 also considers the speed of the approaching vehicle 340a when determining if the approaching vehicle 340a is operating within the cluster 348a of trajectories (e.g., when the event determiner is calculating a likelihood of an threat event). The speed/range 347 may be visible when viewing through a display of the CAMS 100 and may also be saved as part of each trajectory 342. The speed of the approaching vehicle 340 may be compared to that of the cluster 348a of trajectories as part of the determination. For example, if the speed of the approaching vehicle 340a is greater than the speed of the trajectories of the cluster 348a, the calculation may indicate less similarity to the cluster 348a (e.g., the approaching vehicle 340a is not following the cluster 348a and an alert should be issued) and if the speed of the approaching vehicle 340a is lower than the speed of the trajectories of the cluster 348a the calculation may indicate more similarity to the cluster 348a. The approaching vehicles 340 with a lower speed have more time to follow the cluster 348a of trajectories and thus the comparison between the cluster 348a and a trajectory at a lower speed may indicate a less threatening trajectory. In the example scene 300 of FIG. 15, the approaching vehicle 340a is traveling at 32 miles per hour. Because the approaching vehicle 340a is already near the last point previous vehicles have moved to the next lane, the speed may dictate if the current trajectory 342a is considered unthreatening. For example, if the majority of the trajectories in the cluster 348a have speeds in excess of 32 mph, an alert may not be sent. However, if the majority of the trajectories in the cluster 348a have slower speeds, the event determiner 360 may still estimate a high likelihood of a collision or other threat situation, which will cause an alert to be generated.

The scene 300 of FIG. 15 shows two additional clusters 348b and 348c, in this case following lanes of the road 310. Another approaching vehicle 340b may also be determined as unlikely to cause a threat event as the vehicle (i) has a future trajectory 342b that does not enter the restricted zone 344 and (ii) is following trajectory cluster 348c. In some embodiments, a distance comparison to the clusters or a representative trajectory of a cluster is not directly performed. Machine learning techniques can be used to train an AI model to classify (e.g., determine) an approaching vehicle 340 as not threatening or threatening. The trajectories of previous vehicles can be used to train (e.g., adjust the parameters of) the AI network for each new scene. For example, the CAMS 100 may have a pretrained AI network that is reset and adjusted for each new scene. In some embodiments, the training performed given a specific scene may only affect a portion of the AI network (e.g., a single layer), or the training may affect a network that is added on to the end of the pretrained network specifically for a given scene.

In some embodiments, the CAMS 100 may recognize that the vehicle 10 has been deployed to the same or similar scene 300 in the past. The CAMS 100 may recall previous clusters and/or AI networks developed by the learning system 368 in the past and use them initially to increase the speed at which the CAMS 100 adapts to the scene.

Referring again to FIG. 13, a trajectory 342d may be determined to be threatening because the trajectory 342d is in the lanes closer to the vehicle 10 for longer than most trajectories 342. In addition, the personnel 343 has moved upstream of the vehicle 10. This situation may cause the adjustment calculator 362 to increase the value related to probability of a threat event (e.g., because the personnel 343 is no longer protected by vehicle 10). The risk analyzer 364 may also increase the risk of the event because the personnel 343 may be severely injured even if struck at lower vehicle speeds. A trajectory 342e may also be determined to be a threat by the behavior analyzer 370, the trajectory 342e shows significantly more lane changes then any previously stored trajectories 342 from the scene 300. This may be considered a behavioral outlier and cause the generation of an alert.

### Scene Zone Creation

In some embodiments, the restricted zone 344 (e.g., a protected area, a zone that other vehicles should not enter, etc.) near the vehicle 10 can be adapted to a particular scene 300. With reference to FIG. 13, for example, a default restricted zone 344a may form a perimeter (e.g., an ellipse, rectangle, square, or any other suitable shape) around the vehicle 10 and then adapt based on placement of the scene markers 330, lane markers, road geometry, devices, sensors, or beacons carried or worn by personnel at the scene, etc. to form an updated zone, shown as second (e.g., updated) restricted zone 344b. In some embodiments, the restricted zone 344 is used by the event determiner 360 to determine a threat score. For example, the threat score may be based on a likelihood an approaching vehicle will enter the restricted zone 344. The restricted zone 344 may also be used by the alert system driver 366 to alert personnel if they leave the restricted zone 344 (e.g., by way of haptic feedback on a worn or carried device).

Referring back to FIG. 12, the zone detector 372 may be configured to determine a restricted zone around the vehicle 10 and/or the scene 300. The scene markers 330, lane markers, road geometry, etc. may be used by the zone detector 372 to determine a restricted zone 344 and communicate the restricted zone 344 to the event determiner 360. For example, the camera(s) 204, the LIDAR sensor(s) 208, and/or the radar sensor(s) 206 may detect the various markers and other objects and the zone detector 372 may use the detected objects to determine a boundary (e.g., edges, limits, etc.) of the restricted zone 344. In some embodiments, the scene markers 330 (e.g., cones, flares, flags, etc.) deployed by the personnel 343 of the scene 300 may include electronic beacons (e.g., RFID beacons, GPS beacons, ultra sonic beacons, near-field communication beacons, infrared beacons, etc.) that can be detected by the CAMS 100 to ensure accurate detection and creation of the restricted zone. After the restricted zone 344 is created, the event determiner 360 may determine if a trajectory is entering the restricted zone 344 created by the zone detector 372 and thus if there is a high likelihood of a threat event. In some embodiments, devices are worn or carried by personnel at the scene to facilitate tracking. The zone detector 372 may continually update the restricted zone 344 based on the position of the worn or carried devices.

The zone detector 372 may be configured to determine the restricted zone 344 based on the position of several objects (e.g., markers, devices, etc.) at the scene. The objects may be passive (e.g., their position may be determined by the camera(s) 204, the radar sensor(s) 206, and/or the LIDAR sensor(s) 208 and communicated in sensor data, for example, CAMS data) or the objects may be active (e.g., actively communicate their position to the CAMS module 200 to be included in the sensor data). In some embodiments, the zone detector 372 generates the restricted zone 344 by determining a shape that will encompass all of the objects (markers, personnel, etc.), the vehicle 10, and/or disabled vehicle 301 at the scene. The zone detector 372 may determine the smallest (e.g., least area) version of a shape that encompasses the objects, etc. For example, the zone detector 372 may determine parameters for the shape (e.g., a center and radius of a circle, foci and major/minor axes of an ellipse, corners of a rectangle, etc.). In some embodiments, the zone detector 372 solves an optimization problem to determine parameters for a shape. For example, by minimizing the area of the shape subject to constraints that the objects, etc. are within the shape. The type of shape used by the zone detector 372 may be predefined, entered by a user, and/or selected by the zone detector 372.

In some embodiments, the zone detector 372 determines the restricted zone 344 by generating a convex shape that encompasses all the of the objects, etc. For example, one or more of the objects may define vertices of a convex polygon that make up the restricted zone. The zone detector 372 may be configured to determine a smallest such convex shape. In some embodiments, one or more of the objects are used to fit a boundary of a predefined shape. For example, the one or more objects that define vertices of the smallest convex polygon may be used as data points to fit (e.g., minimizing a sum of Euclidean distance from the boundary or other objective function) a different shape (e.g., circle, ellipse, rectangle, etc.).

In some embodiments, the zone detector 372 includes a buffer region around any of the objects while generating the restricted zone 344. The constraints or rules used to generate the restricted zone 344 may include the buffer zone. The zone detector 372 thereby may generate a restricted zone 344 such that all objects are at least a certain distance away from the boundary of the restricted zone restricted zone 344. In some embodiments, a minimum distance from the boundary is used rather than defining a specific buffer region. The size and shape of the buffer zone or the minimum distance may be entered by a user or may be predefined. In some embodiments, different types of objects have different minimum distances (e.g., buffer region sizes). For example, the minimum distance between personnel and the boundary of the restricted zone 344 may be selected or predefined to be greater than the minimum distance between a lane marker and the boundary of the restricted zone.

In some embodiments, the zone detector 372 uses trajectories of vehicles that previously approached the scene 300 to adjust the restricted zone 344. For example, the zone detector 372 may adjust the restricted zone 344 based upon clusters of trajectories that were determined to be unthreatening. If a cluster of trajectories passes through the restricted zone 344 or otherwise intersects the restricted zone 344, the zone detector 372 may remove the area through which the cluster of trajectories passes from the restricted zone 344. In some embodiments, the zone detector 372 aligns the boundary of the restricted zone 344 with a representative trajectory of the cluster (e.g., the average trajectory, the trajectory that includes the most distance in the restricted zone 344, etc.).

The zone entry interface 374 may include instructions for generating a user interface within which the restricted zone 344 can be entered (e.g., drawn, selected, etc.) by the personnel 343. For example, the zone entry interface 374 may include instructions to cause the user interface to be displayed on the display 130 or the zone entry interface 374 may send instructions (e.g., JavaScript) to another client device (e.g., of a remote system 378, of the mobile devices 132, etc.) to generate a user interface where the restricted zone 344 can be entered. The restricted zone 344 can then be entered by a user by interacting with the user interface and activating callbacks and/or API calls to store the entered restricted zone in the CAMS 100.

In some embodiments, the user interface generated by instructions from the zone entry interface 374 display the restricted zone 344 (e.g., display the boundary thereof) on an overhead view of the scene 300. The zone entry interface 374 may receive overhead imagery from the camera(s) 204 and cause the restricted zone 344 to be overlaid on the overhead imagery. In some embodiments, positions of objects (e.g., markers, personnel, etc.) at the scene 300 are obtained from the camera(s) 204, the radar sensor(s) 206, and/or the LIDAR sensor(s) 208 and used to generate a rendering (e.g., two or three-dimensional rendering) of the scene. The restricted zone 344 may be overlaid on the rendering.

In some embodiments, the boundary of the restricted zone 344 is represented by one or more nodes connected by one or more edges (e.g., lines or curves) connecting the nodes. For example, the zone entry interface 374 may generate nodes corresponding to the objects detected at the scene or a subset thereof. In some embodiments, the user interface allows for interactive configuration of the restricted zone 344. For example, the zone entry interface 374 may generate instructions allowing for drag and drop interactions with the nodes defining the restricted zone 344. A drag and drop interaction may may activate a callback within the user interface that updates the position of the node and thus the overall geometry of the restricted zone 344 stored in or used by the CAMS controller 210.

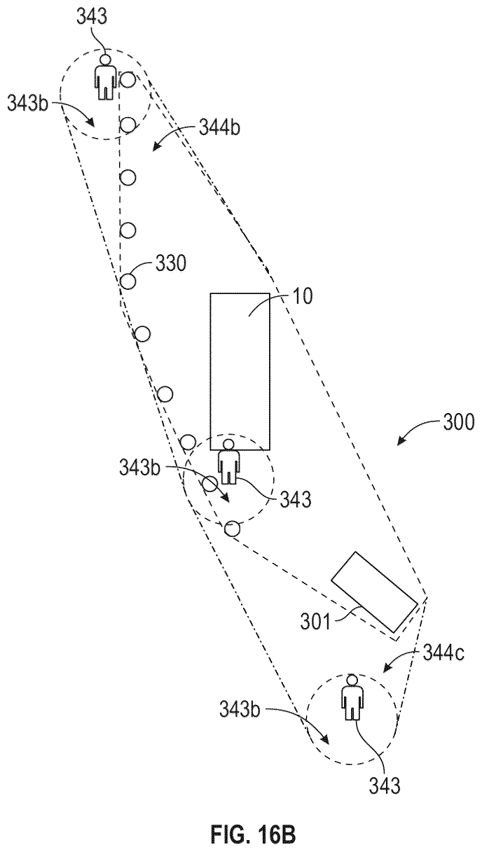

With reference to FIG. 16A, a method for determining a restricted zone 344 around the vehicle 10 at the scene 300 is described in more detail. Upon initially arriving to the scene 300, a default restricted zone 344a may be generated around the vehicle 10. The default restricted zone 344a may be an ellipse, circle, square, rectangle, or other closed shape that can be used to segment part of the scene 300 as restricted for the approaching vehicles 340. The restricted zone 344 may be the area within which the personnel 343 are expected to be. If vehicle trajectories are predicted to enter the restricted zone 344, an alert may be generated both to (i) alert the driver of the approaching vehicle 340 of the scene 300 and (ii) alert the personnel 343 of a potential threat condition so that they can move away from the lanes of traffic.

The default restricted zone 344a may, at some scenes 300, extend into a valid (e.g., open) lane of traffic and cause false alarms (e.g., superfluous alerts). In some embodiments, the learning system 368 may learn that trajectories in this lane are not threatening, but it may take some time for CAMS 100 to adapt. In some embodiments, the default restricted zone 344a can be modified automatically or by user entry after arrival. The personnel 343 may set the scene markers 330 to alert the approaching vehicles 340 of the restricted zone 344. The scene markers 330 may be detected by the CAMS 100 and used to automatically to generate an second restricted zone 344b. For example, the scene markers 330 may be detected by the camera(s) 204, the LIDAR sensor(s) 208, and/or the radar sensor(s) 206. As another example, the scene markers 330 may include electronic beacons (e.g., RFID beacons, GPS beacons, ultra sonic beacons, near-field communication beacons, infrared beacons, etc.) that can be detected by the CAMS 100.

To generate the second restricted zone 344b, the zone detector 372 may determine a closed boundary that encompasses the scene markers 330, the vehicle 10, and the disabled vehicle 301. For example, the zone detector 372 may detect the scene markers 330, the vehicle 10, and the disabled vehicle 301 to generate a polygon or other closed boundary that encompasses the scene 300. As another example, the zone detector 372 may use the scene markers 330 to generate splines (or other curves, lines, etc.) to define the boundary of the second restricted zone 344b. In some embodiments, other points can be added or otherwise used to generate the second restricted zone 344b. For example, the zone detector 372 may use lane markers 331 to generate at least one boundary of the second restricted zone 344b. The zone detector 372 may also use the edge of the road 310 or the other side of the road 310 to generate a boundary of the second restricted zone 344b.

In some embodiments, the personnel 343 (and/or other people) can be detected (e.g., by the camera(s) 204, by wearing a beacon, via the wearable 134, etc.) and used to generate the second restricted zone 344b, for example, by causing the second restricted zone 344b to include all personnel 343 and extend a distance beyond each person. FIGS. 16A and 16B shows an example where two personnel 343 have moved outside of the second restricted zone 344b generated using the scene markers 330. An third restricted zone 344c may be generated to include the personnel 343. For example, the perimeter defining the third restricted zone 344c may include the personnel 343 as depicted in FIGS. 16A and 16B with a dash-dot boundary where the third restricted zone 344c differs from the second restricted zone 344b.

As shown in FIG. 16B, in some embodiments, a buffer zone 343b (e.g., a buffer region, buffer area, etc.) may be created around each personnel 343 (and/or other people) (e.g., even if they remain inside the restricted zone 344). The buffer zones 343b may be any enclosed shape encompassing the personnel 343 (e.g., circle, square, etc.). In FIG. 16B, the buffer zones 343b are depicted as circles centered on the personnel 343. The buffer zone(s) 343b may be included in the third restricted zone 344c in some embodiments (e.g., boundary of the buffer zone included in generating a boundary of the buffer zone with a spline, etc.). For example, the third restricted zone 344c (e.g., depicted with the dash-dot line where it differs from the second restricted zone 344b) includes the buffer zones 343b of three personnel 343 that are either outside of the generated (e.g., generated using the scene markers 330, etc.) second restricted zone 344b or near the boundary of the second restricted zone 344b such that the buffer zone 343b extends beyond the second restricted zone 344b.

In some embodiments, a display device (e.g., the display 130, the mobile devices 132, a remote system 378, etc.) can be used to manually enter the restricted zone 344 or augment the automatically generated second restricted zone 344b. For example, instructions (code, an image, etc.) for a user interface can be generated by the zone entry interface 374 and delivered to the display device. The user interface may generate an overhead view of the scene 300 and the user can draw (e.g., using a mouse, touchscreen, etc.) boundaries overlaid on the overhead view. The user interface may include processing to simplify the boundaries (e.g., reduce the number of nodes or vertices defining the edges) of the restricted zone 344. In some embodiments, the restricted zone 344 can be entered by tracking one of the personnel 343 as they walk around the vehicle 10 and the scene 300 (e.g., by entering a zone entry mode in the zone entry interface 374). The personnel 343 may be tracked visually or by a wearable beacon (e.g., a wearable 134). For example, the personnel 343 may walk to a location and press a button on a user interface, on the beacon, etc. and thereby have the location included in the generation of the restricted zone 344.

In some embodiments, after the restricted zone 344 is detected and/or entered, the zone entry interface 374 may cause the user interface may generate an overhead view of the scene 300 with the second restricted zone 344b, or boundaries thereof, overlaid on the overhead view. The user may modify the boundaries in the user interface. For example, the user may add nodes to the boundary, drag a node of a boundary to another location, or perform other suitable interactions that the user interface can respond to and communicate an adjustment to the second restricted zone 344b to the CAMS controller 210.

### Operational Flows

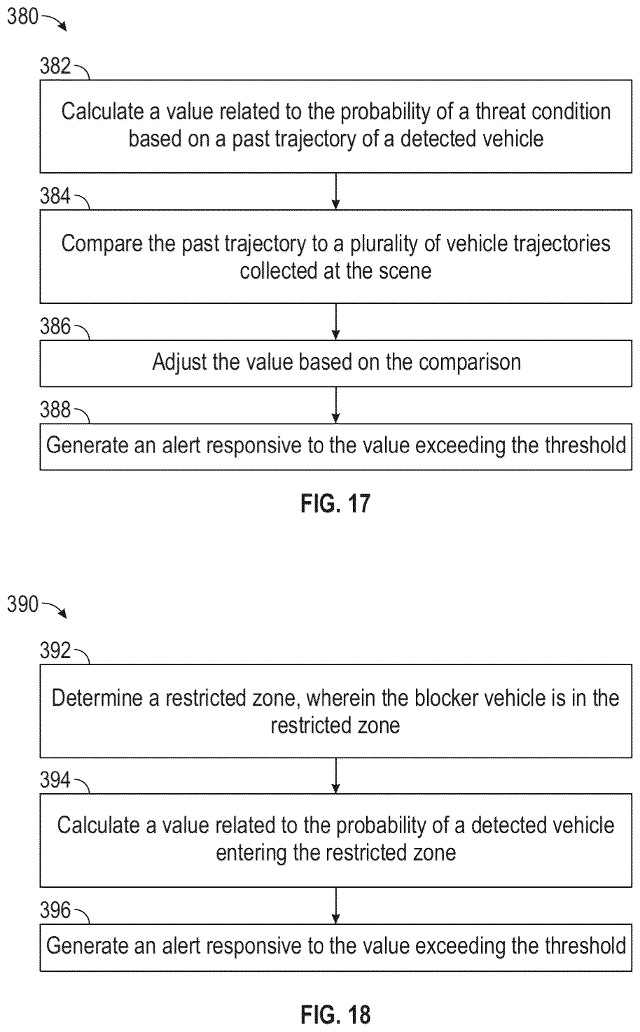

FIG. 17 shows a flow of operations 380 for generating an alert in response to the potential for a threat condition according to some embodiments. The flow 380 can, for example, be performed by the CAMS 100. The flow 380 uses the past trajectory 342a (e.g., recent past) of an approaching vehicle 340, previous trajectories 342a of other approaching vehicles 340 that have entered the scene of the disabled vehicle 301 and determines if an alert should be generated.

The flow 380 may include calculating a value related to the probability of an threat condition based on a past trajectory 342a (e.g., up and including the most recent positions and speeds available) of an approaching vehicle 340 in an operation 382. The value related to the probability may be calculated by executing a first artificial intelligence (“AI”) model. In some embodiments, a future trajectory 342b of the approaching vehicle 340 may be predicted based on the past trajectory 342a of the approaching vehicle 340 (e.g., by curve fitting and extrapolation, a dynamic systems model, a second AI model, as otherwise described with reference to the trajectory predictor 358, etc.). The future trajectory 342b may be used to determine if the scene 300 may become threatening, for example, if the approaching vehicle 340 poses a threat. For example, the future trajectory 342b (and/or the similarity score calculated by the first AI model) may be indicative of a collision with the vehicle 10, a collision with a person within sensing range of the vehicle 10, a collision with another object within sensing range of the blocker vehicle, or an entry into a restricted zone 344 encompassing the vehicle 10. The operation 382 may be performed by the event determiner 360 and may include additional operations described as being performed by the event determiner 360.

In some embodiments, a vehicle trajectory 342 may be analyzed by an AI model to directly determine if the behavior is indicative of a threat condition (e.g., without explicitly performing a prediction step). For example, the AI model may be trained on behavior that is not a threat (e.g., low speeds near a vehicle 10, controlled lane changes, etc.) and may directly output the value related to the probability of a threat condition in response to an input trajectory 342.

The flow 380 may include comparing the past trajectory 342a to a plurality of vehicle trajectories 342 collected at the scene in an operation 384. To identify trajectories known to not be a threat, clusters 348 of trajectories may be determined, either in an embedded feature space or using a distance metric, with agglomerative clustering. Some previously saved trajectories 342 may not fit within any cluster 348 well and can be removed prior to the comparison. An AI model or a distance metric (e.g., integrated absolute difference) may be used to calculate a similarity score between the trajectory 342 of the approaching vehicle 340 and other vehicles that have entered the scene. A high similarity score may be indicative of a trajectory that is not a threat, for example, because another vehicle has already followed a similar path at a similar speed. The operation 384 may be performed by the learning system 368 and/or the behavior analyzer 370. Any functionality described as being performed by the learning system 368 and/or the behavior analyzer 370 may be included in the operation 384.

In some embodiments, the flow 380 includes adjusting the value based on the comparison between the past trajectory 342a and the plurality of vehicle trajectories collected at the scene in an operation 386. For example, if similarity is high between one or more previous trajectories the value related to the probability of a threat condition may be adjusted down. The value may also be adjusted up if the similarity is low. In some embodiments, the amount of the adjustment can depend on the number of trajectories 342 that are similar (e.g., have a similarity greater than a threshold), a summation of the similarity scores, a summation of similarity scores that are above a threshold, etc. In some embodiments, the operations 384 and/or 386 are performed by the adjustment calculator 362, the learning system 368, and/or the behavior analyzer 370. The operation 384 may include operations described as being performed herein by the adjustment calculator 362, the learning system 368, and/or the behavior analyzer 370.

In some embodiments, the operations 382-386 or any combination thereof may be performed by a single AI model or other algorithm. For example, the AI model may accept the past trajectory 342a of the approaching vehicle 340 as an input along with a number of other trajectories 342, calculate a value related to the probability of a threat condition (e.g., a neuron's value from within the network), perform the comparison (e.g., by multiplying several aspects of the other trajectories by model weights and/or embedding the trajectories within the weights during training at the scene and combining that information with the detected vehicle's trajectory through the non-linear functions of the model), and adjust the value based on the comparison (e.g., calculating another, later, neuron's value).

The flow 380 may include generating an alert in response to the value being greater than a threshold in an operation 388. For example, turning on rotating beacon lights or strobe lights on of the light bar 82, flashing the front lights 84 or the rear lights 86, changing the pattern of the strobe lights, causing the audio system 90 (e.g., the horn 94, the siren 92, etc.) to activate, sending alerts to a wearable 134 nearby. In some embodiments, alert severity may increase with the score related to the likelihood of a threat condition and/or the risk score. For example, a first stage may include causing the light bar 82 of vehicle 10 to flash (e.g., turning on rotating beacon lights or strobe lights on top of the vehicle, flashing headlights or taillights, etc.). If beacon or strobe lights are already deployed, the alert may include causing the lights to flash more intensely or with a different pattern. A second stage of the alert may also include causing the audio system 90 (e.g., the horn 94, the siren 92, etc.) to activate to get the attention of the driver of the vehicle with the threatening trajectory and/or to alert the personnel 343 and/or bystanders of the potential for a threat condition (e.g., collision, etc.). In some embodiments, the vehicle 10 may alert the personnel 343 of the potential threat situation via wearable 134 (e.g., causing an audio or haptic alarm on a watch, radio, etc.). Deceleration reduction and/or force dispersion devices (e.g., external airbags, etc.) may also be deployed if it is determined that a collision is imminent. The operation 388 may be performed by the alert system driver 366 and include additional operations described as being performed by the alert system driver 366.

FIG. 18 shows a flow of operations 390 for generating an alert in response to the potential for a threat condition using a restricted zone according to some embodiments. The flow 390 can, for example, be performed by the CAMS 100. The flow 390 calculates a value related to the probability of an approaching vehicle 340 entering a restricted zone 344 and determines if an alert should be generated.

In some embodiments, the flow 390 includes determining a restricted zone 344 that encompasses the vehicle 10 in an operation 392. The restricted zone 344 may be based on various objects detected within the scene of the blocker vehicle. For example, scene markers 330 (e.g., barrels, cones, lane markers, flares, and/or other marker) can be used to determine a restricted zone 344 as described with reference to the zone detector 372. In some embodiments, the restricted zone 344 may be entered by personnel 343. For example, the personnel may use a user interface generated by instructions from the zone entry interface 374 to enter the restricted zone 344 or to adjust the restricted zone 344 (e.g., by way of drag and drop interactions). In some embodiments, the restricted zone 344 is generated based on the position of objects detected at the scene 300 or carried by personnel. For example, the operation 392 may be performed by the zone detector 372. Any of the operations or functionality described as being performed by the zone detector 372 may be included in the operation 392.

The flow 390 may also include calculating a value related to the probability (e.g., risk, likelihood, etc.) of an approaching vehicle 340 entering the restricted zone 344 in an operation 394. For example, the operation 394 may include determining a threat score. A future trajectory 342b of the approaching vehicle may be predicted based on the past trajectory 342a of the approaching vehicle 340 (e.g., by curve fitting and extrapolation, a dynamic systems model, a second AI model, as otherwise described with reference to the trajectory predictor 358, etc.). In some embodiments, the value related to the probability of a approaching vehicle 340 entering the restricted zone 344 may depend on the closest approach of the trajectory 342 to the restricted zone 344 and/or the greatest extent of the encroachment into the restricted zone 344 (e.g., the point of the future trajectory 342b within the restricted zone 344 at which the minimum distance to the boundary is maximized). In some embodiments, the operation 394 may be performed by the event determiner 360. Any of the operations or functionality described as being performed by the event determiner 360 may be included in the operation 394.

In some embodiments, an AI model may directly calculate the probably that the future trajectory 342b will enter the restricted zone 344. For example, an AI model may accept, as inputs, both the past trajectory 342a of the approaching vehicle 340 and information related to the restricted zone 344 (e.g., vertices of a polygon defining the restricted zone 344, nodes of a spline defining the boundary of the restricted zone 344, etc.).

The flow 390 may include generating an alert responsive to the value related to the probability of the detected vehicle entering the restricted zone 344 exceeding the threshold in an operation 396. The operation 396 may, for example, be the same or similar to the operation 388 and may incorporate any of the alerts described with reference to the alert system driver 366.

### Communication With Personnel Devices

According to an exemplary embodiment shown in FIG. 3, the vehicle controller 110 and/or the CAMS controller 210 are configured to send and receive signals (e.g., control signals, location signals, etc.) with the personnel devices 140 (e.g., the mobile devices 132 and the wearables 134). The signals sent by the vehicle controller 110 and/or the CAMS controller 210 to the personnel devices 140 may be indicative of (i) the image data captured or acquired via the camera(s) 204 and/or the radar/LIDAR data captured or acquired via the radar sensor(s) 206 and/or the LIDAR sensor(s) 208, (ii) the movements and characteristics of the approaching vehicles 340, (iii) the threat level associated with the approaching vehicles 340, and/or (iv) an alert or warning generated in response to the threat level exceeding the threat threshold. The signals received by the vehicle controller 110 from the personnel devices 140 may be indicative of locations of the personnel devices 140 (e.g., a location of the operator carrying a mobile device 132, a location of the operator wearing a wearable 134, etc.) relative to the vehicle 10, the scene 300, and/or the approaching vehicles 340.

According to an exemplary embodiment, the camera(s) 204, the radar sensor(s) 206, the LIDAR sensor(s) 208) are configured to acquire data to facilitate monitoring the sensor detection zone 410 to detect the one or more characteristics of the approaching vehicles 340. The movements and characteristics may include a speed relative to the vehicle 10 and/or the CAMS module 200, a heading relative to the vehicle 10 and/or the CAMS module 200, a location of the approaching vehicles 340, a relative distance to the vehicle 10 and/or the CAMS module 200, a path of travel, a size, a type of object (e.g., a type of the approaching vehicle 340, such as a fire fighting vehicle, an aerial ladder truck refuse truck, a concrete mixer truck, a military vehicle, a tow truck, a snow plow truck, a response vehicle, etc.), among other characteristics associated with the approaching vehicles 340.

Based on the movements and characteristics of the approaching vehicles 340, the vehicle controller 110 and/or the CAMS controller 210 are configured to determine a threat level associated with the approaching vehicle 340. The threat level may be evaluated or determined based on the risk of impact of the approaching vehicle 10 with the vehicle 10, the risk of the approaching vehicle 340 entering the scene 300 the vehicle 10 is blocking, the estimated timing of impact, and/or the severity of impact. The threat level may be compared with a threat threshold. By way of example, the characteristic may include the speed of the approaching vehicle 340 and the threat threshold may include a speed threshold (e.g., a speed limit of the road 310), such that the threat level may be determined to be high in response to the speed of the approaching vehicle 340 exceeding the speed threshold. By way of still another example, the threat threshold may include a distance threshold from the vehicle 10 and/or the scene 300, a weight threshold, an object type threshold, among other threat thresholds. By way of yet another example, the threat threshold may be a violation count threshold, such that when a number of violations (e.g., violation instances, number of times the approaching vehicle 340 has exceeded the speed threshold, etc.) of the approaching vehicle 340 exceeds the violation count threshold, the threat level may be determined to be high. By way of yet another example, the threat threshold may be a violation duration threshold, such that when a violation duration of the approaching vehicle 340 exceeds the violation duration threshold (e.g., the speed of the approaching vehicle 340 has exceeded the speed threshold for a duration exceeding the violation duration threshold, the duration of the heading of the approaching vehicle 340 toward the vehicle 10 and/or the scene 300 has exceeded the violation duration threshold, etc.), the threat level may be determined to be high. In some embodiments, the threat threshold varies depending on one or more conditions. By way of example, the threat threshold may vary based on weather such that the threat threshold is lower during poor weather conditions (e.g., while it is raining or after it has rained, rained more than 1 inch in a 24 hour period, after a rain event, snowing, foggy, etc.) such that the threat level exceeds the threat threshold more often than during or after normal weather conditions (e.g., non-rainy weather conditions, clear weather conditions, etc.).

In some embodiments, the vehicle controller 110 and/or the CAMS controller 210 are configured to communicate with one or more of the personnel devices 140 using one of various routing techniques where data, information, alerts, warnings, or commands are propagated via the communications interface 116, via the communications interface 216, a short-range signal, a radio signal, a Wi-Fi signal, a Bluetooth® signal, etc., such as a unicast method (a signal is propagated to a single, specific personnel device 140), a multicast method (a signal is propagated to a subset of the personnel devices 140), a broadcast method (a signal is propagated to all of the personnel devices 140), or an anycast method (a signal is propagated to the nearest personnel device 140). The vehicle controller 110 and/or the CAMS controller 210 may be configured to transmit signals to the personnel devices 140 based on the locations of the personnel devices 140.

In some embodiments, the vehicle controller 110 and/or the CAMS controller 210 are configured to adjust the warnings (e.g., tailor the warnings, send a particular warning from a plurality of predetermined, preexisting warnings, etc.) sent to the personnel devices 140 based on the locations thereof. By way of example, if the vehicle controller 110 and/or the CAMS controller 210 determine that one or more respective personnel devices 140 are located in a vulnerable area (e.g., in the scene 300, in a subsection of the scene 300, outside the scene 300, etc.) deemed to be at risk of being adversely affected by the approaching vehicle 340 (e.g., if the vehicle controller 110 and/or the CAMS controller 210 determine, based on the movements and characteristics of the approaching vehicles 340, that it is more likely than not that the approaching vehicles 340 will impact the vehicle 10 and/or enter the vulnerable area), the vehicle controller 110 and/or the CAMS controller 210 may transmit a signal to the respective personnel devices 140 indicative of the approaching vehicles 340. In such an example, if the vehicle controller 110 and/or the CAMS controller 210 determine that one or more respective personnel devices 140 are located in a safe area (e.g., an area outside of the vulnerable area, in the scene 300, in a subsection of the scene 300, outside the scene 300, etc.) not deemed to be at risk of being adversely affected by the approaching vehicle 340 (e.g., if the vehicle controller 110 and/or the CAMS controller 210 determine, based on the movements and characteristics of the approaching vehicles 340, that it is not likely that the approaching vehicles 340 will impact the vehicle 10 and/or enter the safe area), the vehicle controller 110 and/or the CAMS controller 210 may alter the signal transmitted to the respective personnel devices 140 to indicate that the respective personnel devices 140 are in the safe area. Said another way, the vehicle controller 110 and/or the CAMS controller 210 may send a first warning from a plurality of predetermined, preexisting warnings to the personnel devices 140 located in the vulnerable area so that the operators holding/wearing the personnel devices 140 can take mitigating actions (e.g., run away, take cover, etc.) and send a second warning from the plurality of predetermined, preexisting warnings to the personnel devices 140 located in the safe area so that the operators holding/wearing the personnel devices 140 are aware of the hazard (e.g., aware of the approaching vehicles 340, aware of the threat level, etc.), but that they do not need to take mitigating actions.

In some embodiments, the vehicle controller 110 and/or the CAMS controller 210 are configured to transmit a signal to a single personnel device 140 or a subset of personnel devices 140 based on the locations thereof. By way of example, if the vehicle controller 110 and/or the CAMS controller 210 determine that one or more respective personnel devices 140 are located in the vulnerable area, the vehicle controller 110 and/or the CAMS controller 210 may transmit a signal to the respective personnel devices 140 indicative of the approaching vehicles 340. In such an example, the vehicle controller 110 and/or the CAMS controller 210 may only transmit a signal to the respective personnel devices 140 located in the vulnerable area and may not transmit a signal to the other personnel devices 140 located outside of the vulnerable area.

In some embodiments, the warning transmitted to the personnel devices 140 by the vehicle controller 110 and/or the CAMS controller 210 includes a visual, an audible, and/or a haptic alert provided to the operator of the personnel devices 140 (e.g., the operator associated with the personnel devices 140, the operator carrying the personnel devices 140, etc.). By way of example, the visual alert may be provided to the operator via a display of the personnel devices 140. In such an example, the visual alert may include an indication of the locations of the approaching vehicles 340 on a map including the road 310, the location of the vehicle 10, and/or the locations of the personnel devices 140, the location of the scene 300, among other information. Further, the visual alert may include a live-feed (e.g., real-time image data) of the approaching vehicles 340 acquired by the camera(s) 204. By way of another example, the audible alert may be provided to the operator via a speaker of the personnel devices 140 or a speaker of the vehicle 10. By way of still another example, the haptic alert may be provided to the operator via a haptic actuator of the personnel devices 140.

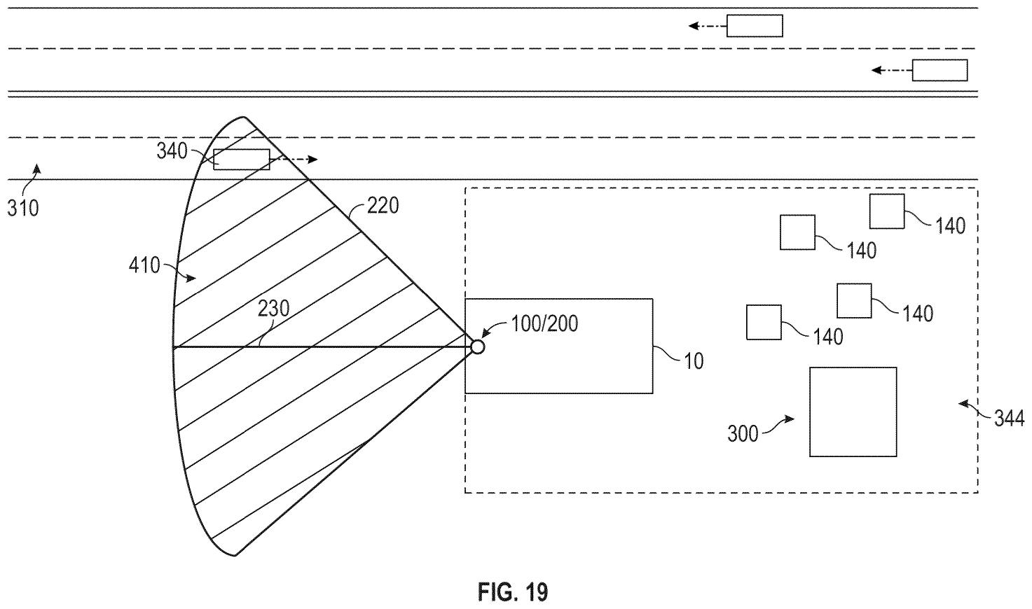

As shown in FIG. 19-21, (a) the camera(s) 204 are configured to acquire image data (e.g., still images, video, etc.) regarding the sensor detection zone 410 and (b) the radar sensor(s) 206 and/or the LIDAR sensor(s) 208 are configured to acquire radar/LIDAR data regarding moving objects proximate and/or approaching the sensor detection zone 410. The sensor detection zone 410 that the camera(s) 204, the radar sensor(s) 206, and/or the LIDAR sensor(s) 208 monitor to acquire image, radar, and/or LIDAR data is used by the vehicle controller 110 and/or the CAMS controller 210 to determine the threat level. As shown in FIG. 19-21, a restricted zone 344 is established (e.g., manually, automatically, etc.) around the vehicle 10, the personnel devices 140, and the scene 300 such that the camera(s) 204, the radar sensor(s) 206, and/or the LIDAR sensor(s) 208 monitor the sensor detection zone 410 including the approaching vehicles 340 to determine the threat level associated with the restricted zone 344. In some embodiments, the restricted zone 344 is established around an area down the road 310 and away from the scene 300 toward objects including the approaching vehicles 340. By way of example, the camera(s) 204, the radar sensor(s) 206, and/or the LIDAR sensor(s) 208 may monitor the sensor detection zone 410 and the vehicle controller 110 and/or the CAMS controller 210 may determine whether the restricted zone 344 (or a portion thereof) is a vulnerable area based on the threat level.

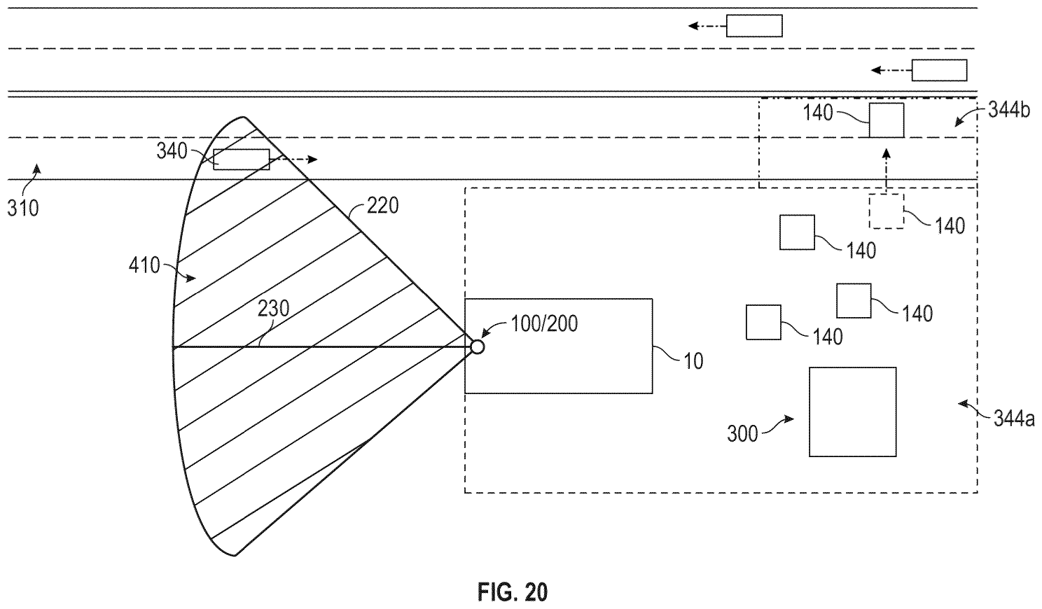

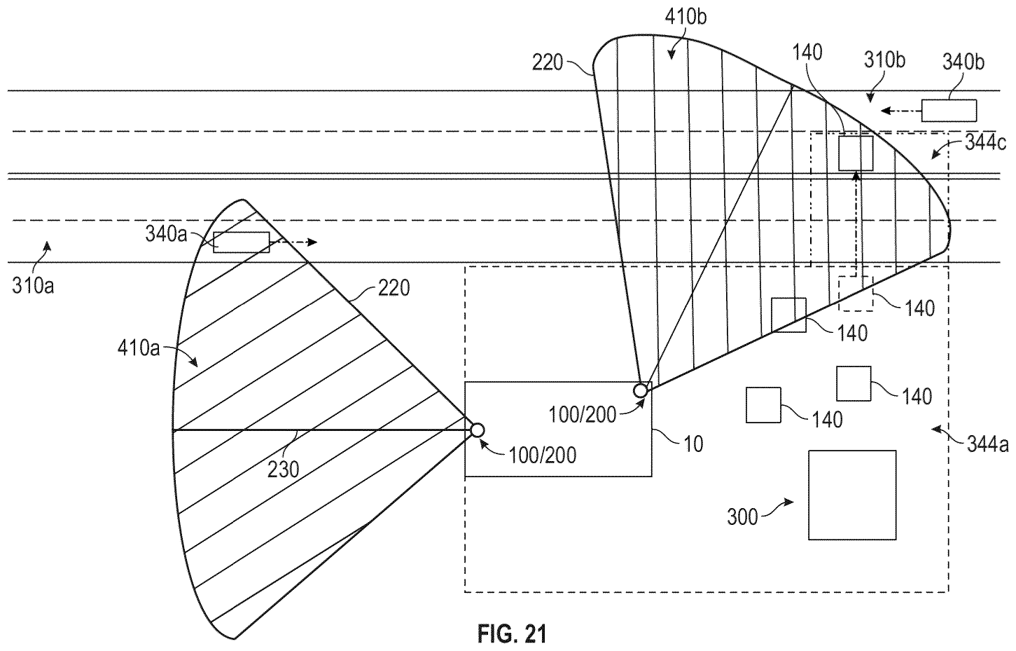

As shown in FIGS. 20 and 21, the restricted zone 344 is dynamic and changes shapes, lengths, sizes, etc., based on the location of the personnel devices 140. According to the exemplary embodiment shown in FIG. 20, the vehicle controller 110 and/or the CAMS controller 210 are configured to dynamically adjust (e.g., modify, change, reestablish, etc.) the boundaries of the restricted zone 344 from a first restricted zone 344a to a second restricted zone 344b such that the second restricted zone 344b encompasses the personnel devices 140 as the location thereof changes (e.g., as the operators holding/wearing the personnel devices 140 walk around the area proximate the vehicle 10 and/or the scene 300). Referring to FIG. 20, a personnel device 140 is shown crossing a boundary of the first restricted zone 344a and exiting the first restricted zone 344a. In response to a determination by the vehicle controller 110 and/or the CAMS controller 210 that the personnel device 140 exits the first restricted zone 344a, the vehicle controller 110 and/or the CAMS controller 210 are configured to dynamically adjust (e.g., modify, change, reestablish, etc.) the boundaries of the restricted zone 344 (e.g., transitions from the first restricted zone 344a to the second restricted zone 344b) such that the personnel devices 140 are located within the second restricted zone 344b. Accordingly, when the personnel devices 140 are located within the second restricted zone 344b, an area surrounding the personnel devices 140 in the second location is being monitored (e.g., an area that was previously not being monitored because no personnel devices 140 were located therein). In this manner, regardless of the location of the personnel devices 140 relative to the vehicle 10 or the scene 300, the CAMS 100 and/or the CAMS module 200 are configured continuously monitor the sensor detection zone 410 to determine whether the restricted zone 344 (e.g., the first restricted zone 344a, the second restricted zone 344b, etc.) with the personnel devices 140 located therein is vulnerable (e.g., if there is a high likelihood of an unsafe event) based on the threat level. In some embodiments, in response to a determination by the vehicle controller 110 and/or the CAMS controller 210 that the personnel device 140 exits the first restricted zone 344a, the vehicle controller 110 and/or the CAMS controller 210 are configured to transmit an indication to the personnel device 140 that the personnel device 140 has exited the restricted zone 344a.

As shown in FIG. 21, the vehicle controller 110 and/or the CAMS controller 210 are configured to dynamically adjust (e.g., modify, change, reestablish, etc.) the boundaries of the restricted zone 344 from the first restricted zone 344a to a third restricted zone 344c such that the third restricted zone 344c encompasses the personnel devices 140 as the location thereof changes. As shown in FIG. 21, a personnel device 140 is shown crossing a boundary of the first restricted zone 344a and exiting the first restricted zone 344a. More specifically, the location of the personnel device 140 moves from a first side of the road 310a (e.g., including approaching vehicles 340a traveling in a first direction towards the vehicle 10 and the scene 300) to an opposite, second side of the road 310b (e.g., including approaching vehicles 340b traveling in an opposite, second direction towards the vehicle 10 and the scene 300).

As shown in FIG. 21, the camera(s) 204, the radar sensor(s) 206, and/or the LIDAR sensor(s) 208 are positioned or otherwise configured to monitor a first sensor detection zone 410a used to determine a threat level of the approaching vehicles 340a traveling in the first direction, but are unable (e.g., due to the positioning/configuration thereof) to monitor an area used to determine a threat level of the approaching vehicles 340b traveling in the second direction. Accordingly, the first sensor detection zone 410a cannot be used to determine the threat level of the approaching vehicles 340b. By way of example, when the personnel device 140 moves from the first side of the road 310a to the second side of the road 310b and the third restricted zone 344c is established therearound, the vehicle controller 110 and/or the CAMS controller 210 monitoring the first sensor detection zone 410a are unable to determine (i) the threat level for the approaching vehicles 340b approaching the third restricted zone 344c and (ii) whether the third restricted zone 344c is a vulnerable area (e.g., whether the personnel devices 140 located within the third restricted zone 344c are vulnerable).

In response to a determination by the vehicle controller 110 and/or the CAMS controller 210 that the personnel device 140 is located outside of a zone (e.g., the first restricted zone 344a, the second restricted zone 344b, etc.) capable of being monitored to determine whether the zone is a vulnerable area, the vehicle controller 110 and/or the CAMS controller 210 are configured to adjust or create a new sensor detection zone 410 such that the zone is capable of being monitored to determine whether the zone is a vulnerable area. By way of example, the vehicle controller 110 and/or the CAMS controller 210 are configured to create a second sensor detection zone 410b or transition the sensor detection zone 410 from the first sensor detection zone 410a to the second sensor detection zone 410b. In some embodiments, the vehicle controller 110 and/or the CAMS controller 210 are configured to adjust a position the camera(s) 204, the radar sensor(s) 206, and/or the LIDAR sensor(s) 208 (e.g., commanding an actuator coupled with the camera(s) 204, the radar sensor(s) 206, and/or the LIDAR sensor(s) 208 to actuate to adjust a position thereof) and/or adjust the FOV 220 of the camera(s) 204, the radar sensor(s) 206, and/or the LIDAR sensor(s) 208 to dynamically adjust the sensor detection zone 410 monitored thereby (e.g., rotate the camera(s) 204, the radar sensor(s) 206, and/or the LIDAR sensor(s) 208 to transition the first sensor detection zone 410a to the second sensor detection zone 410b). In some embodiments, a first group of the camera(s) 204, the radar sensor(s) 206, and/or the LIDAR sensor(s) 208 are configured to monitor the first sensor detection zone 410a and a second group of the camera(s) 204, the radar sensor(s) 206, and/or the LIDAR sensor(s) 208 are configured to monitor the second sensor detection zone 410b. In some embodiments, the camera(s) 204, the radar sensor(s) 206, and/or the LIDAR sensor(s) 208 are configured to monitor both the approaching vehicles 340a and the approaching vehicles 340b to determine threat levels associated therewith. In such embodiments, instead of ignoring the CAMS data (e.g., image, radar, and/or LIDAR data) acquired from monitoring an area (e.g., the second sensor detection zone 410b) that did not affect the determination of whether the restricted zone 344 was a vulnerable area (e.g., because the area was outside of the first restricted zone 344a), but now does affect the determination of whether the restricted zone 344 is a vulnerable area (e.g., because the area is now inside of the third restricted zone 344c) as a result of the location of the personnel device 140 changing, the vehicle controller 110 and/or the CAMS controller 210 analyzes the CAMS data acquired of the second sensor detection zone 410b to determine the threat level for the approaching vehicles 340b and whether the third restricted zone 344c is a vulnerable area.

Accordingly, responsive to a determination by the vehicle controller 110 and/or the CAMS controller 210 that, based on the location data, the location of the personnel devices 140 changes from a first location inside of the restricted zone 344 to a second location outside of the restricted zone 344 (e.g., the operators holding/wearing the personnel devices 140 walk from the first location to the second location), the vehicle controller 110 and/or the CAMS controller 210 may automatically (i) adjust the boundaries of the restricted zone 344 or create a new restricted zone 344, and/or (ii) adjust the boundaries of the sensor detection zone 410 or create a new sensor detection zone 410 such that the area surrounding the personnel devices 140 in the second location is being monitored (e.g., the area that was previously not being monitored because no personnel devices 140 were located therein) to determine whether the area is a vulnerable area.

### Communication With Approaching Vehicles

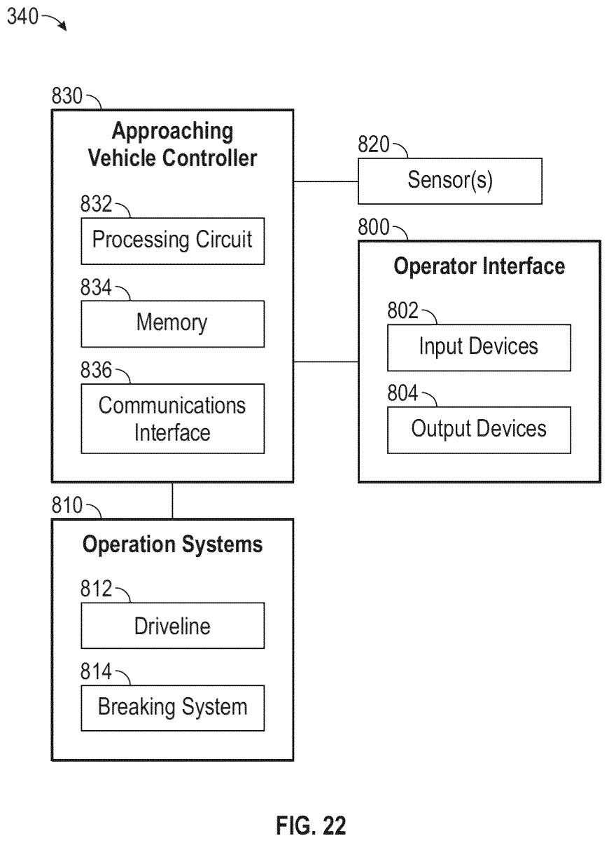

As shown in FIG. 22, the approaching vehicle 340 includes operator input and output devices, shown as operator interface 800, systems associated with the operation of the approaching vehicle 340, shown as operation systems 810, one or more sensors, shown as sensors 820, and a controller, shown as approaching vehicle controller 830, coupled to the operator interface 800, the operation systems 810, and the sensors 820. In some embodiments, the approaching vehicle 340 includes more or fewer components.

According to an exemplary embodiment, the operator interface 800 is configured to provide an operator with the ability to control one or more functions of and/or provide commands to the approaching vehicle 340 and the components thereof (e.g., turn on, turn off, drive, turn, brake, engage various operating modes, etc.). As shown in FIG. 22, the operator interface 800 includes one or more first devices, shown as input devices 802, configured to receive an input from an operator of the approaching vehicle 340 to control one or more functions of and/or provide commands to the approaching vehicle 340 and the components thereof. The input devices 802 may be or include a steering interface (e.g., a steering wheel, joystick(s), etc.), an accelerator interface (e.g., a pedal, a throttle, etc.), a braking interface (e.g., a pedal), and one or more other buttons, switches, knobs, levers, dials, etc. As shown in FIG. 22, the operator interface 800 includes one or more second devices, shown as output devices 804, configured to provide an audible indication (e.g., alert, sound, message, tone, etc.), a visual indication (e.g., alert, message, warning, image, video, etc.), and/or a haptic indication (e.g., vibration, pulse, etc.), among other indications. The output devices 804 may be or include a touchscreen, a LCD display, a LED display, a speedometer, gauges, warning lights, speakers, sirens, horns, haptic actuators, etc.

According to an exemplary embodiment, the operation systems 810 include a driveline 812 configured to propel the approaching vehicle 340. The driveline 812 may include a prime mover, an energy storage device, tractive assemblies (e.g., a front tractive assembly and a rear tractive assembly), and a steering assembly configured to steer one or more of the tractive assemblies. In some embodiments, the driveline 812 is a conventional driveline whereby the prime mover is an internal combustion engine and the energy storage is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 812 is an electric driveline whereby the prime mover is an electric motor and the energy storage is a battery system. In some embodiments, the driveline 812 is a fuel cell electric driveline whereby the prime mover is an electric motor and the energy storage is a fuel cell (e.g., that stores hydrogen, that produces electricity from the hydrogen, etc.). In some embodiments, the driveline 812 is a hybrid driveline whereby (i) the prime mover includes an internal combustion engine and an electric motor/generator and (ii) the energy storage includes a fuel tank and/or a battery system.

According to an exemplary embodiment, the prime mover is configured to provide power to drive one or more of the tractive assemblies. In some embodiments, the driveline 812 includes a transmission device (e.g., a gearbox, a continuous variable transmission (“CVT”), etc.) positioned between (a) the prime mover and (b) one or more of the tractive assemblies. The tractive assemblies may include a drive shaft, a differential, and/or an axle. In some embodiments, the tractive assemblies include two axles or a tandem axle arrangement. In some embodiments, the tractive assemblies are steerable (e.g., using the input devices 802, via the steering assembly). In some embodiments, the tractive assemblies are fixed and not steerable (e.g., employ skid steer operations).

According to an exemplary embodiment, the braking system 814 includes one or more braking components (e.g., disc brakes, drum brakes, in-board brakes, axle brakes, regenerative brakes, etc.) positioned to facilitate selectively braking one or more components of the driveline 812.

The sensors 820 may include various sensors positioned about the approaching vehicle 340 to acquire vehicle information or vehicle data regarding operation of the approaching vehicle 340 and/or the location thereof. By way of example, the sensors 820 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the approaching vehicle 340 and/or the location thereof. According to an exemplary embodiment, one or more of the sensors 820 are configured to facilitate detecting and obtaining vehicle telemetry data including position of the approaching vehicle 340, whether the approaching vehicle 340 is moving, travel direction of the approaching vehicle 340, slope of the approaching vehicle 340, speed of the approaching vehicle 340, vibrations experienced by the approaching vehicle 340, sounds proximate the approaching vehicle 340, suspension travel of components of the suspension system, and/or other vehicle telemetry data.

The approaching vehicle controller 830 may be implemented as a general-purpose processor, an ASIC, one or more FPGAs, a DSP, circuits containing one or more processing components, circuitry for supporting a microprocessor, a group of processing components, or other suitable electronic processing components. According to the exemplary embodiment shown in FIG. 12, the approaching vehicle controller 830 includes a processing circuit 832, a memory 834, and a communications interface 836. The processing circuit 832 may include an ASIC, one or more FPGAs, a DSP, circuits containing one or more processing components, circuitry for supporting a microprocessor, a group of processing components, or other suitable electronic processing components. In some embodiments, the processing circuit 832 is configured to execute computer code stored in the memory 834 to facilitate the activities described herein. The memory 834 may be any volatile or non-volatile or non-transitory computer-readable storage medium capable of storing data or computer code relating to the activities described herein. According to an exemplary embodiment, the memory 834 includes computer code modules (e.g., executable code, object code, source code, script code, machine code, etc.) configured for execution by the processing circuit 832. In some embodiments, the approaching vehicle controller 830 may represent a collection of processing devices. In such cases, the processing circuit 832 represents the collective processors of the devices, and the memory 834 represents the collective storage devices of the devices.

In one embodiment, the approaching vehicle controller 830 is configured to selectively engage, selectively disengage, control, or otherwise communicate with components of the approaching vehicle 340 (e.g., via the communications interface 836, a CAN bus, etc.). According to an exemplary embodiment, the approaching vehicle controller 830 is coupled to (e.g., communicably coupled to) components of the operator interface 800 (e.g., the input devices 802, the output devices 804, etc.), the operation systems 810 including components of the driveline 812 (e.g., the prime mover, steering assembly, etc.) and the braking system 814, and the sensors 820. By way of example, the approaching vehicle controller 830 may send and receive signals (e.g., control signals, location signals, etc.) with the components of the operator interface 800, the components of the driveline 812, the components of the braking system 814, the sensors 820, and/or remote systems (e.g., the CAMS 100, the CAMS module(s) 200, etc.) or vehicles (e.g., the vehicle 10) via the communications interface 836.

According to an exemplary embodiment, the vehicle controller 110 and/or the CAMS controller 210 are configured to communicate (e.g., via the communications interface 116, via the communications interface 216, a short-range signal, a radio signal, a Wi-Fi signal, a Bluetooth® signal, etc.) with the approaching vehicle controllers 830 (e.g., via the communications interface 836) of the approaching vehicles 340. The vehicle controller 110 and/or the CAMS controller 210 may send and receive signals indicative of commands, data, or information with the approaching vehicles 340.

In some embodiments, the approaching vehicle controller 830 is configured to transmit a wireless signal (e.g., via the communications interface 836, a short-range signal, a radio signal, a Wi-Fi signal, a Bluetooth® signal, etc.) to the vehicle controller 110 and/or the CAMS controller 210 associated with one or more characteristics of the approaching vehicle 340. By way of example, the approaching vehicle controller 830 may transmit a signal associated with one or more of a location of the approaching vehicle 340, travel direction of the approaching vehicle 340, speed of the approaching vehicle 340, size of the approaching vehicle 340, type of the approaching vehicle 340, operations of the driveline 812, operations of the braking system 814, among other vehicle telemetry data acquired by the sensors 820. In some embodiments, the vehicle controller 110 and/or the CAMS controller 210 are configured to assess and determine the threat level associated with the approaching vehicles 340 based on the data received therefrom (in addition to or in place of the data acquired by the CAMS module 200).

In some embodiments, the vehicle controller 110 and/or the CAMS controller 210 are configured to transmit a wireless signal (e.g., via the communications interface 116, via the communications interface 216, a short-range signal, a radio signal, a Wi-Fi signal, a Bluetooth® signal, a cellular signal, etc.) to the approaching vehicles 340 (e.g., via the communications interface 836) proximate the vehicle 10 and/or approaching the scene 300 (e.g., within a range of the wireless signal) in response to the approaching vehicles 340 entering a zone (e.g., an area within the FOV 220 and the range 230 of the CAMS module 200) monitored by the CAMS 100. By way of example, the vehicle controller 110 and/or the CAMS controller 210 may be configured to transmit a signal to the approaching vehicles 340 to provide an indication of the location, distance, severity, etc. of the vehicle 10 and/or the scene 300, among other information associated with the vehicle 10 and/or the scene 300. By way of another example, in response to threat levels associated with the approaching vehicles 340 exceeding the threat threshold, the vehicle controller 110 and/or the CAMS controller 210 are configured to transmit a signal to the approaching vehicles 340 to provide an indication of the vehicle 10 and/or the scene 300.

In some embodiments, when the threat levels associated with the approaching vehicles 340 exceed the threat threshold, and in response to receiving the signal, the approaching vehicles 340 are configured to provide an indication (e.g., via the output devices 804) to warn the operator of the approaching vehicle 340 to perform one or more mitigating procedures to reduce the threat level below the threat threshold, or otherwise provide an indication to the operator that the approaching vehicle 340 is operating at a threat level that is exceeding the threat threshold. The one or more mitigating procedures to reduce the threat level may include providing an input to a brake pedal of the input devices 802 to activate the braking system 814 to slow or stop the approaching vehicles 340, steering a steering wheel of the input devices 802 to steer the approaching vehicles 340 to avoid the vehicle 10 and/or the scene 300 or merge the approaching vehicles 340, among other procedures to reduce the threat level below the threat threshold.

The indication may include the audible indication output by a speaker, siren, horn, etc. of the output devices 804 such as a message, one or more tones, one or more alarms, etc. to instruct the operator of the approaching vehicle 340 on how or what procedures to perform to reduce the threat level below the threat threshold. The indication may include the visual indication output by a display, warning light, heads-up-display, etc. of the output devices 804. By way of example, the output devices 804 may display a message warning the operator of a location of the vehicle 10 and/or the scene 300, display an image or video of the vehicle 10 and/or the scene 300, display instructions on how or what mitigating procedures to perform to reduce the threat level below the threat threshold, display navigation instructions to avoid the scene 300 (e.g., to follow a detour around the scene 300), illuminate the warning light to indicate that the threat level has/is exceeded/exceeding the threat threshold, etc. The indication may include the haptic indication output by a haptic actuator engaged (e.g., in contact) with the operator of the approaching vehicle 340 to warn the operator of the vehicle 10 and/or the scene 300. By way of example, the output devices 804 may be configured to actuate (e.g., shake, vibrate, etc.) the steering wheel of the approaching vehicle 340 to warn the operator of the vehicle 10 and/or the scene 300. In some embodiments, the vehicle controller 110 and/or the CAMS controller 210 are in communication with a user device (e.g., smartphone, smartwatch, laptop, tablet, etc.) of the operator and are configured to transmit a signal instructing the user device to initiate an alarm, output a message, vibrate, or perform some other function to warn the operator of the vehicle 10 and/or the scene 300. Further details regarding such communications with the user devices and/or the approaching vehicles 340 may be found in U.S. Patent Publication No. 2025/0126452, published Apr. 17, 2025, which is incorporated herein by reference in its entirety.

In some embodiments, when the threat levels associated with the approaching vehicles 340 exceed the threat threshold, and in response to receiving the signal, the approaching vehicle controller 830, the vehicle controller 110, and/or the CAMS controller 210 are configured to limit operation (e.g., limit operation of the approaching vehicles 340 in a first mode of operation) of the operator interface 800, the driveline 812, the braking system 814, and/or any other component of the approaching vehicles 340. By way of example, the approaching vehicle controller 830 may be configured to limit operation of the prime mover such that the approaching vehicles 340 (i) provide limited or reduced power to the tractive assemblies, (ii) provide no power to drive the tractive assemblies, (iii) are shifted into neutral (e.g., such that no power is transmitted to the prime mover), and/or (iv) any other control to limit operation of the approaching vehicles 340. In such an example, to transition the approaching vehicles 340 to the first mode of operation, the approaching vehicle controller 830 may (i) shift the approaching vehicles 340 into neutral (e.g., such that no power is transmitted to the prime mover) and/or (ii) operate the driveline 812 and/or the braking system 814 to slow the approaching vehicles 340 (e.g., to below a threshold speed, to a stop, etc.) such that the threat level is reduced below the threat threshold. By way of another example, the approaching vehicle controller 830 may be configured to additionally or alternatively control the steering assembly to (i) limit operation of the steering wheel and/or (ii) steer the tractive assemblies such that the operator does not steer the approaching vehicles 340 toward the vehicle 10 and/or the scene 300 (e.g., the approaching vehicle controller 830 autonomously controls steering operations such that the threat level is reduced below the threat threshold).

The approaching vehicles 340 may be limited to the first mode of operation until the threat level is reduced below the threat threshold or the scene 300 is passed by the approaching vehicles 340. In response to a determination that the threat level of the approaching vehicles 340 is below the threat threshold or the approaching vehicles 340 have passed by the scene 300, the approaching vehicle controller 830 may facilitate (e.g., permit operation of the approaching vehicles 340 in a second mode of operation) normal or unrestricted operation of the operator interface 800, the driveline 812, the braking system 814, and/or any other component of the approaching vehicles 340. In some embodiments, in response to a determination that the location of approaching vehicles 340 is up the road past the vehicle 10 and/or the scene 300, the approaching vehicle controller 830 may permit operation of the approaching vehicles 340 in the second mode of operation. In some embodiments, the vehicle controller 110 and/or the CAMS controller 210 are configured to broadcast the control signals (e.g., speed limit signals, steering signals, etc.) to all approaching vehicles 340 within a specified distance or zone that limits the speed and/or travel path of the approaching vehicle 340, irrespective of the threat level.

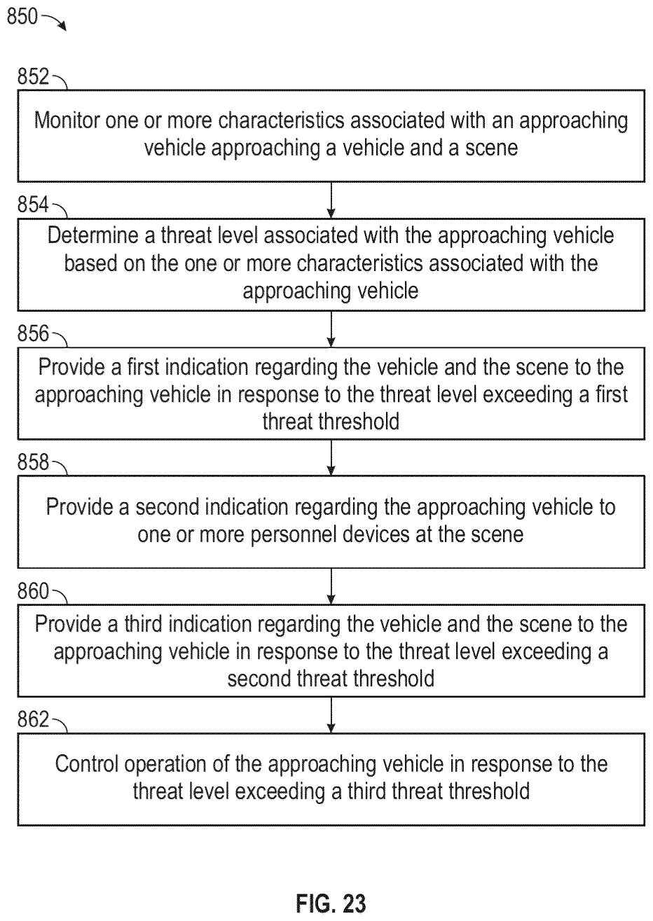

As shown in FIG. 23, a method 850 for communicating with and controlling an approaching vehicle (e.g., the approaching vehicle 340, communicating with the approaching vehicle controller 830, providing one or more warnings to the operator of the approaching vehicle 340, etc.) is shown, according to an exemplary embodiment. The method 850 includes steps 852-862. The method 850 may be performed, at least in part, by the vehicle controller 110, the CAMS controller 210, and/or the approaching vehicle controller 830. In some embodiments, at least a portion of the method 850 is performed by a remote system or server (e.g., data analytics and processing) and then commands are communicated to the approaching vehicle and/or a blocker vehicle.

At step 852, a vehicle controller (e.g., the vehicle controller 110), a CAMS controller (e.g., the CAMS controller 210), and/or a remote system are configured to monitor one or more characteristics associated with the approaching vehicle approaching a blocker vehicle (e.g., the vehicle 10) and a scene (e.g., the scene 300). One or more cameras, radar sensors, and/or LIDAR sensors (e.g., the camera(s) 204, the radar sensor(s) 206, the LIDAR sensor(s) 208) are configured to acquire data to facilitate monitoring the blocker vehicle, the scene, and/or the adjacent/proximate areas therearound to detect the one or more characteristics. The one or more characteristics may include a speed relative to the blocker vehicle and/or a CAMS module (e.g., the CAMS module 200), a heading relative to the blocker vehicle and/or the CAMS module, a relative distance to the blocker vehicle and/or the CAMS module, a path of travel, a size, a type of object, and/or other characteristics.

At step 854, the vehicle controller, the CAMS controller, and/or the remote system are configured to assess and determine a threat level associated with the approaching vehicle based on the one or more characteristics associated with the approaching vehicle. The threat level may be evaluated or determined based on the risk of impact of the approaching vehicle with the blocker vehicle, the risk of the approaching vehicle entering the scene the blocker vehicle is blocking, the estimated timing of impact, and/or the severity of impact. The threat level may be compared with a threat threshold.

At step 856, in response to the threat level exceeding a first threat threshold, the vehicle controller and/or the CAMS controller are configured to provide a first indication regarding the blocker vehicle and the scene to the approaching vehicle. In some embodiments, the remote system provides a command to the vehicle controller and/or the CAMS controller to provide the first indication. The first indication may include a visual alert and/or an audible alert provided to the approaching vehicle (e.g., to an operator of the approaching vehicle). In some embodiments, the vehicle controller and/or the CAMS controller are configured to activate one or more components of a light system (e.g., the light system 80, activate a bright spot light, etc.) or alter the operation of one or more components of the light system (e.g., change the color, change the cadence or pattern, change the direction of light being emitted to be directed at the approaching vehicle, etc.) to provide the first indication to alert or warn the operator of the blocker vehicle and the scene so that the operator can take mitigating actions (e.g., slow down, pull over, swerve out of the path of the blocker vehicle and the scene, etc.). In some embodiments, the vehicle controller and/or the CAMS controller are configured to activate one or more components of an audio system (e.g., the audio system 90, activate the siren 92, activate the horn 94, activate the loudspeaker etc.) or alter the operation of one or more components of the audio system (e.g., change the sound, change the volume, etc.) to provide the first indication to alert or warn the operator of the approaching vehicle.

At step 858, the vehicle controller, the CAMS controller, and/or the remote system are configured to provide a second indication regarding the approaching vehicle to personnel devices (e.g., the personnel devices 140) and/or personnel proximate the blocker vehicle and the scene (e.g., the personnel wearing or carrying the personnel devices 140) in response to the operator of the approaching vehicle not taking mitigating actions to reduce the threat level of the approaching vehicle in response to the first indication. In some embodiments, the vehicle controller, the CAMS controller, and/or the remote system are configured to provide the second indication to initiate an alarm, output a message, vibrate, or perform some other function to warn the personnel holding or wearing the personnel devices to take cover or evacuate the scene. In some embodiments, the vehicle controller, the CAMS controller, and/or the remote system are configured to initiate or engage the light system and/or the audio system to provide the second indication to alert or warn the personnel proximate the blocker vehicle and the scene of the approaching vehicle. In some embodiments, the vehicle controller, the CAMS controller, and/or the remote system are configured to provide the second indication via a display (e.g., the display 130) and/or a speaker (e.g., an in-cab speaker) to instruct an operator within the blocker vehicle to evacuate the blocker vehicle. In some embodiments, the second indication regarding the approaching vehicle is provided to the personnel devices and/or the personnel proximate the blocker vehicle and the scene in response to the threat level exceeding the first threat threshold. In some embodiments, step 858 occurs prior to step 856. In some embodiments, step 856 and step 858 are performed simultaneously. In some embodiments, step 856 and step 858 occur at different threat thresholds.

At step 860, in response to the threat level exceeding a second threat threshold, the vehicle controller, the CAMS controller, and/or the remote system are configured to provide a third indication regarding the blocker vehicle and the scene to the approaching vehicle. The second threat threshold may be greater than the first threat threshold (e.g., the threat level is more threatening to exceed the second threshold). In some embodiments, the approaching vehicle is configured to provide an indication (e.g., via the output devices 804) to warn the operator of the approaching vehicle to perform one or more mitigating procedures to reduce the threat level below the threat threshold (e.g., below the first threat threshold and the second threat threshold), or otherwise provide an indication to the operator that the approaching vehicle is operating at a threat level that is exceeding the threat threshold. The third indication may include an audible indication output by a speaker, siren, horn, etc. such as a message, one or more tones, one or more alarms, etc. The third indication may include a visual indication output by a display, warning light, heads-up-display, etc. such as a message warning the operator of a location of the blocker vehicle and/or the scene. The third indication may include a haptic indication output by an actuator to actuate (e.g., shake, vibrate, etc.) the steering wheel of the approaching vehicle to warn the operator of the blocker vehicle and/or the scene. In some embodiments, the second indication regarding the approaching vehicle is provided to the personnel devices and/or the personnel proximate the blocker vehicle and the scene in response to the threat level exceeding the second threat threshold (e.g., at the same time as the third indication).

At step 862, in response to the threat level exceeding a third threat threshold, the vehicle controller, the CAMS controller, the remote system, and/or an approaching vehicle controller (e.g., the approaching vehicle controller 830) are configured to control one or more operations of the approaching vehicle. The third threat threshold may be greater than the second threat threshold (e.g., the threat level is more threatening to exceed the third threshold). In some embodiments, the approaching vehicle controller, the vehicle controller, the CAMS controller, and/or the remote system are configured to limit operation of an operator interface (e.g., the operator interface 800), a driveline (e.g., the driveline 812), a braking system (e.g., the braking system 814), and/or any other component of the approaching vehicle. By way of example, the approaching vehicle controller may be configured to limit operation of the prime mover such that the approaching vehicle (i) provides limited or reduced power to the tractive assemblies, (ii) provides no power to drive the tractive assemblies, (iii) is shifted into neutral (e.g., such that no power is transmitted to the prime mover), and/or (iv) any other control to limit operation of the approaching vehicle. By way of another example, the approaching vehicle controller may be configured to additionally or alternatively control the steering assembly to (i) limit operation of the steering wheel and/or (ii) steer the tractive assemblies such that the operator does not steer the approaching vehicle toward the blocker vehicle and/or the scene. Operation of the approaching vehicle may be controlled (e.g., limited to the first mode of operation) until the threat level is reduced below one or more threat thresholds (e.g., below the first threat threshold, the second threat threshold, the third threat threshold, etc.) or the scene is passed by the approaching vehicle. In response to a determination that the threat level of the approaching vehicle is below the one or more threat thresholds or the approaching vehicle has passed by the scene, the approaching vehicle controller may facilitate (e.g., permit operation of the approaching vehicle in a second mode of operation) normal or unrestricted operation of the operator interface, the driveline, the braking system, and/or any other component of the approaching vehicle. In some embodiments, the second indication regarding the approaching vehicle is provided to the personnel devices and/or the personnel proximate the blocker vehicle and the scene in response to the threat level exceeding the third threat threshold.

### Forward Facing CAMS Module

In some embodiments, the vehicle 10 has at least one CAMS module 200 positioned to acquire data regarding an area forward of the vehicle 10 as the vehicle 10 is being driven. According to an exemplary, the radar sensor(s) 206 and/or the LIDAR sensor(s) 208 of the such CAMS module 200 are configured to acquire radar and/or LIDAR data regarding one or more objects and an environment in front of the vehicle 10. By way of example, the radar sensor(s) 206 and/or the LIDAR sensor(s) 208 may be positioned along a front of the front cabin 20, along one or more sides of the front cabin 20, along a top of the front cabin 20, along one or more sides of the rear section 30, along a top of the rear section 30, along a rear of the rear section 30, coupled to the aerial ladder 50 (e.g., a ladder thereof, a basket at a proximal end thereof, etc.), coupled to the mast 52, and/or coupled to or integrated into the light bar 82, among other possible locations, to acquire data regarding one or more objects and environment in front of the vehicle 10. The one or more objects may include oncoming vehicles, the scene 300, operators at the scene 300, other vehicles 10 dispatched at the scene, pedestrians, cyclists, buildings, signs along the road 310 (e.g., stop signs, yield signs, merge signs, street signs, traffic lights, etc.), hazards in the road 310 (e.g., fallen trees, debris from a car accident, etc.), wildlife on the road 310, and/or other objects. The environment in front of the vehicle 10 may include road markings (e.g., lane markings, chevron markings, crosswalk lines, arrows indicating turning lanes, straight lanes, merges, etc.), edges of the road (e.g., curbs, shoulders, etc.), curvature of the road 310, a condition of the road (e.g., potholes, cracks, etc.), and/or other features of the surrounding environment.

The radar sensor(s) 206 and/or the LIDAR sensor(s) 208 are configured to acquire the radar and/or LIDAR data as the vehicle 10 is traveling along the road 310 (e.g., navigating to the scene 300, navigating around the scene 300, leaving the scene 300, etc.) and when the vehicle 10 is stationary at the scene 300. In some embodiments, the radar sensor(s) 206 and/or the LIDAR sensor(s) 208 are configured to acquire the radar and/or LIDAR data in low visibility conditions or no visibility conditions while the vehicle 10 is traveling or stationary. Low visibility or no visibility conditions include conditions that substantially limit the ability of an operator of the vehicle 10 (e.g., the driver of the vehicle 10) to see in front of the vehicle 10, thereby making it difficult to operate the vehicle 10. Such low visibility and no visibility conditions may include severe weather (e.g., snowstorms/whiteouts, heavy rain, dense fog, sand or dust storms, hail storms, etc.), conditions impacted by the time of day (e.g., night time, low light conditions, glare caused by the sun, etc.), smoke (e.g., smoke from a wildfire, smoke from a fire at the scene 300, etc.), or other conditions.

The radar sensor(s) 206 and/or the LIDAR sensor(s) 208 of the CAMS module 200 are configured to transmit a plurality of signals (e.g., the signals 240) up the road 310 in a direction generally forward of the vehicle 10 and toward objects and the surrounding environment. The radar sensor(s) 206 and/or the LIDAR sensor(s) 208 are configured to receive the signals back to acquire the radar and/or LIDAR data regarding detected objects and the surrounding environment. The objects and the surrounding environment may be represented as a point cloud indicative of the position and orientation thereof relative to the vehicle 10, the radar sensor(s) 206, and/or the LIDAR sensor(s) 208. By way of example, the radar sensor(s) 206 and/or the LIDAR sensor(s) 208 may emit one or more signals (e.g., radio waves, laser beams, etc.) and sense the intensity of the reflections from the points where the signals reflected off surfaces of the objects and the surrounding environment. The vehicle controller 110 and/or the CAMS controller 210 are configured to detect and track movements of moving/stationary objects and characteristics thereof (as discussed in greater detail above) based on the radar and/or LIDAR data.

The radar and/or LIDAR data (e.g., point cloud data) may be used to generate a graphical representation (e.g., a two-dimensional representation, a three-dimensional representation) of the objects and the surrounding environment to be displayed by the display 130. In some embodiments, the raw radar and/or LIDAR data (e.g., coordinates, distances, angles, speeds, etc.) of the objects and the surrounding environment are displayed by the display 130. By way of example, the raw data acquired by the radar sensor(s) 206 and/or the LIDAR sensor(s) 208 may indicate that the objects and/or the surrounding environment are a respective distance away from the vehicle 10, and the display 130 may display the respective distance. In some embodiments, the radar sensor(s) 206 and/or the LIDAR sensor(s) 208 are configured to capture the radar and/or LIDAR data at a predetermined frequency (e.g., every second, every 500 milliseconds, at a frequency of about 5 Hz, 10 Hz, 50 Hz, 100 Hz, etc.) such that the graphical representation and the raw radar and/or LIDAR data of the objects and the surrounding environment are indicative of the current (e.g., real-time) position and orientation of the objects and the surrounding environment relative to the vehicle 10. In some embodiments, the graphical representation of the objects and the surrounding environment is displayed on a heads-up-display (“HUD”) projected onto a front windshield of the vehicle 10 or displayed by a display included in the front windshield of the vehicle 10. In some embodiments, the graphical representation of the objects and the surrounding environment is displayed on a display of the personnel devices 140.

The radar and/or LIDAR data and the graphical representation thereof are configured to aid the operator (e.g., the driver) of the vehicle 10 in identifying the objects and the environment in front of the vehicle 10 that would otherwise be imperceptible (e.g., imperceivable, undetectable, difficult to identify, etc.) by the operator due to the low visibility or no visibility conditions. The operator may make operational decisions based on the displayed graphical representation to operate the vehicle 10 in such low visibility or no visibility conditions. By way of example, the display 130 may display a graphical representation of an object on the road 310 and the operator may steer the vehicle 10 to avoid the object. By way of another example, the display 130 may display a graphical representation of the scene 300 that the vehicle 10 is approaching and the operator may provide an input to activate the light system 80 and/or the audio system 90 to provide an indication that the vehicle 10 is approaching the scene (e.g., to alert operators, pedestrians, etc. at the scene 300 that the vehicle 10 is approaching).

Such a front looking vision system provides enhanced operability of the vehicle 10 when responding to scenes at high speeds and during low visibility or no visibility conditions. By way of example, the vehicle 10 may be responding to an accident on a highway during a whiteout snowstorm. In some instances, these accidents can turn into multi-car/multi-lane pileups that are not visible to approaching vehicles until it may be too late. Accordingly, as the vehicle 10 approaches such a scene during such visibility-impaired conditions, the CAMS 100 is configured to provide the operator of the vehicle 10 with advanced warnings and enhanced visibility of the scene so that the operator may navigate the vehicle 10 appropriately and in the most efficient manner possible, while preventing the vehicle 10 itself from becoming part of such pileup.

### Advanced Sensing

### Rotatable CAMS Module

In some situations, when the vehicle 10 is positioned on a road in a blocking arrangement, the vehicle 10 is arranged at an angle with respect to the lane that the vehicle 10 is blocking (see, e.g., FIGS. 7 and 8). In other words, the blocking arrangement may orient the vehicle 10 so that a longitudinal axis that extends down a centerline of the vehicle 10 (e.g., in a front-to-rear direction), or a centerline of the FOV, is arranged at an angle relative to (e.g., not parallel with) the road markings (e.g., center markings, lane markings, edge or side markings, etc.). The angled orientation of the vehicle 10 may orient an FOV of one or more of the CAMS module(s) 200 so that the FOV is at least partially misaligned with a travel path of the approaching vehicles 340 (e.g., misaligned with the road). In some embodiments, the CAMS module(s) 200 is rotatably coupled or mounted to the vehicle 10 (e.g., to the front cabin 20, the rear section 30, the aerial ladder 50, the mast 52, the light bar 82, and/or a body panel) so that the FOV defined by the CAMS modules(s) 200 may be rotated and aligned with the lanes of the road (e.g., parallel with the lanes and/or the lane markings on the road). In this way, for example, the vehicle 10 may be able to assume various orientations in the blocking arrangement and the FOV of the CAM module(s) 200 may be rotated to align with the travel path of the approaching vehicles 340 (e.g., align with the lane(s) being blocked by the vehicle 10).

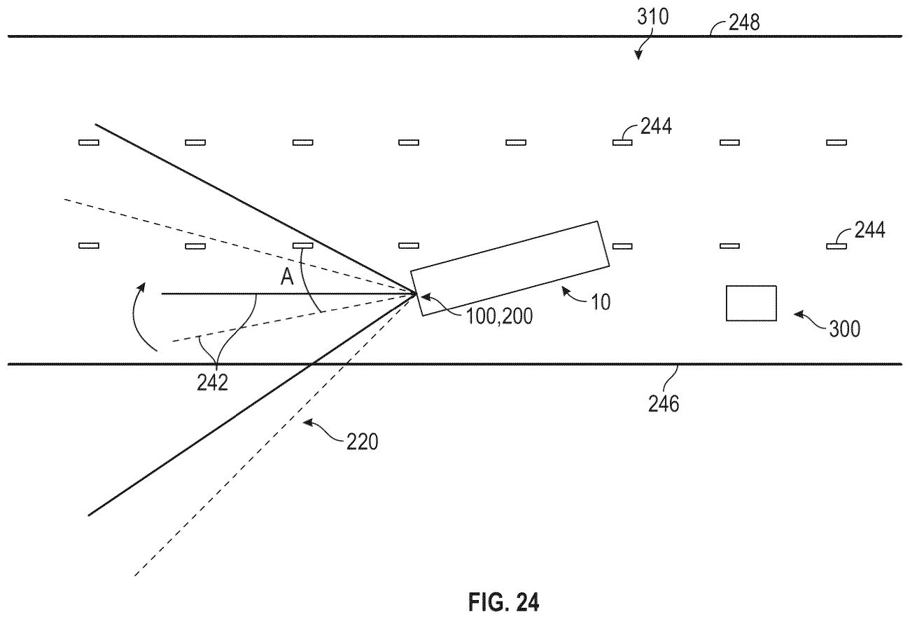

FIG. 24 shows an exemplary embodiment of the vehicle 10 positioned in a blocking arrangement on the road 310 with the CAMS module 200 mounted at a rear of the rear section 30 of the vehicle 10. In the exemplary embodiment, the blocking arrangement positions the vehicle 10 in an angled orientation relative to the lanes of the road 310, which also orients an initial position of the FOV 220 (shown in dashed lines in FIG. 24) of the CAMS module 200 in an angled orientation relative to the lanes of the road 310. For example, a centerline 242 defined along a center of the FOV 220 is angled so that (a) the centerline 242 is not parallel with lane markings 244, an edge or side marking 246, and/or a center marking 248 of the road 310, and/or (b) an acute angle A is formed between the centerline 242 and the lane markings 244, the edge marking 246, and/or the center marking 248. Accordingly to an exemplary embodiment, the CAMS module 200 is rotatably coupled to the rear section 30 so that the CAMS module 200 selectively rotates about a rotation axis (e.g., a vertical axis perpendicular to a ground on which the vehicle 10 is supported). The selective rotation of the CAMS module 200 rotates the FOV 220 to an aligned position (shown in solid lines in FIG. 24), where the centerline 242 of the FOV 220 is oriented approximately or substantially parallel to the lanes of the road 310. For example, the rotation of the FOV 220 to the aligned position may orient the centerline 242 approximately or substantially parallel to the lane markings 244, the edge marking 246, and/or the center marking 248. In this way, the FOV 220 of the CAMS module 200 is selectively repositioned to compensate for off-angle orientations and position the FOV 220 to align with a travel path of the approaching vehicles 340.

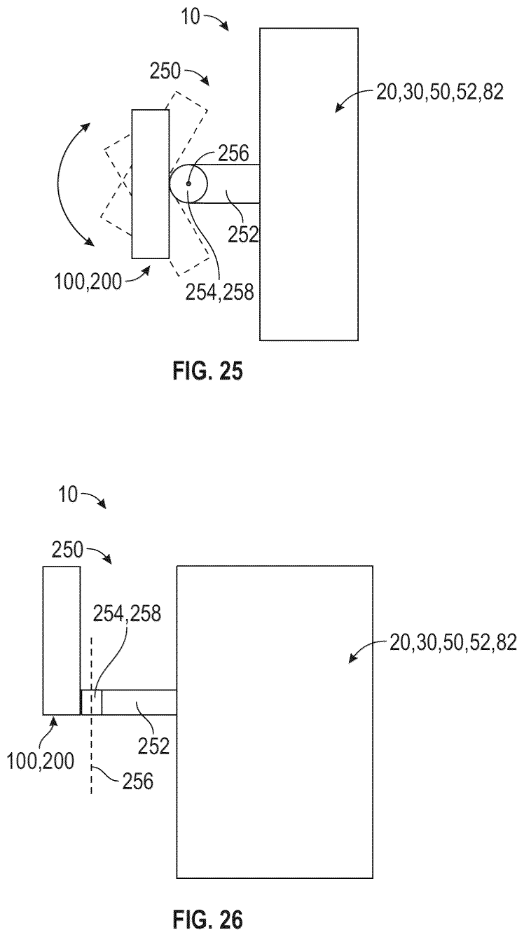

According to an exemplary embodiment, the CAMS module(s) 200 may be rotatably coupled to the vehicle 10 using a mounting assembly that includes at least one rotatable coupling or rotatable actuator to facilitate rotating the CAMS module(s) 200 relative to the vehicle 10 (e.g., relative to a body panel to which the CAM module(s) 200 is coupled). As shown in FIGS. 25 and 26, the CAMS module 200 is rotatably coupled to the vehicle 10 (e.g., to the front cabin 20, the rear section 30, the aerial ladder 50, the mast 52, the light bar 82, and/or a body panel) by a mount system, shown as mounting assembly 250, according to an exemplary embodiment. The mounting assembly 250 includes (a) a support structure, linkage, post, arm, or bar, shown as mounting arm 252, that is coupled between a portion of the vehicle 10 (e.g., the front cabin 20, the rear section 30, the aerial ladder 50, the mast 52, the light bar 82, and/or a body panel), (b) a rotatable coupling, bearing, ball joint, pin, rod, or sleeve, shown as hinge joint 254, (c) a pivot actuator, shown as rotary actuator 258, and (d) the CAMS module 200. The rotary actuator 258 may include a motor, a linear actuator, and/or another type of actuator. In some embodiments (e.g., a manual system), the mounting assembly 250 does not include the rotary actuator 258. In general, the hinge joint 254 is rotatably coupled between the mounting arm 252 and the CAMS module 200 (e.g., the sensor housing 202 of the CAMS module 200), so that the CAMS module 200 and the components thereof (e.g., the camera(s) 204, the radar sensor(s) 206, the LIDAR sensor(s) 208) are selectively rotatable about a rotation axis 256. In some embodiments, the rotation axis 256 is perpendicular to a ground on which the vehicle 10 is supported. In some embodiments, the rotation axis 256 is approximately parallel to the body panel or component to which the mounting arm 252 is coupled (e.g., a body panel of the front cabin 20, the rear section 30, the aerial ladder 50, the mast 52, and/or the light bar 82). In some embodiments, the mounting arm 252 is rigidly coupled to the vehicle 10 so that rotation of the CAMS module 200 about the rotation axis 256 rotates the CAMS module 200 relative to both the vehicle 10 and the mounting arm 252.

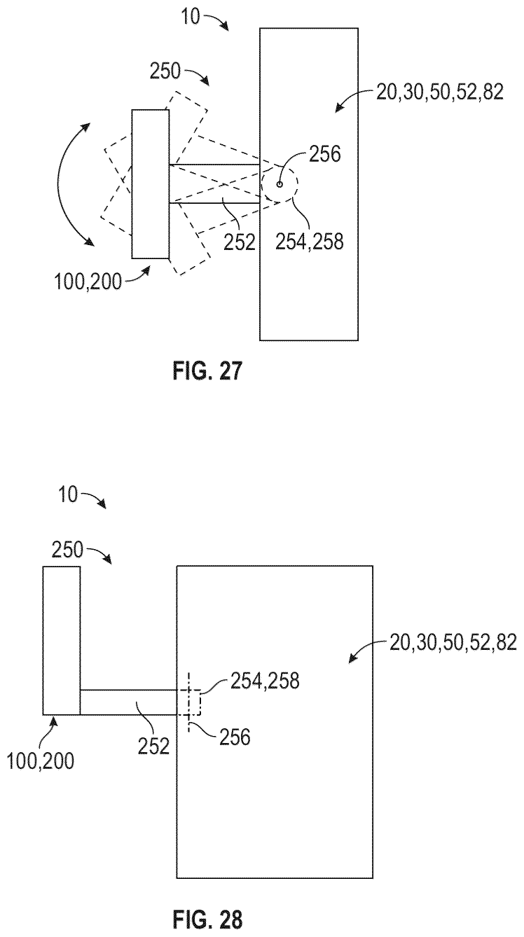

FIGS. 27 and 28 show an exemplary embodiment of the mounting assembly 250 where the mounting arm 252 is rotatably coupled to the vehicle 10 (e.g., to the front cabin 20, the rear section 30, the aerial ladder 50, the mast 52, the light bar 82, and/or a body panel) by the hinge joint 254 and/or the rotary actuator 258. That is, rather than the mounting arm 252 being fixed to the vehicle 10 and the CAMS module 200 and rotating relative to both the mounting arm 252 and the vehicle 10 (see, e.g., FIGS. 25 and 26), the mounting arm 252 and the CAMS module 200 both rotate relative to the vehicle 10 (shown in dashed lines in FIG. 27) to adjust a position of the FOV 220. In some embodiments, the hinge joint 254 and at least a portion of the mounting arm 252 are integrated into the vehicle 10 (e.g., recessed within a body panel thereof). In some embodiments, at least a portion of the rotary actuator 258 is integrated into the vehicle 10 (e.g., recessed within a body panel thereof).

Regardless of the particular arrangement of the mounting assembly 250, rotation of the CAMS module 200 about the rotation axis 256 (shown in dashed lines in FIG. 25 and shown in dashed lines in FIG. 27) is configured to enable the FOV 220 (e.g., defined by the camera(s) 204, the radar sensor(s) 206, and/or the LIDAR sensor(s) 208) to be selectively adjusted/rotated to align the FOV 220 with the lanes of the road 310 that the vehicle 10 is on and in the blocking arrangement (see, e.g., FIG. 24). For example, the CAMS module 200 may be selectively rotated about the rotation axis 256 in a first rotational direction or a second rotational direction depending on the orientation of the FOV 220 and the road 310 on which the vehicle 10 is in the blocking arrangement.

In some embodiments, the CAMS module 200 is manually rotatable by a user grasping the CAMS module 200 (e.g., the sensor housing 202) and/or grasping a handle attached to the sensor housing 202, and manually rotating the CAMS module 200. In such embodiments, the mounting assembly 250 may not include the rotary actuator 258. In such embodiments, the hinge joint 254 may include a friction fit or a detent mechanism that selectively unlocks in response to a user applying a torque to the CAMS module 200 in the direction of rotation and locks when the user stop rotating the CAMS module 200 (e.g., the rotating torque is removed). In such embodiments, the CAMS module 200 may include a manual locking mechanism (e.g., a locking clamp) to fix the CAMS module 200 in a desired orientation.

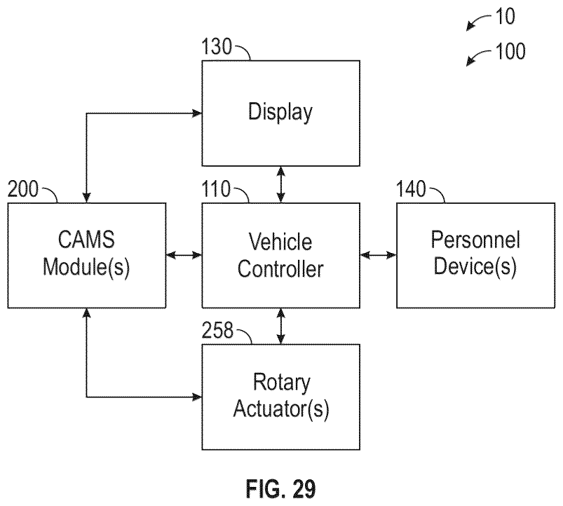

According to the exemplary embodiments shown in FIG. 24-29, the mounting assembly 250 includes the rotary actuator 258 (e.g., rotary actuator, stepper motor, servomotor, etc.) integrated into or coupled to the hinge joint 254 so that selective rotation of the rotary actuator 258 results in the same rotation of the CAMS module 200. In some embodiments, the rotary actuator 258 is a linear actuator (e.g., a linear electric actuator, a pneumatic cylinder, a hydraulic cylinder, etc.) extending between the sensor housing 202 of the CAMS module 200 and a portion the vehicle 10 (e.g., a body panel). Accordingly, extension and retraction of the linear actuator results in rotation of the CAMS module 200 about the hinge joint 254. In some embodiments, the rotary actuator 258 may be electronically controlled (e.g., by the vehicle controller 110 or the CAMS controller 210) so that a user may control rotation of the CAMS module 200 by providing an input to the display 130 or other control interface. For example, the display 130 may function as a user interface that includes dedicated inputs (e.g., touch screen buttons, knobs, dials, and/or manual buttons, knobs, dials, etc.) for controlling rotation of the CAMS module 200, via the rotary actuator 258, about the rotation axis 256. In this way, for example, a user may be able to view the initial position of the FOV 220 and the centerline 242, and selectively rotate the FOV 220 to the aligned position, while viewing the movement of the FOV 220 and the centerline 242 on the display 130.

In some embodiments, the personnel device(s) 140 is configured to facilitate selectively adjusting a rotational position of the rotary actuator 258 and the CAMS module 200. For example, the mobile devices 132 may be in communication with the vehicle controller 110 and/or the CAMS controller 210, and provide instructions thereto that result in rotation of the CAMS module 200 about the rotation axis 256.

In some embodiments, the CAMS module 200 may be automatically (e.g., in response to an operator command) or autonomously (e.g., without operator input, in response to the vehicle 10 being put into park and while on the road 310 at an angle, etc.) rotated in response to the vehicle 10 being parked in the blocking arrangement and detecting that the FOV 220 is off-angle or misaligned with the lanes in the road (e.g., the angle A is greater than or equal to a threshold angle). The automatic rotation of the CAMS module 200 may occur in response to the CAMS module 200 receiving an alignment command (e.g., from the operator via the display 130) and/or detecting an off-angle orientation of the FOV 220 relative to the road 310 (e.g., based on CAMS data captured by the camera(s) 204, the radar sensor(s) 206, and/or the LIDAR sensor(s) 208). If misaligned, the rotary actuator 258 may be instructed to the rotate the CAMS module 200 and the FOV 220 to the aligned position. The automatic rotation of the CAMS module 200 may occur in response to the CAMS module 200 detecting that the vehicle 10 has been parked on the road 310 in a misaligned orientation (i.e., without requiring a specific alignment command from the operator). In some embodiments, the camera(s) 204, the radar sensor(s) 206, and/or the LIDAR sensor(s) 208 of the CAMS module 200 are used to detect the orientation of the lane markings 244, the edge marking 246, and/or the center marking 248 on the road 310 relative to the centerline 242 of the FOV 220 (e.g., detect the angle A based on CAMS data). If the FOV 220 is angled relative to the lanes in the road 310 (e.g., the angle A is greater than or equal to the threshold angle), as indicated by the orientation of the lane markings 244, the edge marking 246, and/or the center marking 248, the rotary actuator 258 is commanded to rotate the CAMS module 200 and the FOV 220 to the aligned position (e.g., rotated in a particular direction with a particular magnitude) where the centerline 242 of the FOV 220 is approximately or substantially parallel to the lane markings 244, the edge marking 246, and/or the center marking 248.

In some embodiments, the orientation of the FOV 220 relative to the lanes of the road 310, detected by the CAMS module 200, is sent to the vehicle controller 110 and the vehicle controller 110 instructs the rotary actuator 258 to rotate the FOV 220 to the aligned position. For example, the vehicle controller 110 may instruct the rotary actuator 258 to rotate the FOV 220 until the CAMS module 200 no longer detects misalignment of the FOV 220 and the lanes in the road 310. Alternatively or additionally, the magnitude and direction may be known (e.g., stored in a map in the memory 114 of the vehicle controller 110) based on the detected orientation of the FOV 220 relative to the lanes in the road 310, and the vehicle controller 110 may send the appropriate instructions to the rotary actuator 258 to rotate the CAMS module 200 and the FOV 220 to the aligned position.

In some embodiments, the CAMS controller 210 instructs the rotary actuator 258 to rotate the FOV 220 to the aligned position based the orientation of the FOV 220 relative to the lanes of the road 310 detected by the CAMS module 200. For example, the CAMS controller 210 may instruct the rotary actuator 258 to rotate the FOV 220 until the CAMS module 200 no longer detects misalignment of the FOV 220 and the lanes in the road 310. Alternatively or additionally, the magnitude and direction may be known (e.g., stored in a map in the memory 214 of the CAMS controller 210) based on the detected orientation of the FOV 220 relative to the lanes in the road 310, and the CAMS controller 210 may send the appropriate instructions to the rotary actuator 258 to rotate the CAMS module 200 and the FOV 220 to the aligned position.

### CAMS With Combined FOV

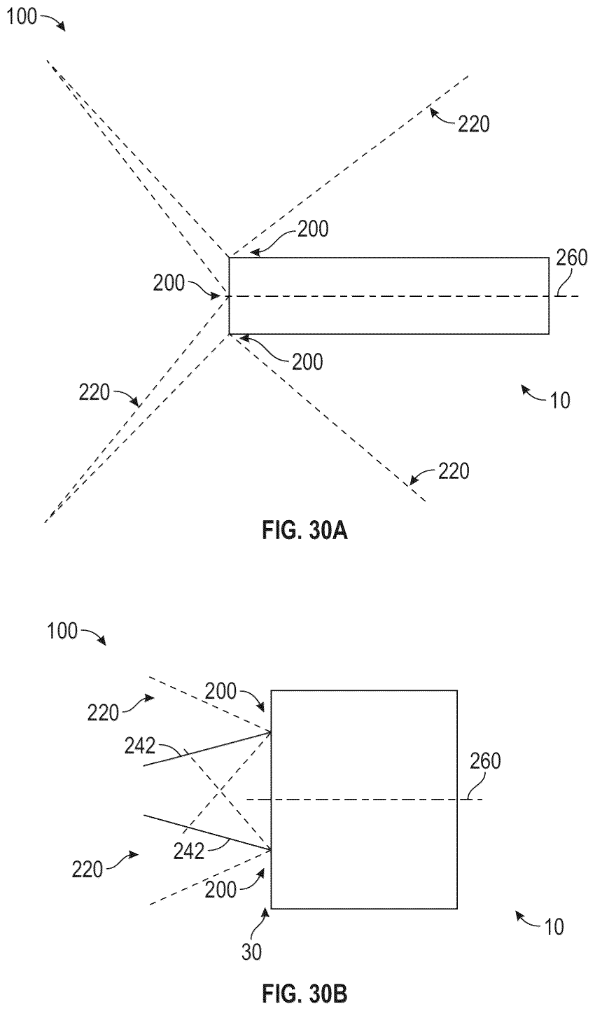

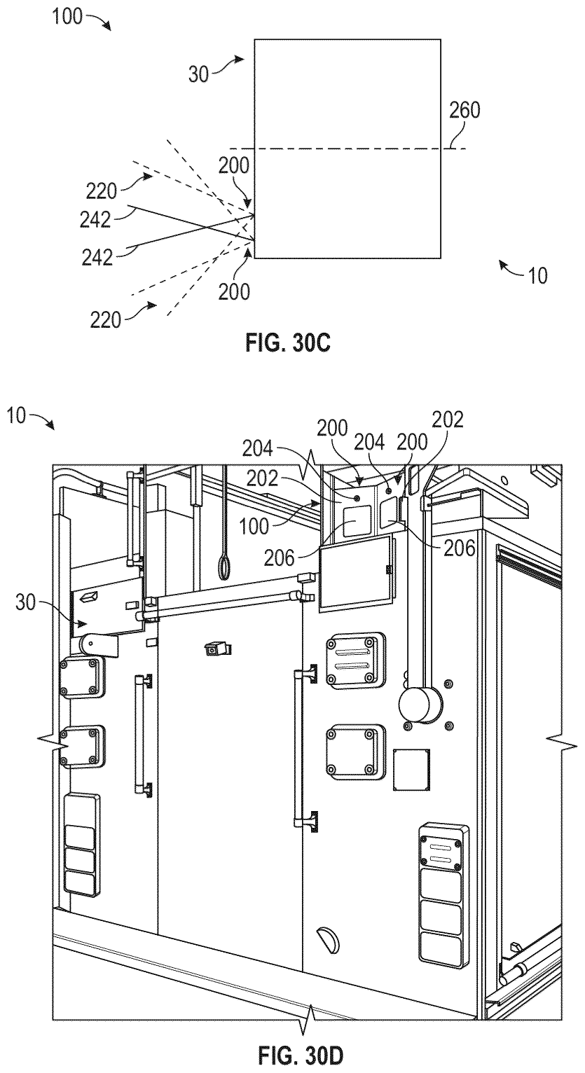

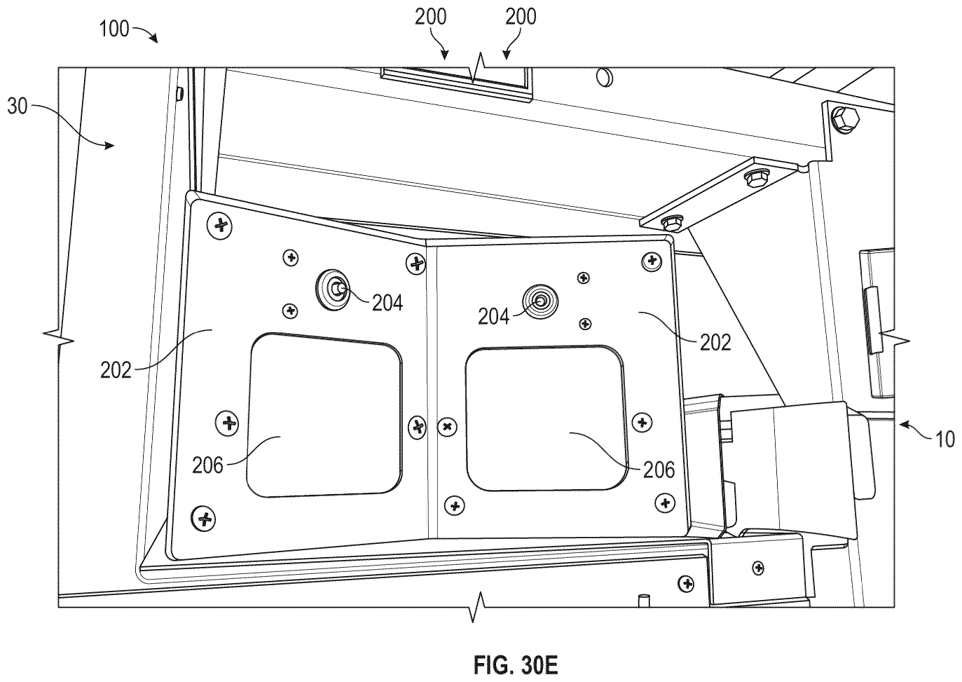

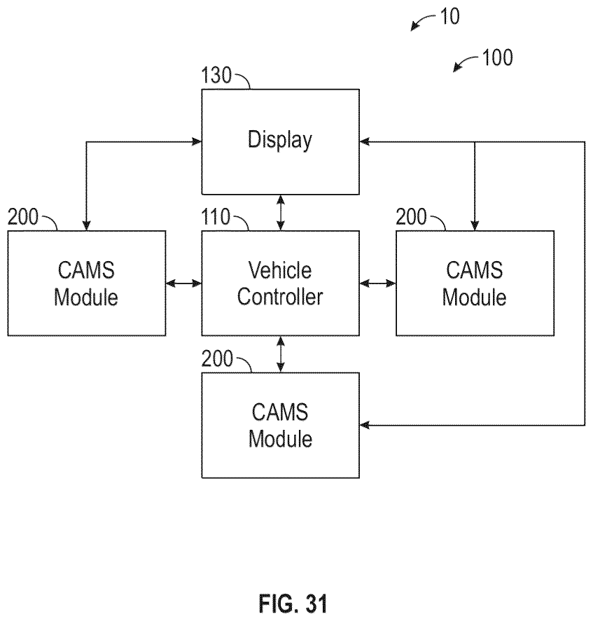

In some embodiments, the CAMS 100 is configured to combine the data from two or more CAMS modules 200 into a combined data set that defines an expanded FOV (e.g., when compared to a single CAMS module 200) and allows the CAMS 100 to monitor a larger area or zone at a scene. FIGS. 30A, 30B, and 31 show an exemplary embodiment of a plurality of the CAMS modules 200 mounted on the vehicle 10, with each of the CAMS modules 200 capturing data within an FOV 220. In the exemplary embodiment of FIG. 30A, the CAMS 100 includes three CAMS modules 200 (e.g., a first CAMS module, a second CAMS module, and a third CAMS module), with one of the CAMS modules 200 being mounted to a rear of the rear section 30, one of the CAMS modules 200 being mounted to a first side of the rear section 30, and one of the CAMS modules 200 being mounted to a second, opposite side of the rear section 30. The data from each of the CAMS modules 200 may be combined and displayed on the display 130 as a single combined FOV. In other embodiments, the CAMS 100 may include more or less CAMS modules 200 mounted in various locations, which are then combined to create a single combined FOV for viewing on the display 130. For example, the CAMS 100 may include one, two, three, or four of the CAMS modules 200 mounted to two or more of the front cabin 20, the rear section 30, the aerial ladder 50, the mast 52, the light bar 82, or a body panel, and the FOVs 220 from the CAMS modules 200 may be combined into a single combined FOV for viewing on the display 130.

In some embodiments, the CAMS 100 may include more than one of the CAMS modules 200 mounted to the same side of the vehicle. For example, FIG. 30B shows two or more of the CAMS modules 200 being mounted to the front cabin 20, the rear section 30, the aerial ladder 50, the mast 52, the light bar 82, or a body panel. Specifically, FIG. 30B shows two of the CAMS modules 200 being mounted on the rear section 30 of the vehicle 10. It should be appreciated that the other sections/sides of the vehicle 10 may also include two or more of the CAMS modules 200 and the description herein relating to FIG. 30B applies to these alternative or additional embodiments. In the exemplary embodiment of FIG. 30B, the two CAMS modules 200 mounted on the rear section 30 (e.g., on one side of a longitudinal axis 260 of the vehicle 10, on opposing sides of the longitudinal axis 260 of the vehicle 10, etc.) include overlapping FOVs 220 (e.g., a first FOV 220 overlaps with a second FOV 220). Each of the two CAMs modules 200 mounted on the rear section 30 may be selectively rotatable by a user manually rotating the CAMS modules 200 and/or via the rotary actuator 258 (e.g., a dedicated rotary actuator 258 for each of the CAMS modules 200). Due to the overlapping orientation of the FOVs 220, the radar sensors 206 on the two CAMS modules 200 are configured to operate at different transmission frequencies to prevent interference. That is, one of the CAMS modules 200 (e.g., a first CAMS module 200) includes a radar sensor 206 (e.g., a first radar sensor) that is configured to operate at a first transmission frequency, and the other of the CAMS modules 200 (e.g., a second CAMS module 200) includes a radar sensor 206 (e.g., a second radar sensor) that is configured to operate at a second transmission frequency that is different than the first transmission frequency. The operation at different transmission frequencies may be applied to any number of CAMS modules 200 with overlapping FOVs. This may be similarly applied for CAMS modules 200 having LIDAR sensors 208 having overlapping FOVs and different transmission frequencies.

FIG. 30C shows an exemplary embodiment of two or more of the CAMS modules 200 being mounted to the front cabin 20, the rear section 30, the aerial ladder 50, the mast 52, the light bar 82, or a body panel. Specifically, FIG. 30C shows two of the CAMS modules 200 being mounted on the rear section 30 of the vehicle 10, with both of the CAMS modules 200 being arranged on a same side of the longitudinal axis 260 (e.g., a center axis extending longitudinally along the vehicle 10) and including overlapping FOVS 220 (e.g., a first FOV 200 overlaps with a second FOV 220).

FIGS. 30D and 30E show an exemplary embodiment of the CAMS 100 mounted on the vehicle 10. In the exemplary embodiment, the CAMS 100 includes two of the CAMS modules 200 mounted on the rear section 30 of the vehicle 10. Each of the CAMS modules 200 mounted on the rear section 30 of the vehicle 10 includes the sensor housing 202, the camera 204, and the radar sensor 206. The sensor housings 202 are oriented in a V-shaped arrangement, with an inner edge of each of the sensor housings 202 defining the point or vertex of the V-shaped arrangement. The V-shaped arrangement of the sensors housings 202 both orients the two CAMS modules 200 close to one anther and angles or points the cameras 204 and the radar sensors 206 toward one another, so that at least the FOV 220 of the radar sensors 206 overlap (e.g., similar to the arrangement of FIG. 30C). As described herein, in this overlapping arrangement, the radar sensor 206 in one of the two CAMS modules 200 may operate at different transmission frequencies to prevent interference between the two signals. In some embodiments, the FOV 220 of the cameras 204 and the radar sensors 206 overlap.

In each of the CAMS modules 200, the camera 204 is arranged above the radar sensor 206. In other words, the camera 204 is arranged closer to a top side of the housing 202 than the radar sensor 206. In the exemplary embodiment of FIGS. 30D and 30E, both of the CAMS modules 200 are arranged on the same side of the 260. For example, if the rear section 30 of the vehicle 10 is split into four quadrants about a center point, the two CAMS modules 200 may be arranged in the upper-right quadrant. In some embodiments, the CAMS modules 200 may be arranged in other quadrants of the rear section 30, or in other sides/locations along the vehicle 10.

In some embodiments, the data captured within each of the FOVs 220 of the CAMS modules 200 is communicated to the vehicle controller 110, and the vehicle controller 110 is configured to combine the data into a single combined FOV that is displayed on the display 130. For example, the vehicle controller 110 may remove overlapping regions between the individual FOVs 220 and produce the single combined FOV that includes all the non-overlapping regions of the individual FOVs 220, which expands the FOV of the CAMS 100.

In some embodiments, the display 130 includes dedicated sections for each of the CAMS modules 200 within the CAMS 100. For example, the data captured within the FOV 220 of each of the CAMS modules 200 is communicated to a dedicated section of the display 130 allowing a user to view multiple FOVs 220 simultaneously.

In some embodiments, each of the CAMS modules 200 arranged on the vehicle 10 is selectively rotatable by a user manually rotating the CAMS modules 200 and/or via the rotary actuator 258 (e.g., a dedicated rotary actuator 258 for each of the CAMS modules 200), according to the systems and methods described herein. In some embodiments, one of the CAMS modules 200 may act as a leader module for the rotational orientation of each of the CAMS modules 200 and the remaining CAMS modules 200 may follow the rotational position of the leader module. For example, the CAMS module 200 arranged on the rear section 30 of the vehicle 10 may act as the leader module and when the leader module rotates from the misaligned position to the aligned position, the remaining CAMS modules 200 (follower modules) may mimic the rotational movement (e.g., in magnitude and direction) of the leader module. In this way, for example, the combined FOV of each of the CAM modules 200 may be aligned with the road 310. In some embodiments, each of the CAM modules 200 is independently rotatable.

### Deployable Drone

In some situations, when the vehicle 10 is positioned on a road in a blocking arrangement, the vehicle 10 is arranged in a location that is downstream of (e.g., further down the road in the direction of travel) a road-based, geography-based, terrain-based, or man-made obstruction. For example, the vehicle 10 may be located downstream of a curve in the road, at the bottom of a hill, behind trees, rocks, or other terrain, and/or behind a sign, building, or billboard. According to an exemplary embodiment, the CAMS 100 may include a mobile or deployable CAMS module that is mounted on a mobile unit. The deployable unit may be selectively deployed and travel, or be positioned, upstream of the vehicle 10 to provide a field of view to incoming traffic that is upstream of the field of view(s) of the CAMS module(s) 200 on the vehicle 10. The CAMS module 200 on the vehicle 10 is configured to capture first CAMS data (e.g., data from the camera(s) 204, the radar sensor(s) 206, and/or the LIDAR sensor(s) 208) and the deployable CAMS module is configured to capture second CAMS data. The second CAMS data may determine a preliminary threat level upstream of the vehicle 10 and the deployable CAMs module is configured to communicate with the CAMS 100 on the vehicle 10 to provide data regarding the incoming traffic and preliminary threat levels upstream of the vehicle 10, in locations where the CAMS module(s) 200 on the vehicle 10 are obstructed from viewing the incoming traffic (e.g., outside of a vision range or the FOV of the CAMS module 200 on the vehicle 10). In this way, for example, the CAMS 100 may be provided with preliminary data regarding the incoming traffic and the respective threat levels thereof prior to the incoming traffic entering the field of view(s) of the CAM module(s) 200 on the vehicle 10.

In some embodiments, the deployable CAMS module is configured to transmit a pre-alert signal to the alert system 120, an approaching vehicle, and/or the personnel devices 140 in response to the preliminary threat level exceeding a preliminary threat threshold. In some embodiments, the deployable CAMS module is configured to evaluate and communicate the preliminary threat level of an approaching vehicle, and the CAMS module 200 on the vehicle 10 is configured to evaluate a final threat level of the approaching vehicle. An alert signal may be provided to the alert system 120, the approaching vehicle, and/or the personnel devices 140 in response to the preliminary threat level or the final threat level exceeding a threat threshold.

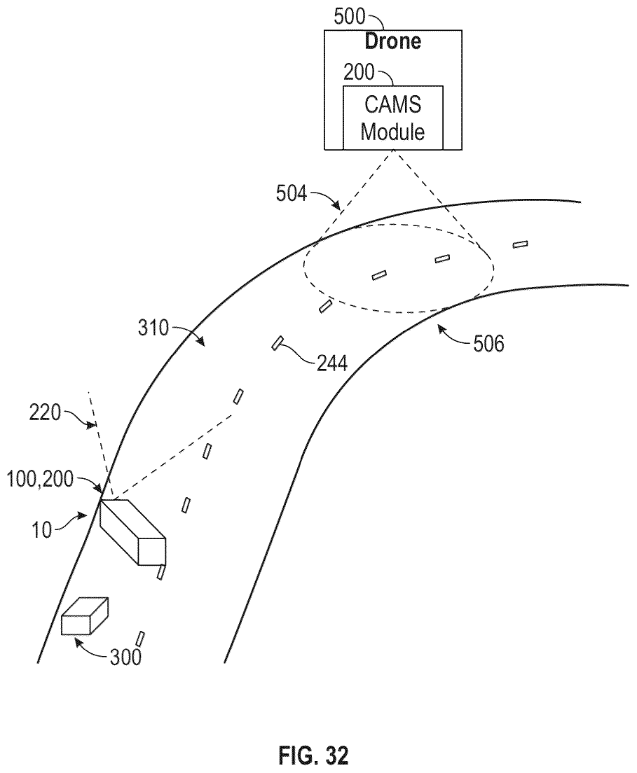

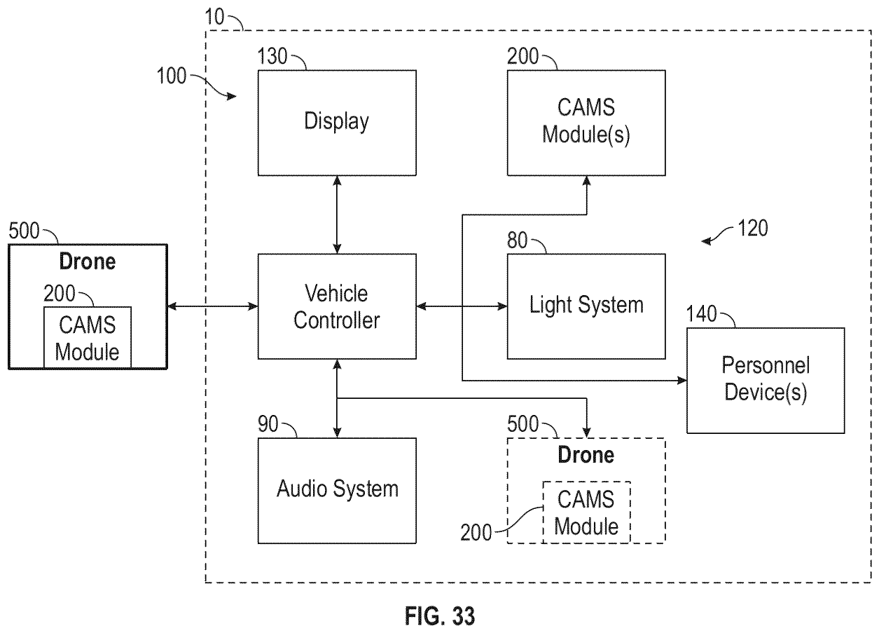

FIGS. 32 and 33 show an exemplary embodiment of the CAMS 100 including a first deployable CAMS module, shown as drone 500, having one or more of the CAMS modules 200 (e.g., a mobile CAMS module) mounted to the drone 500. In general, when the vehicle 10 is in a blocking arrangement, the drone 500 may be selectively deployed to travel upstream of the vehicle 10 and provide a supplemental FOV, shown as FOV 504, (e.g., defined by the camera(s) 204, the radar sensor(s) 206, and/or the LIDAR sensor(s) 208 in the CAMS module 200 on the drone 500) to capture data regarding incoming traffic upstream of the scene in a location where the FOV 220 of the CAMS module 200 on the vehicle 10 is obstructed or out of range. In the illustrated embodiment, the drone 500 is deployed to travel upstream of the vehicle 10 and orient the FOV 504 to capture data regarding incoming traffic traveling on a curve 506 in the road 310. The FOV 220 of the CAMS module 200 on the vehicle 10 is obstructed from viewing the incoming traffic on the curve 506, and the CAMS module 200 within the drone 500 allows the CAMS 100 to be provided with preliminary data regarding the incoming traffic, prior to the incoming traffic entering the FOV 220. In some embodiments, more than one of the drone 500 is deployed and positioned upstream of the vehicle 10 and each of the drones 500 may be used to sequentially or simultaneously generate preliminary data. It should be appreciated that the drone 500 is not limited to providing preliminary data along the curve 506. The drone 500 may be deployed to provide preliminary data along any road-based, geography-based, terrain-based, or man-made obstruction that prevents the CAMS module(s) 200 on the vehicle 10 from viewing the incoming traffic.

In some embodiments, the drone 500 is stored on and/or deployed from the vehicle 10, as indicated by the dashed lines in FIG. 33. In some embodiments, the drone 500 includes a dedicated controller that is controlled by a user of the vehicle 10 and the camera(s) 204 of the CAMS module 200 on the drone 500 may be used to navigate the drone 500 to a desired location upstream of the vehicle 10. In some embodiments, the drone 500 is controllable using one of the mobile devices 132 of the CAMS 100. In some embodiments, the drone 500 includes a GPS navigation system and the drone 500 may be commanded to travel to a specific GPS location upstream of the vehicle 10. Regardless of how the drone 500 is commanded, once the drone 500 reaches a desired location upstream of the vehicle 10, the CAMS module 200 within the drone 500 may begin to provide preliminary data to the CAMS 100 on the vehicle 10. In some embodiments, the CAMS controller 210 of the CAMS module 200 on the drone 500 is in wireless communication with the vehicle controller 110 and/or the CAMS controller 210 of the CAMS module 200 on the vehicle 10 via cellular communication, radio frequency communication, satellite communication, a long-range wide-area network, and/or another long-range wireless communication protocol.

As described herein, the vehicle controller 110 and/or the CAMS controller 210 are configured to detect and track the approaching vehicles 340 including a path of the approaching vehicles, a size of the approaching vehicles, and/or a type of the approaching vehicles (e.g., a motorcycle, a sedan, a SUV, a truck, a semi-truck, a response vehicle, etc.). Such detection and tracking may be performed by the CAMS module 200 (e.g., by the CAMS controller 210) within the drone 500 to produce preliminary tracking data that is used to correlate the data for the vehicles within the FOV 504 to the vehicles within the FOV 220 and evaluate a preliminary threat level of the approaching vehicles. For example, an approaching vehicle captured by the CAMS module 200 within the drone 500 may be correlated and mapped to an approaching vehicle captured by the CAMS module(s) 200 on the vehicle 10, based on the preliminary tracking data, and the correlation between the two data sets may be used to escalate or deescalate a threat level associated with the vehicle.

For example, the CAMS controller 210 of the CAMS module 200 on the drone 500 is configured assess and determine a preliminary threat level associated with the approaching vehicles 340 based on the detection and tracking of the approaching vehicles 340 (e.g., the speed, the heading, the size, the path of travel, the type, etc.) within the FOV 504. The preliminary threat level may be evaluated or determined based on the risk of impact of the approaching vehicles 340 with the vehicle 10 (e.g., based on heading, distance, and speed). By way of example, if one of the approaching vehicles 340 is traveling at a high rate of speed around the curve 506 and is within a certain distance or time of arrival where it is unlikely that the driver would be able to avoid the vehicle 10 and/or the scene 300, the preliminary threat level may be determined to be high. By way of another example, if one of the approaching vehicles 340 is traveling at a low rate of speed around the curve 506, the preliminary threat level may be determined to be low. By way of still another example, if one of the approaching vehicles 340 is traveling at a high rate of speed around the curve 506, but the approaching vehicle 340 is a response vehicle (e.g., indicated by flashing lights detected via object recognition), the preliminary threat level may be determined to be low.

The preliminary threat level determined by the CAMS module 200 within the drone 500 is communicated to CAMS 100 and to the vehicle controller 110, and the preliminary threat level may be used by the CAMS 100 to more quickly escalate the threat level above the threat threshold. For example, if an approaching vehicle 340 is determined to have a high preliminary threat level by the CAMS module 200 within the drone 500, the CAMS module 200 on the vehicle 10 may determine that the same vehicle exceeds the threshold threat level earlier within the FOV 220. That is, the preliminary threat level may be used to prioritized approaching vehicles 340 with high preliminary threat levels and determine if the threat level of these approaching vehicles 340 exceeds the threat threshold when the vehicles are entering the FOV 220. In some embodiments, the CAMS module 200 within the drone 500 is configured to communicate the preliminary threat level of an approaching vehicle 340 to the CAMS module 200 on the vehicle 10 and/or to the vehicle controller 110 in response to the preliminary threat level exceeding a threat threshold (e.g., the speed, the heading, the size, the path of travel, the type, etc.).

In some embodiments, the vehicle controller 110 and/or the CAMS controller 210 within the drone 500 are configured to initiate or engage the alert system 120 in response to the preliminary threat level exceeding the threat threshold (e.g., more likely than not to impact the vehicle 10 and/or enter a scene, a high threat level, etc.). In some embodiments, the vehicle controller 110 and/or the CAMS controller 210 within the drone 500 are configured to activate one or more components of the light system 80 or alter the operation of one or more components of the light system 80 (e.g., change the color, change the cadence or pattern, etc.) to alert or warn the personnel on the scene in response to the preliminary threat level exceeding the threat threshold. In some embodiments, the vehicle controller 110 and/or the CAMS controller 210 within the drone 500 are configured to activate one or more components of the audio system 90 (e.g., activate the siren 92, activate the horn 94, activate the loudspeaker and/or the in-cab speaker to provide an evacuation or warning message, etc.) or alter the operation of one or more components of the audio system 90 (e.g., change the sound, change the volume, etc.) to alert or warn the personnel on the scene 300 in response to the preliminary threat level exceeding the threat threshold. In some embodiments, the vehicle controller 110 and/or the CAMS controller 210 within the drone 500 are configured to provide a warning or alert via the display 130 and/or an in-cab speaker to instruct an operator in the front cabin 20 to evacuate the vehicle 10 in response to the preliminary threat level exceeding the threat threshold. In some embodiments, the vehicle controller 110 and/or the CAMS controller 210 within the drone 500 are configured to initiate or engage the light system 80 and/or the audio system 90 to direct lights and/or sounds at the operator of the approaching vehicle 340 to alert or warn the operator of the scene 300 so that the operator can take mitigating actions (e.g., slow down, pull over, swerve out of the path of the vehicle 10 and the scene, etc.). In some embodiments, the vehicle controller 110 and/or the CAMS controller 210 within the drone 500 are configured to transmit a wireless signal (e.g., via the communications interface 116, via the communications interface 216, a short-range signal, a radio signal, a Wi-Fi signal, a Bluetooth® signal, etc.) to the personnel devices 140 proximate the vehicle 10 and/or on the scene 300 (e.g., within a range of the wireless signal) in response to the preliminary threat level exceeding the threat threshold. Upon receipt of the wireless signal, the personnel devices 140 are configured to initiate an alarm, output a message, vibrate, or perform some other function to warn the personnel holding or wearing the personnel devices 140 to take cover or evacuate the scene 300.

### Mobile CAMS Assembly

In some situations, when the vehicle 10 is positioned on a road in a blocking arrangement, the vehicle 10 is arranged in a location that is downstream of (e.g., further down the road in the direction of travel) a road-based, geography-based, terrain-based, or man-made obstruction. For example, the vehicle 10 may be located downstream of a curve in the road, at the bottom of a hill, behind trees, rocks, or other terrain, and/or behind a sign, building, or billboard. According to an exemplary embodiment, the CAMS 100 may include a mobile or deployable CAMS module that is mounted on a mobile unit. The deployable unit may be selectively deployed and travel, or be positioned, upstream of the vehicle 10 to provide a field of view to incoming traffic that is upstream of the field of view(s) of the CAMS module(s) 200 on the vehicle 10. The CAMS module 200 on the vehicle 10 is configured to capture first CAMS data (e.g., data from the camera(s) 204, the radar sensor(s) 206, and/or the LIDAR sensor(s) 208) and the deployable CAMS module is configured to capture second CAMS data. The second CAMS data may determine a preliminary threat level upstream of the vehicle 10 and the deployable CAMs module is configured to communicate with the CAMS 100 on the vehicle 10 to provide data regarding the incoming traffic and preliminary threat levels upstream of the vehicle 10, in locations where the CAMS module(s) 200 on the vehicle 10 are obstructed from viewing the incoming traffic (e.g., outside of a vision range or the FOV of the CAMS module 200 on the vehicle 10). In this way, for example, the CAMS 100 may be provided with preliminary data regarding the incoming traffic and the respective threat levels thereof prior to the incoming traffic entering the field of view(s) of the CAM module(s) 200 on the vehicle 10.

In some embodiments, the deployable CAMS module is configured to transmit a pre-alert signal to the alert system 120, an approaching vehicle, and/or the personnel devices 140 in response to the preliminary threat level exceeding a preliminary threat threshold. In some embodiments, the deployable CAMS module is configured to evaluate and communicate the preliminary threat level of an approaching vehicle, and the CAMS module 200 on the vehicle 10 is configured to evaluate a final threat level of the approaching vehicle. An alert signal may be provided to the alert system 120, the approaching vehicle, and/or the personnel devices 140 in response to the preliminary threat level or the final threat level exceeding a threat threshold.

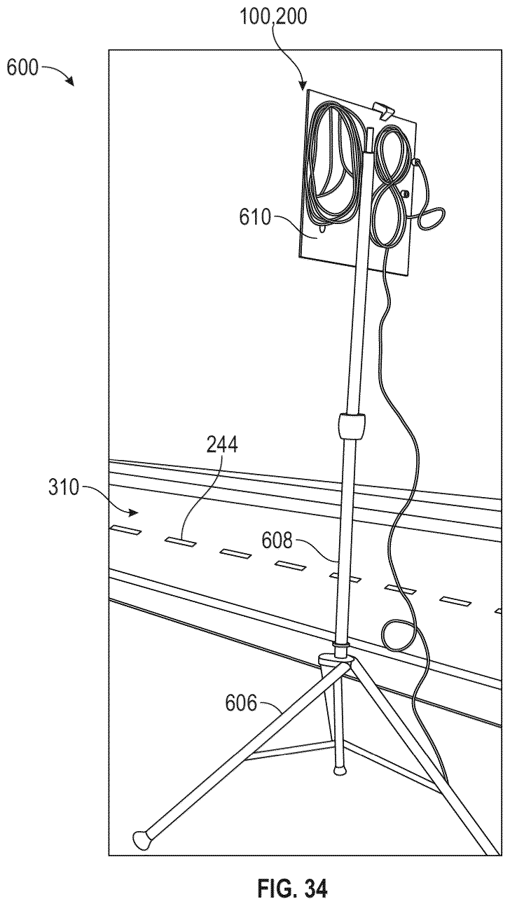

FIG. 34-36 show an exemplary embodiment of the CAMS 100 including a deployable CAMS module, shown mobile CAMS assembly 600, having one of the CAMS modules 200 (e.g., a mobile CAMS module) mounted thereon. In general, the mobile CAMS assembly 600 may be selectively positioned upstream of the vehicle 10 and arranged to provide a supplemental FOV, shown as FOV 604, (e.g., defined by the camera(s) 204, the radar sensor(s) 206, and/or the LIDAR sensor(s) 208 in the CAMS module 200 on the mobile CAMS assembly 600) to capture data regarding incoming traffic upstream of the scene 300 in a location where the FOV 220 of the CAMS module 200 on the vehicle 10 is obstructed or out of range.

As shown in FIG. 34, the mobile CAMS assembly 600 includes a stand, shown as base 606, a riser, shown as shaft 608, that is coupled to and supported on the base 606, and a support, shown as mounting plate 610, that is coupled to a free end of the shaft 608. One or more of the CAMS modules 200 is supported on or by the mounting plate 610. In some embodiments, the shaft 608 is height-adjustable (e.g., telescoping) to enable the height of the mounting plate 610 and the CAMS module 200 coupled thereto to be selectively adjusted. In some embodiments, the mobile CAMS assembly 600 is configured to be manually moved upstream of the vehicle 10 (e.g., carried, moved on a trailer, dropped off by the vehicle 10, etc.) and positioned to capture preliminary data upstream of the vehicle 10. In some embodiments, the base 606 includes wheels (e.g., locking caster wheels) that enable the mobile CAMS assembly 600 to be portable without being carried or trailered.

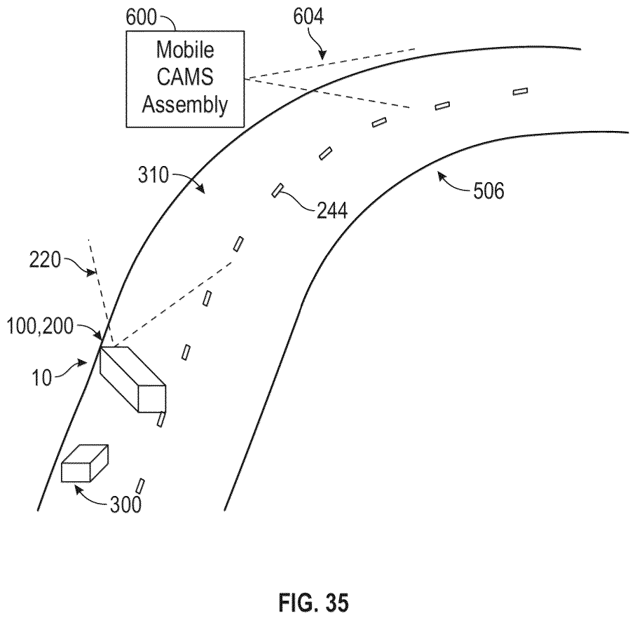

As shown in FIG. 35, the mobile CAMS assembly 600 is positioned upstream of the vehicle 10 and to orient the FOV 604 to capture data regarding incoming traffic traveling on the curve 506 in the road 310. The FOV 220 of the CAMS module 200 on the vehicle 10 is obstructed from viewing the incoming traffic on the curve 506, and the CAMS module 200 of the mobile CAMS assembly 600 allows the CAMS 100 to be provided with preliminary data regarding the incoming traffic, prior to the incoming traffic entering the FOV 220. In some embodiments, more than one of the mobile CAMS assemblies 600 are positionable upstream of the vehicle 10 and each of the mobile CAMS assemblies 600 may be used to sequentially or simultaneously generate preliminary data. It should be appreciated that the mobile CAMS assembly 600 is not limited to providing preliminary data along the curve 506. The mobile CAMS assembly 600 may be deployed to provide preliminary data along any road-based, geography-based, terrain-based, or man-made obstruction that prevents the CAMS module(s) 200 on the vehicle 10 from viewing the incoming traffic.

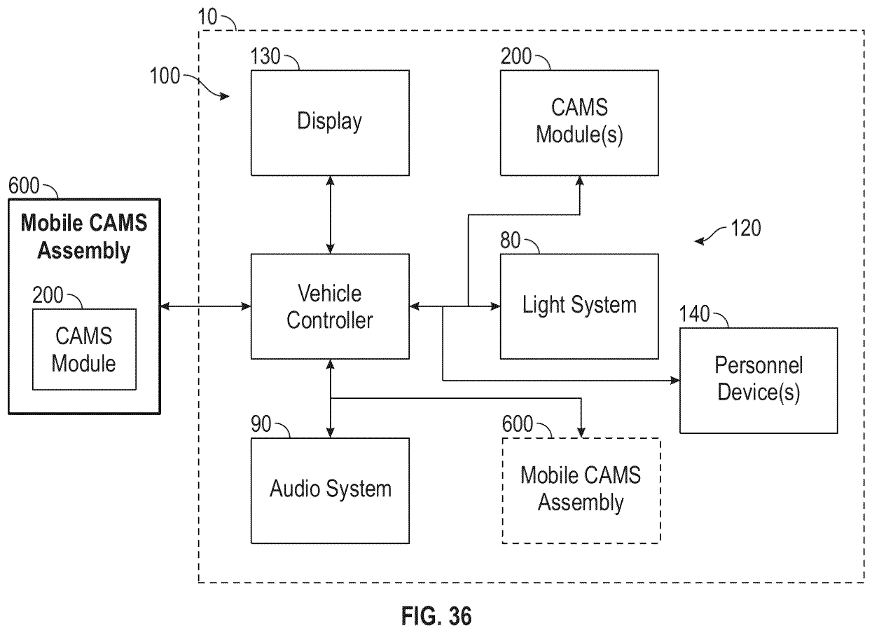

In some embodiments, the mobile CAMS assembly 600 is stored on and/or trailered by the vehicle 10, as indicated by the dashed lines in FIG. 36. Once the mobile CAMS assembly 600 is positioned at a desired location upstream of the vehicle 10, the CAMS module 200 on the mobile CAMS assembly 600 may begin to provide preliminary data to the CAMS 100 on the vehicle 10. In some embodiments, the CAMS controller 210 of the CAMS module 200 on the mobile CAMS assembly 600 is in wireless communication with the vehicle controller 110 and/or the CAMS controller 210 of the CAMS module 200 on the vehicle 10 via cellular communication, radio frequency communication, satellite communication, a long-range wide-area network, and/or another long-range wireless communication protocol.

As described herein, the vehicle controller 110 and/or the CAMS controller 210 are configured to detect and track the approaching vehicles 340 including a path of the approaching vehicles 340, a size of the approaching vehicles 340, and/or a type of the approaching vehicles 340 (e.g., a motorcycle, a sedan, a SUV, a truck, a semi-truck, a response vehicle, etc.). Such detection and tracking may be performed by the CAMS module 200 (e.g., by the CAMS controller 210) within the mobile CAMS assembly 600 to produce preliminary tracking data that is used to correlate the data for the vehicles within the FOV 604 to the vehicles within the FOV 220. For example, a vehicle captured by the CAMS module 200 within the mobile CAMS assembly 600 may be correlated and mapped to a vehicle captured by the CAMS module(s) 200 on the vehicle 10, based on the preliminary tracking data, and the correlation between the two data sets may be used to escalate or deescalate a threat level associated with the vehicle.

For example, the CAMS controller 210 of the CAMS module 200 on the mobile CAMS assembly 600 is configured assess and determine a preliminary threat level associated with the approaching vehicles 340 based on the detection and tracking of the approaching vehicles 340 (e.g., the speed, the heading, the size, the path of travel, the type, etc.) within the FOV 604. The preliminary threat level may be evaluated or determined based on the risk of impact of the approaching vehicles 340 with the vehicle 10 (e.g., based on heading, distance, and speed). By way of example, if one of the approaching vehicles 340 is traveling at a high rate of speed around the curve 506 and is within a certain distance or time of arrival where it is unlikely that the driver would be able to avoid the vehicle 10 and/or the scene, the preliminary threat level may be determined to be high. By way of another example, if one of the approaching vehicles 340 is traveling at a low rate of speed around the curve 506, the preliminary threat level may be determined to be low. By way of still another example, if one of the approaching vehicles 340 is traveling at a high rate of speed around the curve 506, but the approaching vehicle 340 is a response vehicle (e.g., indicated by flashing lights detected via object recognition), the preliminary threat level may be determined to be low.

The preliminary threat level determined by the CAMS module 200 within the mobile CAMS assembly 600 is communicated to CAMS 100 and to the vehicle controller 110, and the preliminary threat level may used by the CAMS 100 to more quickly escalate the threat level above the threat threshold. For example, if an approaching vehicle 340 is determined to have a high preliminary threat level by the CAMS module 200 of the mobile CAMS assembly 600, the CAMS module 200 on the vehicle 10 may determine that the same vehicle exceeds the threshold threat level earlier within the FOV 220. That is, the preliminary threat level may be used to prioritize the approaching vehicles 340 with high threat preliminary threat levels and determine if the threat level of these approaching vehicles 340 exceeds the threat threshold when the vehicles are entering the FOV 220. In some embodiments, the CAMS module 200 within the mobile CAMS assembly 600 is configured to communicate the preliminary threat level of an approaching vehicle 340 to the CAMS module 200 on the vehicle 10 and/or to the vehicle controller 110 in response to the preliminary threat level exceeding a threat threshold (e.g., the speed, the heading, the size, the path of travel, the type, etc.).

In some embodiments, the vehicle controller 110 and/or the CAMS controller 210 of the mobile CAMS assembly 600 are configured to initiate or engage the alert system 120 in response to the preliminary threat level exceeding a threat threshold (e.g., more likely than not to impact the vehicle 10 and/or enter a scene, a high threat level, etc.). In some embodiments, the vehicle controller 110 and/or the CAMS controller 210 of the mobile CAMS assembly 600 are configured to activate one or more components of the light system 80 or alter the operation of one or more components of the light system 80 (e.g., change the color, change the cadence or pattern, etc.) to alert or warn the personnel on the scene in response to the preliminary threat level exceeding the threat threshold. In some embodiments, the vehicle controller 110 and/or the CAMS controller 210 of the mobile CAMS assembly 600 are configured to activate one or more components of the audio system 90 (e.g., activate the siren 92, activate the horn 94, activate the loudspeaker and/or the in-cab speaker to provide an evacuation or warning message, etc.) or alter the operation of one or more components of the audio system 90 (e.g., change the sound, change the volume, etc.) to alert or warn the personnel on the scene 300 in response to the preliminary threat level exceeding the threat threshold. In some embodiments, the vehicle controller 110 and/or the CAMS controller 210 of the mobile CAMS assembly 600 are configured to provide a warning or alert via the display 130 and/or an in-cab speaker to instruct an operator in the front cabin 20 to evacuate the vehicle 10 in response to the preliminary threat level exceeding the threat threshold. In some embodiments, the vehicle controller 110 and/or the CAMS controller 210 of the mobile CAMS assembly 600 are configured to initiate or engage the light system 80 and/or the audio system 90 to direct lights and/or sounds at the operator of the approaching vehicle 340 to alert or warn the operator of the scene 300 so that the operator can take mitigating actions (e.g., slow down, pull over, swerve out of the path of the vehicle 10 and the scene 300, etc.). In some embodiments, the vehicle controller 110 and/or the CAMS controller 210 of the mobile CAMS assembly 600 are configured to transmit a wireless signal (e.g., via the communications interface 116, via the communications interface 216, a short-range signal, a radio signal, a Wi-Fi signal, a Bluetooth® signal, etc.) to the personnel devices 140 proximate the vehicle 10 and/or on the scene 300 (e.g., within a range of the wireless signal) in response to the preliminary threat level exceeding the threat threshold. Upon receipt of the wireless signal, the personnel devices 140 are configured to initiate an alarm, output a message, vibrate, or perform some other function to warn the personnel holding or wearing the personnel devices 140 to take cover or evacuate the scene.

### Roadway Camera Access

According to an exemplary embodiment, the CAMS 100 on the vehicle 10 may be in communication with one or more roadway cameras that communicate preliminary and/or additional data to the CAMS 100. For example, the CAMS 100 may be in communication with red light cameras, speed cameras, traffic cameras, automatic number plate recognition cameras, and/or other roadway cameras that may be in or around a scene where the vehicle 10 is in a blocking arrangement.

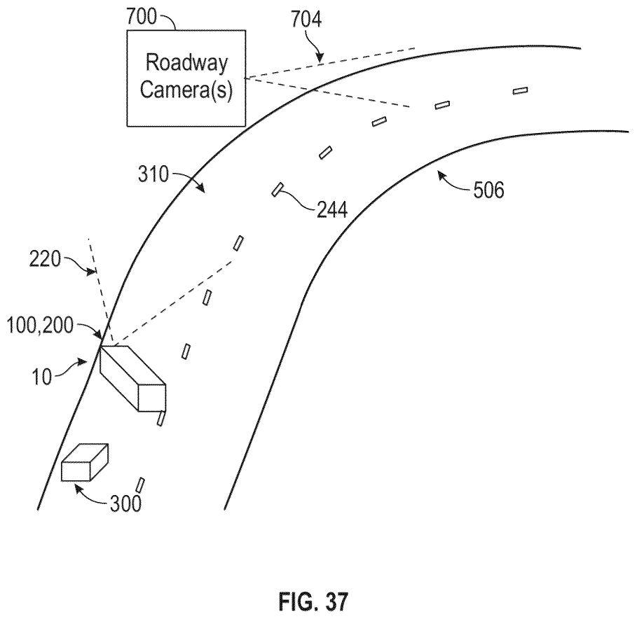

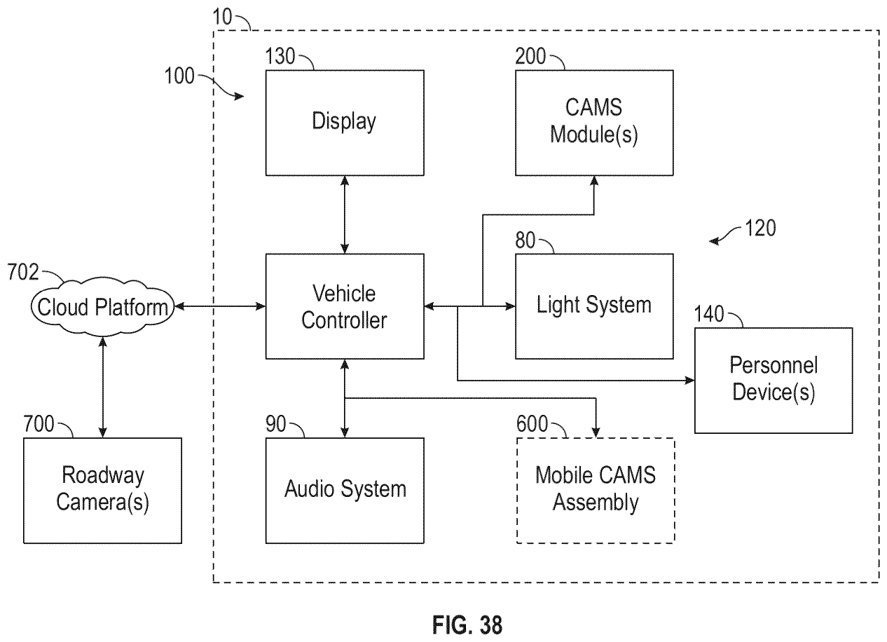

FIGS. 37 and 38 show an exemplary embodiment of the CAMS 100 in communication with one or more external cameras (e.g., red light cameras, speed cameras, traffic cameras, automatic number plate recognition cameras, and/or other roadway cameras), shown as roadway cameras 700. The roadway camera(s) 700 may be positioned upstream of the vehicle 10 and provide a supplemental FOV, shown as FOV 704, that capture data regarding incoming traffic upstream of the scene 300 in a location where the FOV 220 of the CAMS module 200 on the vehicle 10 is obstructed or out of range. As shown in FIG. 38, in some embodiments, the vehicle controller 110 and/or the CAMS controller 210 of the CAMS module 200 on the vehicle 10 are in direct wireless communication with the roadway camera(s) 700 via cellular communication, radio frequency communication, satellite communication, a long-range wide-area network, and/or another long-range wireless communication protocol. As shown in FIG. 38, in some embodiments, (a) the vehicle controller 110 and/or the CAMS controller 210 of the CAMS module 200 on the vehicle 10 and (b) the roadway camera(s) 700 are in wireless communication through a network, shown as cloud platform 702, that enables the vehicle controller 110 and/or the CAMS controller 210 to access the data from the roadway camera(s) 700. In some embodiments, the vehicle controller 110 and/or the CAMS controller 210 may determine which, if any, of the roadway camera(s) 700 are positioned upstream of the vehicle 10 in a position not blocked by an obstruction, and access the data captured by the roadway camera(s) 700 to generate the preliminary data.

As shown in FIG. 37, the roadway camera(s) 700 is positioned upstream of the vehicle 10 and the FOV 704 is oriented to capture data regarding incoming traffic traveling on the curve 506 in the road 310. The FOV 220 of the CAMS module 200 on the vehicle 10 is obstructed from viewing the incoming traffic on the curve 506, and roadway camera(s) 700 allows the CAMS 100 to be provided with preliminary data regarding the incoming traffic prior to the incoming traffic entering the FOV 220. It should be appreciated that the roadway camera(s) 700 is not limited to providing preliminary data along the curve 506. The roadway camera(s) 700 may be deployed to provide preliminary data along any road-based, geography-based, terrain-based, or man-made obstruction that prevents the CAMS module(s) 200 on the vehicle 10 from viewing the incoming traffic.

In some embodiments, the data captured by the roadway camera(s) 700 is utilized by the vehicle controller 110 and/or the CAMS controller 210 to detect and track the approaching vehicles including a path of the approaching vehicles 340, a size of the approaching vehicles 340, a license plate number, and/or a type of the approaching vehicles 340 (e.g., a motorcycle, a sedan, a SUV, a truck, a semi-truck, a response vehicle, etc.). Such detection and tracking may be performed to produce preliminary tracking data that is used to correlate the data for the vehicles within the FOV 704 to the vehicles within the FOV 220. For example, a vehicle captured by the roadway camera(s) 700 may be correlated and mapped to a vehicle captured by the CAMS module(s) 200 on the vehicle 10, based on the preliminary tracking data, and the correlation between the two data sets may be used to escalate or deescalate a threat level associated with the vehicle.

In some embodiments, the CAMS controller 210 and/or the vehicle controller 110 are configured assess and determine a preliminary threat level associated with the approaching vehicles 340 based on the detection and tracking of the approaching vehicles 340 (e.g., the speed, the heading, the size, the path of travel, the type, etc.) captured by the roadway cameras 700 (e.g., within the FOV 704). The preliminary threat level may be evaluated or determined based on the risk of impact of the approaching vehicles 340 with the vehicle 10 (e.g., based on heading, distance, and speed). By way of example, if one of the approaching vehicles 340 is traveling at a high rate of speed around the curve 506 and is within a certain distance or time of arrival where it is unlikely that the driver would be able to avoid the vehicle 10 and/or the scene 300, the preliminary threat level may be determined to be high. By way of another example, if one of the approaching vehicles 340 is traveling at a low rate of speed around the curve 506, the preliminary threat level may be determined to be low. By way of still another example, if one of the approaching vehicles 340 is traveling at a high rate of speed around the curve 506, but the approaching vehicle 340 is a response vehicle (e.g., indicated by flashing lights detected via object recognition), the preliminary threat level may be determined to be low.

The preliminary threat level determined based on the data captured by the roadway camera(s) 700 is communicated to CAMS 100 and to the vehicle controller 110, and the preliminary threat level may used by the CAMS 100 to more quickly escalate the threat level above the threat threshold. For example, if an approaching vehicle 340 is determined to have a high preliminary threat level based on the data captured by the roadway camera(s) 700, the CAMS module 200 on the vehicle 10 may determine that the same vehicle exceeds the threshold threat level earlier within the FOV 220. That is, the preliminary threat level may be used to prioritized approaching vehicles 340 with high threat preliminary threat levels and determine if the threat level of these approaching vehicles 340 exceeds the threat threshold when the vehicles are entering the FOV 220. In some embodiments, the preliminary threat level of an approaching vehicle 340 detected by the roadway camera(s) 700 is communicated to the CAMS module 200 on the vehicle 10 and/or to the vehicle controller 110 in response to the preliminary threat level exceeding a threat threshold (e.g., the speed, the heading, the size, the path of travel, the type, etc.).

In some embodiments, the vehicle controller 110 and/or the CAMS controller 210 are configured to initiate or engage the alert system 120 in response to the preliminary threat level exceeding a threat threshold (e.g., more likely than not to impact the vehicle 10 and/or enter a scene, a high threat level, etc.). In some embodiments, the vehicle controller 110 and/or the CAMS controller 210 are configured to activate one or more components of the light system 80 or alter the operation of one or more components of the light system 80 (e.g., change the color, change the cadence or pattern, etc.) to alert or warn the personnel on the scene 300 in response to the preliminary threat level exceeding the threat threshold. In some embodiments, the vehicle controller 110 and/or the CAMS controller 210 are configured to activate one or more components of the audio system 90 (e.g., activate the siren 92, activate the horn 94, activate the loudspeaker and/or the in-cab speaker to provide an evacuation or warning message, etc.) or alter the operation of one or more components of the audio system 90 (e.g., change the sound, change the volume, etc.) to alert or warn the personnel on the scene 300 in response to the preliminary threat level exceeding the threat threshold. In some embodiments, the vehicle controller 110 and/or the CAMS controller 210 are configured to provide a warning or alert via the display 130 and/or an in-cab speaker to instruct an operator in the front cabin 20 to evacuate the vehicle 10 in response to the preliminary threat level exceeding the threat threshold. In some embodiments, the vehicle controller 110 and/or the CAMS controller 210 are configured to initiate or engage the light system 80 and/or the audio system 90 to direct lights and/or sounds at the operator of the approaching vehicle 340 to alert or warn the operator of the scene 300 so that the operator can take mitigating actions (e.g., slow down, pull over, swerve out of the path of the vehicle 10 and the scene 300, etc.). In some embodiments, the vehicle controller 110 and/or the CAMS controller 210 are configured to transmit a wireless signal (e.g., via the communications interface 116, via the communications interface 216, a short-range signal, a radio signal, a Wi-Fi signal, a Bluetooth® signal, etc.) to the personnel devices 140 proximate the vehicle 10 and/or on the scene 300 (e.g., within a range of the wireless signal) in response to the preliminary threat level exceeding the threat threshold. Upon receipt of the wireless signal, the personnel devices 140 are configured to initiate an alarm, output a message, vibrate, or perform some other function to warn the personnel holding or wearing the personnel devices 140 to take cover or evacuate the scene.

### Other Implementations

While the present disclosure mainly references the vehicle 10 being in a blocking arrangement along the lanes of the road 310, in some implementations, the vehicle 10 may be positioned along a shoulder of the road 310 or off-road (e.g., during a traffic stop, a construction site along the side of a roadway, etc.). The CAMS 100 described herein may similarity be utilized in such implementations.

Further, while the present disclosure mainly references the vehicle 10 being in a stationary implementation, the CAMS 100 may be used while the vehicle 10 is moving or being driven. Specifically, the CAMS 100 may be used with vehicles that make frequent stops, that drive slower than normal traffic, and/or that drive along shoulders of roadways such as refuse vehicles, delivery vehicles, busses, snow plow trucks, tow trucks, street sweepers, construction machinery, agricultural machinery, and the like. In such implementations, the CAMS 100 may be configured to (a) monitor the approaching vehicles 340 and (b) alert the operator of the vehicle 10 regarding a high risk approaching vehicle and/or alert the operators of the approaching vehicles 340 to take mitigating actions (e.g., using the various techniques described herein).

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., CAMS 100, CAMS module 200, etc.) as shown in the various exemplary embodiments is illustrative only. Additionally, any element disclosed in one embodiment may be incorporated or utilized with any other embodiment disclosed herein.

1. A collision avoidance system for a blocker vehicle at a scene, the collision avoidance system comprising:
one or more sensors; and
one or more processing circuits configured to:
acquire a plurality of past trajectories of approaching vehicles proximate the scene, each of the plurality of past trajectories based on a plurality of first position measurements from the one or more sensors, wherein the plurality of past trajectories represent unthreatening conditions for the scene;
determine a threat score for a detected vehicle based on the plurality of past trajectories and a plurality of second position measurements of the detected vehicle acquired by the one or more sensors; and
responsive to the threat score exceeding a threshold, transmit an alert signal configured to at least one of activate an alert system associated with the blocker vehicle, activate a collision avoidance system of the detected vehicle, or activate a threat mitigation system of the blocker vehicle.

2. The collision avoidance system of claim 1, wherein the threat score is related to a likelihood of at least one of a collision with the blocker vehicle, a collision with a person within a sensing range of the blocker vehicle, a collision with another object within the sensing range of the blocker vehicle, or an entry into a restricted zone encompassing the blocker vehicle.

3. The collision avoidance system of claim 2, wherein the restricted zone is based on a position of one or more personnel at the scene.

4. The collision avoidance system of claim 1, wherein the one or more processing circuits are configured to predict a future trajectory of the detected vehicle based on the plurality of second position measurements and determine the threat score for the detected vehicle based on the future trajectory.

5. The collision avoidance system of claim 4, wherein the one or more processing circuits are configured to adjust the future trajectory of the detected vehicle based on the plurality of past trajectories representing unthreatening conditions.

6. The collision avoidance system of claim 4, wherein the one or more processing circuits are configured to:
separate the plurality of past trajectories representing unthreatening conditions at the scene into a plurality of clusters;
determine a plurality of similarity measures, each similarity measure of the plurality of similarity measures based on a comparison of (a) an observed trajectory for the detected vehicle calculated based on the plurality of second position measurements and (b) a cluster of the plurality of clusters; and
adjust the future trajectory based on the cluster associated with a maximum similarity measure of the plurality of similarity measures.

7. The collision avoidance system of claim 1, wherein the one or more processing circuits are configured to:
separate the plurality of past trajectories representing unthreatening conditions at the scene into a plurality of clusters;
determine a plurality of similarity measures, each similarity measure of the plurality of similarity measures based on a comparison of (a) an observed trajectory for the detected vehicle calculated based on the plurality of second position measurements and (b) a cluster of the plurality of clusters; and
determine the threat score based on a maximum similarity measure of the plurality of similarity measures.

8. The collision avoidance system of claim 1, wherein the one or more processing circuits are configured to determine the threat score by executing an artificial intelligence model configured to accept, as input, the plurality of second position measurements and one or more of the plurality of past trajectories.

9. The collision avoidance system of claim 1, wherein the one or more sensors are configured to determine a velocity of the detected vehicle, and wherein the one or more processing circuits are configured to determine the threat score based on the plurality of past trajectories, the plurality of second position measurements, and the velocity of the detected vehicle.

10. The collision avoidance system of claim 1, wherein the one or more processing circuits are configured to adjust the threat score based on a weather condition at the scene.

11. The collision avoidance system of claim 1, wherein the one or more sensors comprise at least one of a camera, a radar, or a LIDAR.

12. The collision avoidance system of claim 1, wherein responsive to the threat score exceeding the threshold, the one or more processing circuits are configured to transmit the alert signal configured to activate the alert system, and wherein the alert system includes at least one of:
a siren, a speaker, or a horn of the blocker vehicle;
a light system of the blocker vehicle; or
a device worn or carried by personnel at the scene.

13. The collision avoidance system of claim 1, wherein responsive to the threat score exceeding the threshold, the one or more processing circuits are configured to transmit the alert signal configured to activate the threat mitigation system of the blocker vehicle, and wherein the threat mitigation system includes at least one of a deceleration reduction device or a force dispersion device.

14. The collision avoidance system of claim 1, wherein the one or more processing circuits are configured to determine an angle between a longitudinal axis of the detected vehicle and a direction of motion of the detected vehicle determined from the plurality of second position measurements, and wherein the threat score is further based on the angle.

15. A collision avoidance system for a blocker vehicle at a scene, the collision avoidance system comprising:
one or more sensors; and
one or more processing circuits configured to:
acquire a plurality of past trajectories of approaching vehicles proximate the scene, wherein the plurality of past trajectories represent unthreatening conditions;
determine a threat score for a detected vehicle based on a plurality of position measurements of the detected vehicle acquired by the one or more sensors;
adjust the threat score based on a comparison of the plurality of position measurements to one or more past trajectories of the plurality of past trajectories representing unthreatening conditions; and
responsive to the threat score exceeding a threshold, transmit an alert signal configured to at least one of activate an alert system of the blocker vehicle, activate a collision avoidance system of the detected vehicle, or activate a threat mitigation system of the blocker vehicle.

16. The collision avoidance system of claim 15, wherein the one or more processing circuits are configured to predict a future trajectory of the detected vehicle based on the plurality of position measurements, and wherein the comparison is between (a) the plurality of position measurements and the future trajectory and (b) the plurality of past trajectories.

17. The collision avoidance system of claim 15, wherein the one or more processing circuits are configured to:
separate the plurality of past trajectories representing unthreatening conditions at the scene into a plurality of clusters;
determine a plurality of similarity measures, each similarity measure of the plurality of similarity measures based on a comparison of (a) an observed trajectory for the detected vehicle calculated based on the plurality of position measurements and (b) a cluster of the plurality of clusters; and
select the one or more past trajectories using clusters of the plurality of clusters for which a respective similarity measure of the plurality of similarity measures satisfies a similarity criterion.

18. The collision avoidance system of claim 15, wherein the one or more processing circuits are configured to adjust the threat score down for each of the one or more past trajectories satisfying a similarity criterion with the plurality of position measurements.

19. The collision avoidance system of claim 15, wherein the one or more processing circuits are configured to compare the plurality of position measurements to the one or more past trajectories by executing an artificial intelligence model configured to accept, as input, the plurality of position measurements and the one or more past trajectories.

20. A collision avoidance system for a blocker vehicle at a scene, the collision avoidance system comprising:
one or more sensors configured to acquire a position and a longitudinal axis of a detected vehicle; and
one or more processing circuits configured to:
acquire a plurality of position measurements for the detected vehicle;
determine an angle between the longitudinal axis of the detected vehicle and a direction of motion of the detected vehicle determined from the plurality of position measurements; and
responsive to the angle satisfying a threshold criterion, transmit an alert signal configured to at least one of activate an alert system associated with the blocker vehicle, activate a collision avoidance system of the detected vehicle, or activate a threat mitigation system of the blocker vehicle.
